(19) United States
(12) Patent Application Publication
(10) Pub. No.: US 2002/0146654 A1
(43) Pub. Date: Oct. 10, 2002

(54) Heat-developable image recording material

(76) Inventors: Yoshihisa Tsukada, Kanagawa (JP); Hajime Nakagawa, Kanagawa (JP); Tomokazu Yasuda, Kanagawa (JP)

Correspondence Address: BIRCH STEWART KOLASCH & BIRCH, PO BOX 747, FALLS CHURCH, VA, 22040-0747, US

(21) Appl. No.: 10/058,656

(22) Filed: Jan. 30, 2002

(30) Foreign Application Priority Data
Jan. 30, 2001 (JP) P. 2001-022421

(51) Int. Cl. G03C 1/498; G03C 1/04

(52) U.S. Cl. 430/617; 430/620; 430/350; 430/627

(57) ABSTRACT

A heat-developable image recording material comprises a support, a photosensitive silver halide, a non-phosensitive organic silver salt, a reducing agent for a silver ion and a binder including a polymer latex, wherein polymer latex has a halogen ion content of not more than 500 ppm.

### FIELD OF THE INVENTION

The present invention relates to a heat-developable image recording material suitable for using in the fields of medical diagnostic films and photomechanical films.

### BACKGROUND OF THE INVENTION

In recent years, it has been eagerly desired to reduce waste processing solution in view of environmental conservation and space saving in the fields of medical diagnostic films and photomechanical films. Therefore, development of techniques relating to heat-developable image recording materials suitable for medical diagnostic films and photomechanical films, which can be efficiently exposed using a laser image-setter or a laser imager and provide clear black images having high resolution and sharpness, has been required. By the use of heat-developable image recording materials, a heat-developable processing system that is free from solutions of processing chemicals and simple, and does not adversely affect environment can be provided to customers.

While the above-described requirements exist also in the field of conventional image recording materials, in the field of medical diagnosis, high quality images excellent in sharpness and graininess and capable of performing fine description are highly demanded. Also, images of blue black tone are characteristically desired in this field in view of easiness to make a diagnosis. At present, various hard copy systems using pigment or dye, for example, an ink jet printing and electrophotography are popularized as image forming systems of conventional use. However, these are unsatisfactory to output systems of images for medical use.

On the other hand, thermal image-forming systems utilizing an organic silver salt are described, for example, in U.S. Pat. Nos. 3,152,904 and 3,457,075, J. Sturge, V. Walworth and A. Shepp ed., Imaging Processes and Materials: Neblette's, 8th Edition, Chapter 9, Thermally Processed Silver Systems (D. Klosterboer), page 279 (1989). In general, a heat-developable image recording material has a light-sensitive layer comprising a catalytically active amount of photo-catalyst (e.g., silver halide), a reducing agent, a silver salt capable of being reduced (e.g., organic silver salt), and if desired, a toning agent for controlling color tone of silver image, dispersed in a binder matrix. After imagewise exposure, the heat-developable image recording material is subjected to heating at high temperature (e.g., 80° C. or more), whereby a black silver image is formed upon an oxidation reduction reaction between the silver salt capable of being reduced (which acts as an oxidizing agent) and the reducing agent. The oxidation reduction reaction is accelerated by a catalytic function of latent image of silver halide formed by the image exposure and thus, the black silver image is formed in the exposed area.

Although heat-developable image recording materials of such a type have been hitherto known, in most of these recording materials, the light-sensitive layer is prepared by using an organic solvent, for example, toluene, methyl ethyl ketone or methanol as a solvent for coating solution. The use of organic solvent is disadvantageous not only in that it adversely affects to the human body in the process of production but also in that it causes increase in the cost due to recovery of the solvent or other factors.

Methods for forming light-sensitive layer (hereinafter also referred to as a “water-based light-sensitive layer”) using a coating solution of an aqueous medium that is free from the above-described disadvantages are disclosed. For example, a technique of using gelatin as a binder is described in JP-A-49-52626 (the term “JP-A” as used herein means an “unexamined published Japanese patent application”) and JP-A-53-116114, and a technique of using polyvinyl alcohol as a binder is described in JP-A-50-151138.

However, these techniques are below the level of practical use since severe fog occurs and color tone of the image formed is very poor. A technique of using a polymer latex as a binder and forming a light-sensitive layer using an aqueous medium is described in JP-A-10-10669 and JP-A-10-62899. This technique opens the way for the production of heat-developable image recording material, which is preferable from the standpoints of prevention of fog, good color tone of the image, environmental conservation, safety, cost, and the like.

However, this technique is still insufficient in view of photographic characteristics, in particular, image preservability, for example, increase of density in the unexposed area and change in color tone of the silver image after the formation of image and thus further improvement has been desired. In JP-A-11-129629, a method for purifying a latex with a dialysis membrane is described in order to improve the image preservability. However, the method disadvantageously tends to be accompanied with degradation of coating property owing to aggregation of latex occurred during the process of purification. Therefore, a technique to provide a heat-developable image recording material which satisfies both the image preservability and the coating property.

### SUMMARY OF THE INVENTION

The present invention aims to dissolve the problems in the prior art describe above.

Specifically, an object of the present invention is to provide a heat-developable image recording material excellent in both the image preservability and the coating property.

Other objects of the present invention will become apparent from the following description.

It has been found that the above-described objects are accomplished by the following items:

(1) A heat-developable image recording material comprising:

a support;

a photosensitive silver halide;

a non-photosensitive organic silver salt;

a reducing agent for a silver ion; and

a binder including a polymer latex,

wherein the polymer latex has a halogen ion content of not more than 500 ppm.

(2) The heat-developable image recording material as described in item (1), wherein the polymer latex has a halogen ion content of not more than 200 ppm.

(3) The heat-developable image recording material as described in item (1), wherein the halogen ion is a chlorine ion.

(4) The heat-developable image recording material as described in item (1), wherein the polymer latex is not subjected to purification by a desalting process.

(5) The heat-developable image recording material as described in item (1), wherein the binder has a glass transition temperature of from −20° C. to 80° C.

(6) The heat-developable image recording material as described in item (1), wherein the polymer latex contains a conjugated diene copolymer.

(7) The heat-developable image recording material as described in item (1), wherein the reducing agent contains:

a phenol compound; and

a compound that satisfies at least one of the conditions (A) and (B):

(A): the compound having a hydrogen bond-forming rate constant (Kf) of from 20 to 4,000,

(B): the compound having one of a phosphoryl group in its molecule, and a structure represented by formula (II), (III), (IV) or (V):

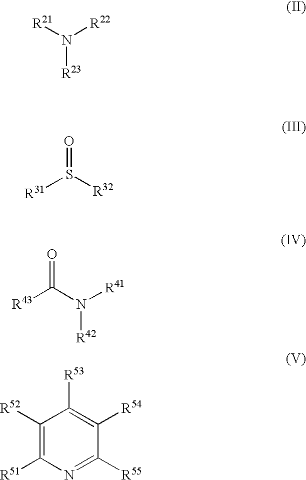

wherein R²¹ and R²², which are the same or different, each represents an alkyl group; R²³ represents an alkyl group, an aryl group or a heterocyclic group; at least two of R²¹, R²² and R²³ may be combined with each other to form a ring, R³¹ and R³², which are the same or different, each represents an alkyl group, an aryl group or a heterocyclic group; R³¹ and R³² may be combined with each other to form a ring,

R⁴¹ and R⁴², which are the same or different, each represents an alkyl group, an aryl group or a heterocyclic group; R represents an alkyl group, an aryl group, a heterocyclic group or —N(R⁴⁴) (R⁴⁵); R⁴⁴ and R⁴⁵, which are the same or different, each represents an alkyl group, an aryl group or a heterocyclic group; at least two of R⁴¹, R⁴², R⁴³, R⁴⁴ and R⁴⁵ may be combined with each other to form a ring, and

R⁵¹, R⁵², R⁵³, R⁵⁴ and R⁵⁵, which are the same or different, each represents a hydrogen atom or a substituent; at least two of R⁵¹, R⁵², R⁵³, R⁵⁴ and R⁵⁵ may be combined with each other to form a ring.

(8) The heat-developable image recording material as described in item (7), wherein the phenol compound is an o-polyphenol compound.

(9) The heat-developable image recording material as described in item (8), wherein the o-polyphenol compound is a compound represented by formula (I):

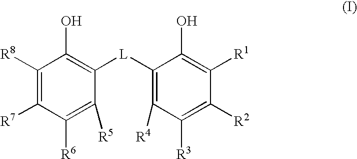

wherein R¹, R², R³, R⁴, R⁵, R⁶, R⁷ and R⁸, which are the same or different, each represents a hydrogen atom or a substituent capable of being substituted on the benzene ring; L represents —S— or —CHR⁹—; and R⁹ represents a hydrogen atom or an alkyl group.

(10) The heat-developable image recording material as described in item (9), wherein the compound represented by formula (I) is a compound in which R², R², R⁵ and R⁷ each represents a hydrogen atom; R¹ and R⁸ each independently represents an alkyl group; R³ and R⁶ each independently represents an alkyl group; and L represents —CHR⁹—.

(11) The heat-developable image recording material as described in item (10), wherein R¹ and R⁸ each independently represents a secondary alkyl group or a tertiary alkyl group.

(12) The heat-developable image recording material as described in item (7), wherein the hydrogen bond-forming rate constant (Kf) is from 70 to 4,000.

(13) The heat-developable image recording material as described in item (7), wherein the phenol compound is an o-polyphenol compound, and the compound which satisfies at least one of the conditions (A) and (B) is the compound having a phosphoryl group in its molecule.

(14) The heat-developable image recording material as described in item (7), wherein the compound having a phosphoryl group in its molecule is a compound represented by formula (VI):

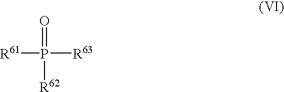

wherein R⁶¹, R⁶² and R⁶³, which are the same or different, each represents an alkyl group, an aryl group, an aralkyl group, an alkoxy group, an aryloxy group, an amino group or a heterocyclic group.

(15) The heat-developable image recording material as described in item (1), which further comprises an image-forming layer containing the photosensitive silver halide, the non-photosensitive organic silver salt and the binder.

(16) The heat-developable photosensitive material as described in item (15), wherein the image-forming layer further contains the reducing agent for a silver ion.

(17) The heat-developable photosensitive material as described in item (15), which further comprises a second image-forming layer containing the reducing agent for a silver ion.

### BRIEF DESCRIPTION OF THE DRAWING

FIG. 1 is a schematic cross-sectional side view showing a construction of a heat developing machine used in the examples.

Explanation of the Symbols:

10: Heat-developable image recording material

11: Carrying in roller

12: Carrying out roller

13: Roller

14: Smooth surface

15: Heater

16: Guide plate

A: Pre-heating part

B: Heat development processing part

C: Slow cooling part

### DETAILED DESCRIPTION OF THE INVENTION

In the present specification, the symbol “˜” means a range including the numerical values described before and after thereof as the minimum value and maximum value, respectively.

The present invention is described in more detail below.

The heat-developable image recording material of the present invention comprises a support, a photosensitive silver halide (a light-sensitive silver halide), a non-photosensitive organic silver salt (a light-insensitive organic silver salt), a reducing agent for a silver ion and a binder, wherein the binder contains a polymer latex having a halogen ion content of not more than 500 ppm based on the polymer latex. The photosensitive silver halide, the non-photosensitive organic silver salt, the reducing agent for a silver ion and the binder is preferably provided on one side of the support.

The heat-developable image recording material of the present invention is excellent in both the image preservability and the coating property by using the polymer latex in which a halogen ion content is controlled to reduce below the specific value.

<Binder>

The polymer latex used for the binder will be described in greater detail below.

The halogen ion contained in the polymer latex for use in the present invention includes a fluorine ion, a chlorine ion, a bromine ion and an iodine ion. In view of the photographic characteristics, it is preferably a chlorine ion, a bromine ion or an iodine ion, more preferably a chlorine ion or a bromine ion, and particularly preferably a chlorine ion.

The halogen ion content of the polymer latex for use in the present invention is not more than 500 ppm, preferably not more than 200 ppm, and particularly preferably not more than 100 ppm, based on the polymer latex. When the halogen ion content exceeds 500 ppm based on the polymer latex, the image preservability degrades.

On the other hand, based on a solid content of the polymer latex, the halogen ion content of the polymer latex is preferably not more than 1,200 ppm, more preferably not more than 500 ppm, and particularly preferably not more than 250 ppm.

The term “halogen ion content” used hereinafter means a halogen ion content based on the polymer latex.

The measurement of the halogen ion content of the polymer latex for use in the present invention is conducted by subjecting the latex to pre-treatment by ultrafiltraion using, for example, Sartorius Centrisart I (cut-off value: 5,000), and centrifugal separation (at 3,000 rpm, for one hour) to prepare a sample for measurement, and then the sample to ion chromatography. The representative conditions for measurement are described below.

Conditions for Measurement

Apparatus for measurement: DIONEX DX500 Model ion chromatography

Separation column: AS-4a (F, Cl, Br) and AS-12a (I)

Eluate: Sodium carbonate/sodium hydrogen carbonate, 4 mM

Flow rate: 1.2 ml/min

The polymer latex for use in the present invention has preferably a particle size of not more than 500 nm, more preferably not more than 300 nm, and still more preferably not more than 200 nm. A species of material for the polymer latex is not particularly limited, and a hydrophobic polymer, for example, an acrylic resin, a polyester resin, a rubber resin (e.g., a conjugated diene copolymer), a polyurethane resin, a vinyl chloride resin, a vinyl acetate resin, a vinylidene chloride resin, a polyolefin resin and a copolymer thereof can be used. Of these polymers, an acrylic resin, a polyester resin and a rubber resin (e.g., a conjugated diene copolymer) are preferred, and an acrylic resin and a rubber resin (e.g., a conjugated diene copolymer) are more preferred.

The polymer latex for use in the present invention is particularly preferably a homopolymer or copolymer comprising a monomer unit selected from monomer groups (a) to (j) described below. The conjugated diene copolymer is most preferably used in view of the photographic characteristics and film property. The monomer unit for use is not particularly restricted, and a monomer unit capable of being polymerized by a conventional radical polymerization or ion polymerization is suitably employed.

Monomer Groups (a) to (j)

(a) Conjugated diene: for example, 1,3-butadiene, isoprene, 1,3-pentadiene, 2-ethyl-1,3-butadiene, 2-n-propyl-1,3-butadiene, 2,3-dimethyl-1,3-butadiene, 2-methyl-1,3-butadiene, 1-phenyl-1,3-butadiene, 1-α-naphtyl-1,3-butadiene, 1-β-naphtyl-1,3-butadiene, 2-chloro-1,3-butadiene, 1-bromo-1,3-butadiene, 1-chloro-1,3-butadiene, 2-fluoro-1,3-butadiene, 2,3-dichloro-1,3-butadiene, 1,1,2-trichloro-1,3-butadiene, 2-cyano-1,3-butadiene, and cyclopentadiene;

(b) Olefin: for example, ethylene, propylene, vinyl chloride, vinylidene chloride, 6-hydroxy-1-hexene, 4-pentenoic acid, methyl 8-noneic acid, vinyl sulfonic acid, trimethyl vinyl silane, trimethoxy vinyl silsne, 1,4-divinylcyclohexane, and 1,2,5-trivinylcyclohexane;

(c) α,β-Unsaturated carboxylic acid and salt thereof: for example, acrylic acid, methacrylic acid, itaconic acid, maleic acid, sodium acrylate, ammonium methacrylate, and potassium itaconate;

(d) α,β-Unsaturated carboxylic acid ester: for example, an alkyl acrylate (e.g., methyl acrylate, ethyl acrylate, butyl acrylate, cyclohexyl acrylate, 2-ethylhexyl acrylate, and dodecyl acrylate), a substituted alkyl acrylate (e.g., 2-chloroethyl acrylate, benzyl acrylate, and 2-cyanoethyl acrylate), an alkyl methacrylate (e.g., methyl methacrylate, butyl methacrylate, 2-ethylhexyl methacrylate, and dodecyl methacrylate), a substituted alkyl methacrylate (e.g., 2-hydroxyethyl methacrylate, glycidyl methacrylate glycerol monomethacrylate, 2-acetoxyethyl methacrylate, tetrahydrofurfuryl methacrylate, 2-methoxyethyl methacrylate, polypropylene glycol monomethacrylate (molar addition amount of polyoxypropylene: 2 to 100), 3-N,N-dimethylaminopropyl methacrylate, chloro-3-N,N,N-trimethylammoniopropyl methacrylate, 2-carboxyethyl methacrylate, 3-sulfopropyl methacrylate, 4-oxysulfobutyl methacrylate, 3-trimethoxysilylpropyl methacrylate, allyl methacrylate, and 2-isocyanatoethyl methacrylate), a derivative of unsaturated dicarboxylic acid (e.g., monobutyl maleate, dimethyl maleate, monomethyl itaconate, and dibutyl itaconate), and a polyfunctional ester (e.g., ethylene glycol diacrylate, ethylene glycol dimethacrylate, 1,4-cyclohexanediacrylate, pentaerythritol tetramethacrylate, pentaerythritol triacrylate, trimethylolpropane triacrylate, trimethylolethane triacrylate, dipentaerythritol pentamethacrylate, pentaerythritol hexaacrylate, and 1,2,4-cyclohexane tetramethacrylate);

(e) β-Unsaturated carboxylic acid amide: for example, acrylamide, methacrylamide, N-methylacrylamide, N,N-dimethylacrylamide, N-methyl-N-hydroxyethylacrylamide, N-tert-butylacrylamide, N-tert-octylmethacrylamide, N-cyclohexylacrylamide, N-phenylacrylamide, N-(2-acetoacetoxyethyl)acrylamide, N-acryloylmorpholine, diacetoneacrylamide, itaconic diamide, N-methylmaleimide, 2-acrylamido-methylpropanesulfonic acid, methylenebisacrylamide, and dimethacryloylpiperazine;

(f) Unsaturated nitrile: for example, acrylonitrile, and methacrylonitrile;

(g) Styrene and derivative thereof: for example, styrene, vinyl toluene, p-tert-butylstyrene, vinyl benzoic acid, methyl vinylbenzoate, a-methylstyrene, p-chloromethylstyrene, vinyl naphthalene, p-hydroxymethylstyrene, sodium p-styenesulfonate, potassium p-styenesulfinate, p-aminomethylstyrene, and 1,4-divinylbenzene;

(h) Vinyl ether: for example, methyl vinyl ether, butyl vinyl ether, and methoxyethyl vinyl ether;

(i) Vinyl ester: for example, vinyl acetate, vinyl propionate, vinyl benzoate, vinyl salicylate, and vinyl chloroacetate;

(j) Other polymerizable monomer: for example, N-vinylimidazole, 4-vinylpyridine, N-vinylpyrrolidone, 2-vinyloxazoline, 2-isopropenyloxazoline, and divinylsulfone.

Preferred example of the conjugated diene copolymer include a styrene-butadiene copolymer (e.g., a butadiene-styrene block copolymer, and a styrene-butadiene-styrene block copolymer), a styrene-isoprene copolymer (e.g., a random copolymer thereof, and a block copolymer thereof), an ethylene-propylene-diene copolymer (the dine monomer including, e.g., 1,4-hexadiene, dicyclopentadiene, and ethylydene norbornene), an acrylonitrile-butadiene copolymer, an isobtylene-isoprene copolymer, a butadiene-acrylate copolymer (the acrylate including, e.g., ethyl acrylate, and butyl acrylate), and a butadiene-acrylate-acrylonitrile copolymer (the acrylate including the same as described above).

The binder for use in the present invention has preferably a glass transition temperature (Tg) of from −20° C. to 80° C., more preferably from 0° C. to 70° C., and still more preferably from 10° C. to 60° C. from the standpoints of film-forming property and image preservability. A mixture of two or more polymers may be used as the binder. In such a case, it is preferred that a weighted mean of the glass transition temperature taking the composition of the mixture into account is in the above-described range. In case of the formation of phase separation or core-shell structure, it is preferred that a glass transition temperature of each phase is in the above-described range.

In such a case wherein the binder is a copolymer of n's monomers from i=1 to i=n, the glass transition temperature (Tg) is calculated according to the following equation:

1/Tg=Σ(Xi/Tgi)

wherein Xi represents a weight ratio of monomer No. i (ΣXi=1) and Tgi represents a glass transition temperature (absolute temperature) of a homopolymer of monomer No. i, and Σ means the sum total of from 1 to n. The value of glass transition temperature of a homopolymer of each monomer used is that described in J. Brandrup and E. H. Immergut, Polymer Handbook, 3rd Edition, Wiley-Interscience (1989).

Specific examples of the polymer latex (Polymer Latexes (P-1) to (P-24)) for use in the present invention are set forth below, but the present invention should not be construed as being limited thereto. In the following examples, the molecular weight is denoted by a number average molecular weight (Mn). In case of using the polyfunctional monomer, the description of molecular weight is omitted, since the concept of molecular weight is not applicable to such a polymer. In the chemical formulae, x, y, z and z′ attached to the parentheses in the polymer main chain portion each represents a weight ratio of polymer composition and the sum total of x, y, z and z′ is 100. The numerical value attached on the right side of parentheses in the polymer side chain portion represents a polymerization degree. The Tg means a glass transition temperature of a dry film obtained from the polymer latex.

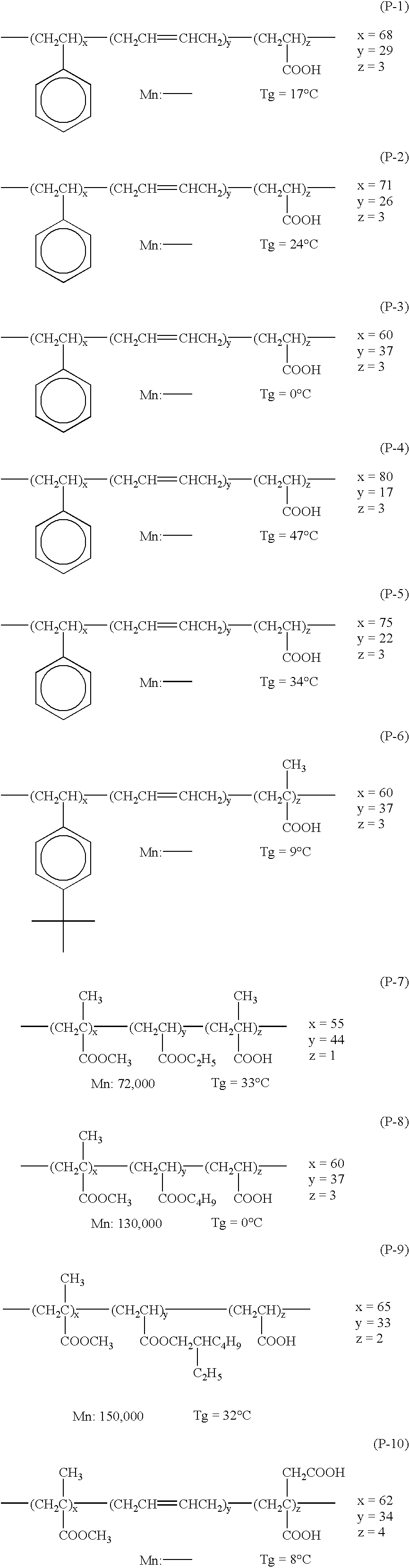

The polymer latex for use in the present invention is characterized by having the low halogen ion content. The reduction of halogen ion content can be conducted by purification of the polymer latex per se through a desalting step using, for example, an ion exchange resin or a dialysis membrane. However, the desalting step has a problem in that it is liable to cause aggregation of the polymer latex due to dramatic change in salt strength at the time of purification or concentration and as a result, the coating property is adversely affected. Therefore, it is preferred that the polymer latex is not subjected to purification through the desalting step.

In order to reduce the halogen ion content in the polymer latex for use in the present invention, it is preferred to control the kinds and amounts of additives used for the preparation of polymer latex as small as possible. Particularly, an additive containing a halogen ion is preferably used in a small amount or after purification. Examples of the additive containing a halogen ion include a polymerization emulsifier and the like. It is particularly preferred that such additives are previously desalted by electrodialysis using an ion exchange membrane and then used for the polymerization.

The polymer latex for use in the present invention can be easily obtained, for example, by an emulsion polymerization method. The emulsion polymerization method can be carried out using as a dispersion medium, for example, water or a mixed solvent of water and an organic solvent miscible with water (e.g., methanol, ethanol or acetone), from 5 to 40% by weight of one or more monomers based on the dispersion medium, from 0.05 to 5% by weight of a polymerization initiator based on the monomer(s) and from 0.1 to 20% by weight of an emulsifier based on the monomer(s) at temperature of from about 30 to about 100° C., preferably from 60 to 90° C., for a period of from 3 to 8 hours under stirring to polymerize. Various conditions, for example, the dispersion medium, concentration of monomer, amount of polymerization initiator, amount of emulsifier, amount of dispersant, reaction temperature and method for addition of monomer can be appropriately determined taking the kind of monomer used, the desired particle size of latex particle and the like into consideration. If desired, a dispersant or a chain transfer agent for the purpose of controlling a rate of gelation may be preferably used.

The polymerization initiator used in the emulsion polymerization method preferably includes a persulfate compound and an azo compound, each of which does not contain a halogen atom, in order to reduce the halogen ion content of the polymer latex. More preferably, an inorganic persulfate, e.g., ammonium persulfate, an azonitrile compound, e.g., sodium azobiscyanovalerate, and an azoamide compound, e.g., 2,2′-azobis(2-methyl-N-(1,1′-bis(hydroxymethyl)2-hydroxyethyl)propionamide are used. Of these compounds, sodium persulfate, potassium persulfate and ammonium persulfate are particularly preferred.

While any of an anionic surface active agent, a nonionic surface active agent, a cationic surface active agent and an amphoteric surface active agent can be employed as the dispersant used in the emulsion polymerization method, an anionic surface active agent is preferably used in view of dispersibility.

As the chain transfer agent used in the emulsion polymerization method, chain transfer agents described in J. Brandrup and E. H. Immergut, Polymer Handbook, 3rd Edition, Wiley-Interscience (1989) are preferably exemplified. A sulfur compound is more preferred since the amount to be used is sufficiently small due to its high chain transfer function. A hydrophobic mercaptan series chain transfer agent, for example, tert-dodecylmeraptan or n-dodecylmercaptan is particularly preferably used.

In the emulsion polymerization method, various additives including those described in a synthetic rubber handbook, for example, an electrolyte, a stabilizer, a thickener, a defoaming agent, an antioxidant, a vulcanizing agent, a chelating agent, an antifreezing agent, a gelling agent, and a vulcanization accelerator may be used in addition to the compounds described above.

The emulsion polymerization can be ordinarily performed according to methods described in Taira Okuda and Hiroshi Inagaki ed., Gosei Jushi Emulsion, Kobunshi-kankokai (1978), Takaaki Sugimura, Yasuo Kataoka, Souichi Suzuki and Keiji Kasahara ed., Gosei Latex no Oyo, Kobunshi-kankokai (1993), and Soichi Muroi, Gosei Latex no Kagaku, Kobunshi-kankokai (1993).

Synthetic examples of the polymer latex for use in the present invention are set forth below, but the present invention should not be construed as being limited thereto. With other examples of the polymer latex illustrated above, the halogen ion content can be decreased in accordance with similar synthesis methods.

### SYNTHESIS EXAMPLE 1

### Synthesis of Polymer Latex (P-1)

Into a polymerization furnace of gas monomer reaction apparatus (TAS-2J Model manufactured by Taiatu Techno Corp.), were put 287 g of distilled water, 19.7 g of a surface active agent (prepared by purifying Sandet BL (manufactured by Sanyo Chemical Industries, Ltd.) by Micro Acilyzer G3 (membrane: AC110-800) (manufactured by Asahi Chemical Industry Co., Ltd.) until the electric conductivity became unchanged; solid content: 30.4%), 15 ml of 1 mol/liter of an aqueous sodium hydroxide solution, 204 g of styrene, 9.0 g of acrylic acid and 2.4 g of tert-dodecylmercaptan, the reaction apparatus was sealed and stirred at a stirring rate of 200 rpm. After repeating several times degassing by a vacuum pump and substitution with nitrogen gas, 87.0 g of 1,3-butadiene was charged in the reaction apparatus with pressure and the inner temperature was raised to 60° C. To the mixture was added a solution of 2.25 g of sodium persulfate dissolved in 40 ml of water, followed by stirring for 5 hours. The inner temperature was raised to 90° C., followed by stirring for 3 hours. After the completion of the reaction, the inner temperature was lowered to room temperature, and the resulting polymer latex was filtered with a paper towel to obtain 620 g of Polymer Latex (P-1) (solid content: 45%, particle size: 80 nm, gel fraction: 60%). As a result of measurement of the halogen ion content by an ion chromatography, it was found that the concentration of chlorine ion was 9 ppm.

### SYNTHESIS EXAMPLE 2

### Synthesis of Polymer Latex (P-2)

Into a polymerization furnace of gas monomer reaction apparatus (TAS-2J Model manufactured by Taiatu Techno Corp.), were put 287 g of distilled water, 19.7 g of a surface active agent (prepared by purifying Sandet BL (manufactured by Sanyo Chemical Industries, Ltd.) by Micro Acilyzer G3 (membrane: AC110-800) (manufactured by Asahi Chemical Industry Co., Ltd.) until the electric conductivity became unchanged; solid content: 30.4%), 15 ml of 1 mol/liter of an aqueous sodium hydroxide solution, 0.06 g of tetrasodium ethylenediaminetetraacetate, 213 g of styrene, 9.0 g of acrylic acid and 2.4 g of tert-dodecylmercaptan, the reaction apparatus was sealed and stirred at a stirring rate of 200 rpm. After repeating several times degassing by a vacuum pump and substitution with nitrogen gas, 78.0 g of 1,3-butadiene was charged in the reaction apparatus with pressure and the inner temperature was raised to 60° C. To the mixture was added a solution of 0.6 g of sodium persulfate dissolved in 40 ml of water, followed by stirring for 5 hours. The inner temperature was raised to 90° C., followed by stirring for 3 hours. After the completion of the reaction, the inner temperature was lowered to room temperature, and the resulting polymer latex was filtered with a paper towel to obtain 615 g of Polymer Latex (P-2) (solid content: 45%, particle size: 76 nm, gel fraction: 65%). As a result of measurement of the halogen ion content by an ion chromatography, it was found that the concentration of chlorine ion was 10 ppm.

### SYNTHESIS EXAMPLE 3

### Synthesis of Polymer Latex (P-20)

Into a three-necked glass flask equipped with a stirrer and a condenser, were put 297 g of distilled water, 9.9 g of a surface active agent (prepared by purifying Sandet BL (manufactured by Sanyo Chemical Industries, Ltd.) by Micro Acilyzer G3 (membrane: AC110-800)(manufactured by Asahi Chemical Industry Co., Ltd.) until the electric conductivity became unchanged; solid content: 30.4%), 15 ml of 1 mol/liter of an aqueous sodium hydroxide solution, 135 g of methyl methacrylate, 150 g of butyl acrylate, 15 g of sodium styrenesulfonate and 2.4 g of tert-dodecylmercaptan, the mixture was stirred at a stirring rate of 200 rpm under nitrogen gas atmosphere and the inner temperature was raised to 60° C. To the mixture was added a solution of 0.6 g of sodium persulfate dissolved in 40 ml of water, followed by stirring for 5 hours. The inner temperature was raised to 90° C., followed by stirring for 3 hours. After the completion of the reaction, the inner temperature was lowered to room temperature, and the resulting polymer latex was filtered with a paper towel to obtain 610 g of Polymer Latex (P-20) (solid content: 45%, particle size: 93 nm, gel fraction: 0%). As a result of measurement of the halogen ion content by an ion chromatography, it was found that the concentration of chlorine ion was 8 ppm.

The gel fraction means a value determined in the following manner:

Into an aluminum foil plate was put 25 g of a latex sample, and the latex sample was dried at 60° C. for 2 hours by an air dryer. The dry film was further dried at 120° C. for 0.5 hours and cut into a sheet of 2 cm by 2 cm. The sheet was put into a wire netting basket (300 mesh) and allowed to stand in 60 ml of toluene for 16 hours or more. The basket was took out from the toluene and dried at 110° C. for one hour, and the weight of the sample remained in the basket was measured to determine the gel fraction.

While an aqueous solvent is used as a solvent in a coating solution of the polymer latex for use in the present invention, a water-miscible organic solvent may be used together. Examples of the water-miscible organic solvent include an alcohol solvent, e.g., methyl alcohol, ethyl alcohol or propyl alcohol, a cellosolve solvent, e.g., methyl cellosolve, ethyl cellosolve or butyl cellosolve, ethyl acetate and dimethylformamide. An amount of the organic solvent added is preferably not more than 50% by weight, more preferably not more than 30% by weight, based on the whole solvent.

With respect to the amount of polymer latex (binder) for use in the present invention, which is added to an organic silver salt-containing layer, a weight ratio of total binder/organic silver salt is preferably in a range of from 1/10 to 10/1, more preferably from 1/5 to 4/1.

The organic silver salt-containing layer is usually also a light-sensitive layer (emulsion layer) containing light-sensitive silver halide that is a light-sensitive silver salt. In such a case, a weight ratio of total binder/silver halide is preferably in a range of from 400 to 5, more preferably from 200 to 10.

The total amount of binder in an image-forming layer is preferably in a range of from 0.2 to 30 g/m², more preferably from 1 to 15 g/m². To the image-forming layer may be added other additives, for example, a crosslinking agent for forming crosslinkage or a surface active agent for improving the coating property.

<Reducing Agent>

The reducing agent will be described in greater detail below.

Although a hitherto known reducing agent may be used as the reducing agent for use in the present invention, it is preferred to employ a combination comprising (1) at least one phenol compound and (2) at least one compound which satisfies one of Condition (A) (having a hydrogen bond-forming rate constant (Kf) of from 20 to 4,000) and Condition (B) (having a structure represented by the above-described formula (II), (III), (IV) or (V), or a phosphoryl group in its molecule) in the present invention. The use of the specific phenol compound and the specific compound in combination is preferred in view of the effect that the image preservability is greatly improved while substantially maintaining good heat-developability.

The reducing agent for use in the present invention comprises at least one phenol compound. It is known to use the phenol compound as the reducing agent as described, for example, in EP-A-803,764, JP-A-51-51933 and JP-A-6-3793. These known phenol compounds are suitably used in the present invention. Among them, an o-polyphenol compound is preferred in view of good heat-developability. The term “o-polyphenol compound” used herein means a compound containing the following structure in its molecule:

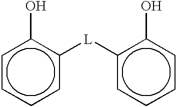

Particularly, the compound represented by formula (I) described above is preferred because of its greater heat-developerbility. Now, the compound represented by formula (I) is described in detail below.

In formula (I), R¹, R², R³, R⁴, R⁵, R⁶, R⁷ and R⁸, which may be the same or different, each represents a hydrogen atom or a substituent capable of being substituted on the benzene ring. Examples of the substituent capable of being substituted on the benzene ring include a halogen atom, an alkyl group, an aryl group, an aralkyl group, an alkoxy group, an acylamino group, a sulfonamido group, an acyl group, a carbamoyl group, a sulfamoyl group, an alkoxycarbonyl group, a sulfonyl group, an alkoxyalkyl group and an acylaminoalkyl group. Examples of the alkyl group include methyl, ethyl, propyl, butyl, isopropyl, tert-butyl, tert-amyl, cyclohexyl and 1-methylcyclohexyl groups. Examples of the aralkyl group include benzyl group.

R¹, R³, R⁶ and R⁸, which may be the same or different, each represents preferably an alkyl group, more preferably a primary alkyl group having from 1 to 20 carbon atoms, a secondary alkyl group having from 3 to 20 carbon atoms or a tertiary alkyl group having from 4 to 20 carbon atoms.

These substituents may further have an appropriate substituent. Examples of such a substituent include a halogen atom, an aryl group, a heterocyclic group, an alkoxy group, an aryloxy group, an alkylthio group, an arylthio group, a hydroxy group, an acyloxy group, an amino group, an alkoxycarbonyl group, an acyl group, an acylamino group, an oxycarbonyl group, a carbamoyl group, a sulfonyl group, a sulfamoyl group, a sulfonamido group, a phosphoryl group and a carboxy group.

Examples of the primary alkyl group include methyl, ethyl, propyl, butyl, pentyl, hexyl, heptyl, octyl, nonyl, decyl, benzyl, methoxymethyl, 2-ethoxyethyl, phenethyl and hexyloxycarbonylmethyl groups. Preferred examples thereof include methyl and ethyl groups.

Examples of the secondary alkyl group include isopropyl, cyclohexyl, cyclopentyl, 1-methoxymethylethyl and 1-butoxyethylethyl groups. Preferred examples thereof include an unsubstituted secondary alkyl group. Particularly, isopropyl and cyclohexyl groups are preferred.

Examples of the tertiary alkyl group include tert-butyl, tert-amyl, tert-octyl, 1-methylcyclohexyl, 1-methylcyclopentyl, 1-methylcyclopropyl, 1-methyl-1-phenylethyl and 1,1-dimethyl-4-hexyloxycarbonylbutyl groups. Preferred examples thereof include an unsubstituted tertiary alkyl group. Particularly, tert-butyl and 1-methylcyclohexyl groups are preferred. Most preferred is tert-butyl group.

R¹ and R⁸, which may be the same or different, each represents preferably a secondary alkyl group or a tertiary alkyl group. The selection of secondary alkyl group or tertiary alkyl group is able to remarkably reduce a coating amount, and as a result, cost and labor for the production of heat-developable image recording material can be significantly cut. In case of using the secondary alkyl group or tertiary alkyl group, the image stability severely degrades, if a compound having a phosphoryl group is not used in combination. On the contrary, the image stability is greatly improved by the combination according to the present invention. From the standpoint of development activity, the tertiary alkyl group is preferred for R¹ and R⁸. Although R¹ and R may be the same or different from each other, it is more preferred that they are the same.

R³ and R⁶, which may be the same or different, each represents preferably an unsubstituted alkyl group. Examples of the unsubstituted alkyl group include methyl, ethyl, propyl, butyl, isopropyl, tert-butyl, tert-amyl, cyclohexyl and 1-methylcyclohexyl groups. More preferred examples thereof include methyl, ethyl, isopropyl and tert-butyl groups. Most preferred are methyl and ethyl groups.

R², R⁴, R⁵ and R⁷, which may be the same or different, each represents preferably a hydrogen atom, a halogen atom or an alkyl group, more preferably a hydrogen atom.

L represents —S— or —CHR⁹—, and R⁹ represents a hydrogen atom or an alkyl group. The alkyl group has preferably from 1 to 20 carbon atoms, and may be unsubstituted or substituted. Examples of the unsubstituted alkyl group include methyl, ethyl, propyl, butyl, heptyl, undecyl, isopropyl, 1-ethylpentyl and 2,4,4-trimethylpentyl groups. The substituent for the alkyl group is same as that for R¹, R³, R⁶ and R⁸. R⁹ represents preferably a hydrogen atom or an unsubstituted alkyl group having from 1 to 12 carbon atoms, more preferably a hydrogen atom or an unsubstituted alkyl group having from 1 to 7 carbon atoms, and particularly preferably hydrogen, methyl or n-propyl.

Specific examples of the compound represented by formula (I) (Compounds (1-1) to (1-34)) are set forth below, but the present invention should not be construed as being limited thereto.

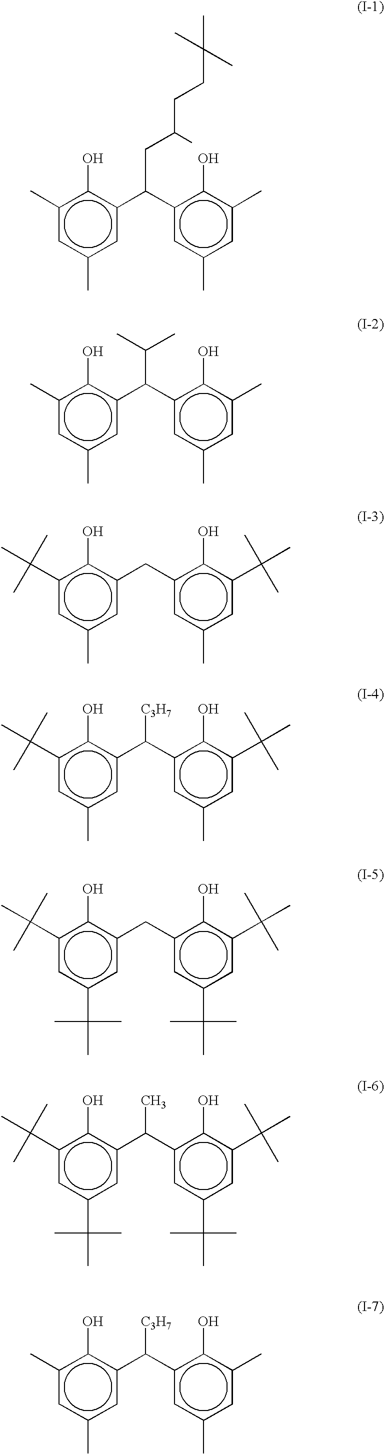

Specific examples of the phenol compound also include those described in EP-A-803,764, JP-A-51-51933 and JP-A-6-3793.

An amount of the phenol compound added is preferably from 0.01 to 4.0 g/m², more preferably from 0.1 to 2.0 g/m². A content of the phenol compound is preferably from 2 to 40% by mole, more preferably from 5 to 30% by mole, based on one mole of silver present on the side of image-forming layer.

Now, the compound having a hydrogen bond-forming rate constant (Kf) of from 20 to 4,000 is described in detail below.

The hydrogen bond-forming rate constant (Kf), which is used as a criterion of the formation of hydrogen bond, is described, for example, in R. W. Taft et al, J. Am. Chem. Soc., Vol. 91, page 4794 (1969). It is a reaction rate constant when a hydrogen bond is formed between p-FC₆H₄OH and the subject compound and measured by F-NMR, IR or a thermodynamic technique. The hydrogen bond-forming rate constants (Kf) of various compounds are described in R. W. Taft et al, J. Am. Chem. Soc., Vol. 91, page 4794 (1969). In the present invention, the hydrogen bond-forming rate constant (Kf) is preferably from 20 to 4,000, more preferably from 70 to 4,000, still more preferably from 100 to 4,000, and particularly preferably from 250 to 2,000. Representative examples of the compound having the hydrogen bond-forming rate constant (Kf) of from 20 to 4,000 are set forth below, but the present invention should not be construed as being limited thereto.

| Compound | Kf |
|---|---|
| Hexamethylphosphamide | 3,600 |
| Triphenylphosphinoxide | 1,456 ± 80 |
| 4-Dimethylaminopyridine | 650 ± 90 |
| Dimethylsulfoxide | 388 ± 7 |
| 2,6-Dimethyl-γ-pyrone | 318 ± 18 |
| Tetramethylurea | 261 ± 5 |
| Trimethyl phosphate | 250 ± 8 |
| N,N-Dimethylacetoamide | 242 ± 6 |
| N,N-Dimethylbenzamide | 167 ± 16 |
| Phenylmethylsulfoxide | 141 ± 4 |
| 4-Methoxypyridine | 139 ± 2 |
| 4-Methylpyridine | 107 ± 2 |
| N,N-Dimethylcyclohexylamine | 118 ± 2 |
| N,N-Dimethylformamide | 115 ± 2 |
| Diphenylsulfoxide | 106 ± 2 |
| Flavone | 98 ± 6 |
| N,N-Dimethyl-n-propylamine | 95 ± 1 |
| Trimethylamine | 85 ± 2 |
| 2-n-Butylpyridine | 76 ± 2 |
| Pyridine | 76 ± 1 |
| Quinoline | 71 ± 3 |
| Tri-n-butylamine | 37 ± 3 |
| N,N-Dimethylbenzylamine | 38 ± 3 |
| Pyrimidine | 22.5 ± 0.5 |

Now, the compound represented by formula (II) is described in detail below.

In formula (II), R²¹ and R²², which may be the same or different, each represents an alkyl group, and R²³ represents an alkyl group, an aryl group or a heterocyclic group. Each of these groups may be unsubstituted or substituted. Examples of the substituent include those described with respect to R⁵¹ below. Specific examples of the alkyl group represented by R²¹ R²² or R²³ include methyl, ethyl, propyl, butyl, isopropyl, tert-butyl, tert-amyl, cyclohexyl, 1-methylcyclohexyl and benzyl groups. Specific examples of the aryl group represented by R²³ include phenyl, p-tolyl and p-methoxyphenyl groups. Specific examples of the heterocyclic group represented by R²³ include 2-tetrahydrofuryl and 4-pyridyl groups. Each of these substituents may further be unsubstituted. The alkyl group described herein does not include an alkenyl group and an alkynyl group. Alternatively, two or more of R²¹, R²² and R²³ may be combined with each other to form a ring.

Now, the compound represented by formula (III) is described in detail below.

In formula (III), R³¹ and R³², which may be the same or different, each represents an alkyl group, an aryl group or a heterocyclic group. Each of these groups may be unsubstituted or substituted. Examples of the substituent include those described with respect to R⁵¹ below. Specific examples of the alkyl group represented by R³¹ or R³² include methyl, ethyl, propyl, butyl, isopropyl, tert-butyl, tert-amyl, cyclohexyl, 1-methylcyclohexyl and benzyl groups. Specific examples of the aryl group represented by R³¹ or R³² include phenyl, p-tolyl and p-methoxyphenyl groups. Specific examples of the heterocyclic group represented by R³¹ or R³² include 2-tetrahydrofuryl and 4-pyridyl groups. Each of these substituents may further be unsubstituted. Alternatively, R³¹ and R³² may be combined with each other to form a ring.

Now, the compound represented by formula (IV) is described in detail below.

In formula (IV), R⁴¹ and R⁴², which may be the same or different, each represents an alkyl group, an aryl group or a heterocyclic group, R⁴³ represents an alkyl group, an aryl group, a heterocyclic group or —N(R⁴⁴) (R⁴⁵), and R⁴⁴ and R which may be the same or different, each represents an alkyl group, an aryl group or a heterocyclic group. Each of these groups may be unsubstituted or substituted. Examples of the substituent include those described with respect to R⁵¹ below. Specific examples of the alkyl group represented by R⁴¹, R⁴², R⁴³, R⁴⁴ or R⁴⁵ include methyl, ethyl, propyl, butyl, isopropyl, tert-butyl, tert-amyl, cyclohexyl, 1-methylcyclohexyl and benzyl groups. Specific examples of the aryl group represented by R⁴¹, R⁴², R⁴³, R⁴⁴ or R⁴⁵ include phenyl, p-tolyl and p-methoxyphenyl groups. Specific examples of the heterocyclic group represented by R⁴¹, R⁴², R⁴³, R⁴⁴ or R⁴⁵ include 2-tetrahydrofuryl and 4-pyridyl groups. Each of these substituents may further be unsubstituted. Alternatively, two or more of R⁴¹, R⁴², R⁴³, R⁴⁴ and R⁴⁵ may be combined with each other to form a ring.

Now, the compound represented by formula (V) is described in detail below.

In formula (V), R⁵¹, R⁵², R⁵³, R⁵⁴ and R⁵⁵, which may be the same or different, each represents a hydrogen atom or a substituent. Examples of the substituent include a straight-chain, branched or cyclic alkyl group, a straight-chain, branched or cyclic alkenyl group, an alkynyl group, an aryl group, an acyloxy group, an alkoxycarbonyloxy group, an aryloxycarbonyloxy group, a carbamoyloxy group, a carbonamido group, a sulfonamido group, a carbamoyl group, a sulfamoyl group, an alkoxy group, an aryloxy group, an aryloxycarbonyl group, an alkoxycarbonyl group, an N-acylsulfamoyl group, an N-sulfamoylcarbamoyl group, an alkylsulfonyl group, an arylsulfonyl group, an alkoxycarbonylamino group, an aryloxycarbonylamino group, an amino group, an ammonio group, a cyano group, a nitro group, a carboxy group, a hydroxy group, a sulfo group, a mercapto group, an alkylsulfinyl group, an arylsulfinyl group, an alkylthio group, an arylthio group, a ureido group, a heterocyclic group (for example, including at least one of a nitrogen atom, an oxygen atom and a sulfur atom, and a 3-membered to 12-membered single ring or condensed ring), a heterocyclicoxy group, a heterocyclicthio group, an acyl group, a sulfamoylamino group, a silyl group and a halogen atom.

Specifically, R⁵¹, R⁵², R⁵³, R⁵⁴ and R⁵⁵, which may be the same or different, each represents a hydrogen atom, a straight-chain, branched or cyclic alkyl group having from 1 to 10 carbon atoms (e.g., trifluoromethyl, methyl, ethyl, propyl, heptafluoropropyl, isopropyl, butyl, tert-butyl, tert-pentyl, cyclopentyl, cyclohexyl, octyl or 2-ethylhexyl), a straight-chain, branched or cyclic alkenyl group having from 2 to 10 carbon atoms (e.g., vinyl, 1-methylvinyl or cyclohexen-1-yl), an alkynyl group having from 2 to 10 carbon atoms (e.g., ethynyl or 1-propynyl), an aryl group having from 6 to 14 carbon atoms (e.g., phenyl or naphthyl), an acyloxy group having from 1 to 10 carbon atoms (e.g., acetoxy or benzoyloxy), an alkoxycarbonyloxy group having from 2 to 10 carbon atoms (e.g., methoxycarbonyloxy or 2-methoxyethoxycarbonyloxy), an aryloxycarbonyloxy group having from 7 to 14 carbon atoms (e.g., phenoxycarbonyloxy), a carbamoyloxy group having from 1 to 12 carbon atoms (e.g., N,N-dimetylcarbamoyloxy), a carbonamido group having from 1 to 12 carbon atoms (e.g., formamido, N-methylacetamido, acetamido, N-methylformamido or benzamido), a sulfonamido group having from 1 to 10 carbon atoms (e.g., methanesulfonamido, benzenesulfonamido or p-toluenesulfonamido), a carbamoyl group having from 1 to 10 carbon atoms (e.g., N-methylcarbamoyl, N,N-diethylcarbamoyl or N-mesylcarbamoyl), a sulfamoyl group having from 0 to 10 carbon atoms (e.g., N-butylsulfamoyl, N,N-diethylsulfamoyl or N-methyl-N-(4-methoxyphenyl)sulfamoyl), an alkoxy group having from 1 to 10 carbon atoms (e.g., methoxy, propoxy, isopropoxy, octyloxy or tert-octyloxy), an aryloxy group having from 6 to 14 carbon atoms (e.g., phenoxy, 4-methoxyphenoxy or naphthoxy), an aryloxycarbonyl group having from 7 to 14 carbon atoms (e.g., phenoxycarbonyl or naphthoxycarbonyl), an alkoxycarbonyl group having from 2 to 10 carbon atoms (e.g., methoxycarbonyl or tert-butoxycarbonyl), an N-acylsulfamoyl group having from 1 to 12 carbon atoms (e.g., N-acetylsulfamoyl or N-benzoylsulfamoyl), an N-sulfamoylcarbamoyl group having from 1 to 12 carbon atoms (e.g., N-methanesulfonylcarbamoyl), an alkylsulfonyl group having from 1 to 10 carbon atoms (e.g., methanesulfonyl, octylsulfonyl or 2-methoxyethylsulfonyl), an arylsulfonyl group having from 6 to 14 carbon atoms (e.g., benzenesulfonyl, p-toluenesulfonyl or 4-phenylsulfonylphenylsulfonyl), an alkoxycarbonylamino group having from 2 to 10 carbon atoms (e.g., ethoxycarbonylamino), an aryloxycarbonylamino group having from 7 to 14 carbon atoms (e.g., phenoxycarbonylamino or naphthoxycarbonylamino), an amino group having from 0 to 10 carbon atoms (e.g., amino, methylamino, diethylamino, diisopropylamino, anilino or morpholino), an ammonio group having from 3 to 12 carbon atoms (e.g., trimethylammonio or dimethylbenzylammonio), a cyano group, a nitro group, a carboxy group, a hydroxy group, a sulfo group, a mercapto group, an alkylsulfinyl group having from 1 to 10 carbon atoms (e.g., methanesulfinyl or octanesulfinyl), an arylsulfinyl group having from 6 to 14 carbon atoms (e.g., benzenesulfinyl, 4-chlorophenylsulfinyl or p-toluenesulfinyl), an alkylthio group having from 1 to 10 carbon atoms (e.g., methylthio, octylthio or cyclohexylthio), an arylthio group having from 6 to 14 carbon atoms (e.g., phenylthio or naphthylthio), a ureido group having from 1 to 13 carbon atoms (e.g., 3-methylureido, 3,3-dimethylureido or 1,3-diphenylureido), a heterocyclic group having from 2 to 15 carbon atoms (for example, including at least one of a nitrogen atom, an oxygen atom and a sulfur atom, and a 3-membered to 12-membered single ring or condensed ring, e.g., 2-furyl, 2-pyranyl, 2-pyridyl, 2-thienyl, 2-imidazolyl, morpholino, 2-quinolyl, 2-benzimidazolyl, 2-benzothiazolyl or 2-benzoxazolyl), a heterocyclicoxy group having from 2 to 15 carbon atoms (e.g., pyridyloxy or pyrazolyloxy), a heterocyclicthio group having from 2 to 15 carbon atoms (e.g., tetrazolylthio, 1,3,4-thiadiazolylthio, 1,3,4-oxadiazolylthio or benzimidazolylthio), an acyl group having from 1 to 12 carbon atoms (e.g., acetyl, benzoyl or trifluoroacetyl), a sulfamoylamino group having from 0 to 10 carbon atoms (e.g., N-butylsulfamoylamino or N-phenylsulfamoylamino), a silyl group having from 3 to 12 carbon atoms (e.g., trimethylsilyl or dimethyl-tert-butylsilyl), and a halogen atom (e.g., fluorine, chlorine or bromine). Each of these substituents may further be substituted. Examples of such substituent include those described above. Alternatively, two or more of R⁵¹, R⁵², R⁵³, R⁵⁴ and R⁵⁵ may be combined with each other to form a ring.

Specific examples of the compounds represented by formulae (II), (III), (IV) and (V) (Compounds (1) to (32)), which are electron donative compounds, are set forth below, but the present invention should not be construed as being limited thereto.

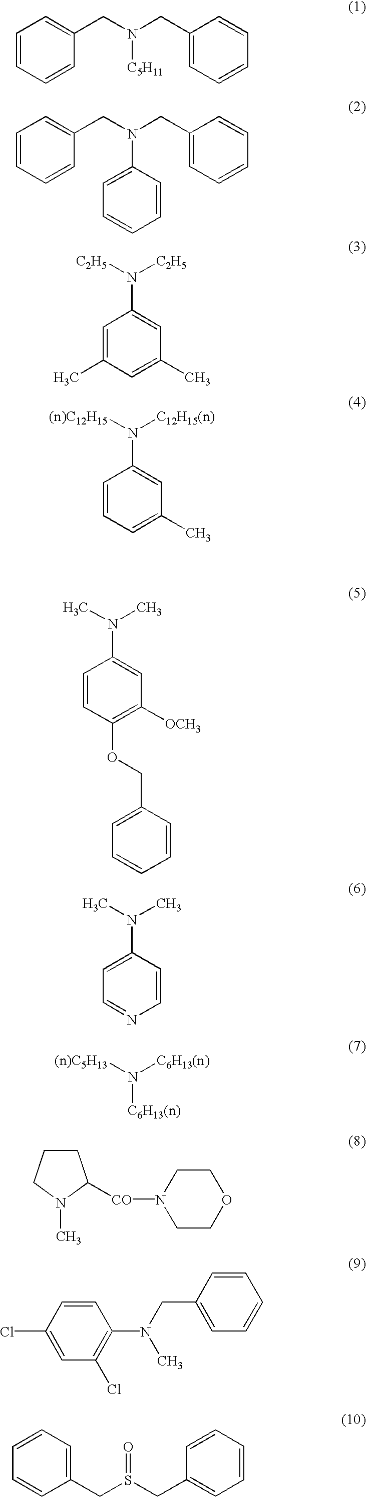

Now, the compound having a phosphoryl group is described in detail below.

The compound having a phosphoryl group for use in the present invention (hereinafter also referred to as a phosphoryl compound) may be any compound which has at least one phosphoryl group in its molecule. Particularly, a compound represented by formula (VI) described above is preferred.

In formula (VI), R⁶¹, R⁶² and R⁶³, which may be the same or different, each represents an alkyl group, an aryl group, an aralkyl group, an alkoxy group, an aryloxy group, an amino group or a heterocyclic group. Each of these groups may be unsubstituted or substituted.

Examples of the alkyl group include methyl, ethyl, butyl, octyl, dodecyl, isopropyl, tert-butyl, tert-amyl, tert-octyl, cyclohexyl and 1-methylcyclohexyl groups. Examples of the aryl group include phenyl, cresyl, xylyl, naphthyl, 4-tert-butylphenyl, 4-tert-octylphenyl, 4-anisidyl and 3,5-dichlorophenyl groups. Examples of the aralkyl group include benzyl, phenethyl and 2-phenoxypropyl groups. Examples of the alkoxy group include methoxy, ethoxy, butoxy, octyloxy, 2-ethylhexyloxy, 3,5,5-trimethylhexyloxy, dodecyloxy, cyclohexyloxy, 4-methylcyclohexyloxy and benzyloxy groups. Examples of the aryloxy group include phenoxy, cresyloxy, isopropylphenoxy, 4-tert-butylphenoxy, naphthoxy and biphenyloxy groups. Examples of the amino group include dimethylamino, diethylamino, dibutylamino, dioctylamino, N-methyl-N-hexylamino, dicyclohexylamino, diphenylamino and N-methyl-N-phenylamino groups.

Preferably, R⁶¹, R⁶² and R⁶³ each represents an alkyl group, an aryl group, an alkoxy group and an aryloxy group. More preferably, at least one of R⁶¹, R⁶² and R⁶³ is an alkyl group or an aryl group, and still more preferably, at least two of R⁶¹, R⁶² and R⁶³ are selected from an alkyl group and an aryl group. From the standpoint of availability of low price, it is preferred that R⁶¹, R⁶² and R⁶³ are the same groups. When the group represented by R⁶¹, R⁶² or R⁶³ has a substituent, examples of the substituent include a halogen atom, an alkyl group, an aryl group, an alkoxy group, an amino group, an acyl group, an acylamino group, an alkylthio group, an arylthio group, a sulfonamido group, an acyloxy group, an oxycarbonyl group, a carbamoyl group, a sulfamoyl group, a sulfonyl group and a phosphoryl group. Preferred examples of R⁶¹, R⁶² and R⁶³ include a substituted or unsubstituted alkyl, aryl, alkoxy and aryloxy groups, and specifically, methyl, ethyl, isopropyl, tert-butyl, tert-octyl, phenyl, 4-alkoxyphenyl, 4-acyloxyphenyl, methoxy and phenoxy groups.

R⁶³ is preferably a phenyl group, and more preferably a phenyl group at least one of the ortho positions of which is substituted. Examples of the substituent for the ortho position include a straight-chain, branched or cyclic alkyl group, a straight-chain, branched or cyclic alkenyl group, an alkynyl group, an aryl group, an acyloxy group, an alkoxycarbonyloxy group, an aryloxycarbonyloxy group, a carbamoyloxy group, a carbonamido group, a sulfonamido group, a carbamoyl group, a sulfamoyl group, an alkoxy group, an aryloxy group, an aryloxycarbonyl group, an alkoxycarbonyl group, an N-acylsulfamoyl group, an N-sulfamoylcarbamoyl group, an alkylsulfonyl group, an arylsulfonyl group, an alkoxycarbonylamino group, an aryloxycarbonylamino group, an amino group, an ammonio group, a cyano group, a nitro group, a carboxy group, a hydroxy group, a sulfo group, a mercapto group, an alkylsulfinyl group, an arylsulfinyl group, an alkylthio group, an arylthio group, a ureido group, a heterocyclic group (for example, including at least one of a nitrogen atom, an oxygen atom and a sulfur atom, and a 3-membered to 12-membered single ring or condensed ring), a heterocyclicoxy group, a heterocyclicthio group, an acyl group, a sulfamoylamino group, a silyl group and a halogen atom.

Specifically, the substituent includes a straight-chain, branched or cyclic alkyl group having from 1 to 10 carbon atoms (e.g., trifluoromethyl, methyl, ethyl, propyl, heptafluoropropyl, isopropyl, butyl, tert-butyl, tert-pentyl, cyclopentyl, cyclohexyl, octyl or 2-ethylhexyl), a straight-chain, branched or cyclic alkenyl group having from 2 to 10 carbon atoms (e.g., vinyl, 1-methylvinyl or cyclohexen-1-yl), an alkynyl group having from 2 to 10 carbon atoms (e.g., ethynyl or 1-propynyl), an aryl group having from 6 to 14 carbon atoms (e.g., phenyl or naphthyl), an acyloxy group having from 1 to 10 carbon atoms (e.g., acetoxy or benzoyloxy), an alkoxycarbonyloxy group having from 2 to 10 carbon atoms (e.g., methoxycarbonyloxy or 2-methoxyethoxycarbonyloxy), an aryloxycarbonyloxy group having from 7 to 14 carbon atoms (e.g., phenoxycarbonyloxy), a carbamoyloxy group having from 1 to 12 carbon atoms (e.g., N,N-dimetylcarbamoyloxy), a carbonamido group having from 1 to 12 carbon atoms (e.g., formamido, N-methylacetamido, acetamido, N-methylformamido or benzamido), a sulfonamido group having from 1 to 10 carbon atoms (e.g., methanesulfonamido, benzenesulfonamido or p-toluenesulfonamido), a carbamoyl group having from 1 to 10 carbon atoms (e.g., N-methylcarbamoyl, N,N-diethylcarbamoyl or N-mesylcarbamoyl), a sulfamoyl group having from 0 to 10 carbon atoms (e.g., N-butylsulfamoyl, N,N-diethylsulfamoyl or N-methyl-N-(4-methoxyphenyl)sulfamoyl), an alkoxy group having from 1 to 10 carbon atoms (e.g., methoxy, propoxy, isopropoxy, octyloxy or tert-octyloxy), an aryloxy group having from 6 to 14 carbon atoms (e.g., phenoxy, 4-methoxyphenoxy or naphthoxy), an aryloxycarbonyl group having from 7 to 14 carbon atoms (e.g., phenoxycarbonyl or naphthoxycarbonyl), an alkoxycarbonyl group having from 2 to 10 carbon atoms (e.g., methoxycarbonyl or tert-butoxycarbonyl), an N-acylsulfamoyl group having from 1 to 12 carbon atoms (e.g., N-acetylsulfamoyl or N-benzoylsulfamoyl), an N-sulfamoylcarbamoyl group having from 1 to 12 carbon atoms (e.g., N-methanesulfonylcarbamoyl), an alkylsulfonyl group having from 1 to 10 carbon atoms (e.g., methanesulfonyl, octylsulfonyl or 2-methoxyethylsulfonyl), an arylsulfonyl group having from 6 to 14 carbon atoms (e.g., benzenesulfonyl, p-toluenesulfonyl or 4-phenylsulfonylphenylsulfonyl), an alkoxycarbonylamino group having from 2 to 10 carbon atoms (e.g., ethoxycarbonylamino), an aryloxycarbonylamino group having from 7 to 14 carbon atoms (e.g., phenoxycarbonylamino or naphthoxycarbonylamino), an amino group having from 0 to 10 carbon atoms (e.g., amino, methylamino, diethylamino, diisopropylamino, anilino or morpholino), an ammonio group having from 3 to 12 carbon atoms (e.g., trimethylammonio or dimethylbenzylammonio), a cyano group, a nitro group, a carboxy group, a hydroxy group, a sulfo group, a mercapto group, an alkylsulfinyl group having from 1 to 10 carbon atoms (e.g., methanesulfinyl or octanesulfinyl), an arylsulfinyl group having from 6 to 14 carbon atoms (e.g., benzenesulfinyl, 4-chlorophenylsulfinyl or p-toluenesulfinyl), an alkylthio group having from 1 to 10 carbon atoms (e.g., methylthio, octylthio or cyclohexylthio), an arylthio group having from 6 to 14 carbon atoms (e.g., phenylthio or naphthylthio), a ureido group having from 1 to 13 carbon atoms (e.g., 3-methylureido, 3,3-dimethylureido or 1,3-diphenylureido), a heterocyclic group having from 2 to 15 carbon atoms (for example, including at least one of a nitrogen atom, an oxygen atom and a sulfur atom, and a 3-membered to 12-membered single ring or condensed ring, e.g., 2-furyl, 2-pyranyl, 2-pyridyl, 2-thienyl, 2-imidazolyl, morpholino, 2-quinolyl, 2-benzimidazolyl, 2-benzothiazolyl or 2-benzoxazolyl), a heterocyclicoxy group having from 2 to 15 carbon atoms (e.g., pyridyloxy or pyrazolyloxy), a heterocyclicthio group having from 2 to 15 carbon atoms (e.g., tetrazolylthio, 1,3,4-thiadiazolylthio, 1,3,4-oxadiazolylthio or benzimidazolylthio), an acyl group having from 1 to 12 carbon atoms (e.g., acetyl, benzoyl or trifluoroacetyl), a sulfamoylamino group having from 0 to 10 carbon atoms (e.g., N-butylsulfamoylamino or N-phenylsulfamoylamino), a silyl group having from 3 to 12 carbon atoms (e.g., trimethylsilyl or dimethyl-tert-butylsilyl), and a halogen atom (e.g., fluorine, chlorine or bromine).

Such a substituent may be present on the position other than the ortho position of the phenyl group represented by R⁶³.

When R represents a phenyl group having a substituent on the ortho position thereof, R⁶¹ and R⁶² each preferably represents an alkyl group or an aryl group.

Specific examples of the compound having a phosphoryl group (Compounds (II-1) to (II-90)) are set forth below, but the present invention should not be construed as being limited thereto.

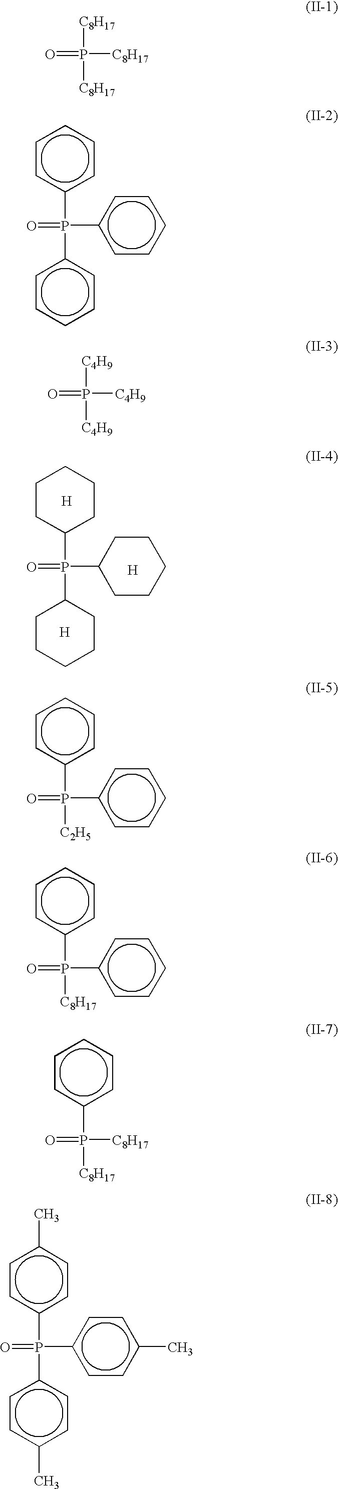

An amount of the compound which satisfies at least one of Conditions (A) and (B) added is preferably from 0.01 to 4.0 g/m², more preferably from 0.1 to 2.0 g/m². A content of the compound which satisfies at least one of Conditions (A) and (B) is preferably from 2 to 40% by mole, more preferably from 5 to 30% by mole, based on one mole of silver present on the side of image-forming layer.

A ratio of the addition amount of phenol compound (compound represented by formula (I)) to compound which satisfies at least one of Conditions (A) and (B) is preferably in a range of from 0.1 to 10, more preferably from 0.1 to 2.0, and still more preferably from 0.5 to 1.5.

The phenol compound (compound represented by formula (I)) and the compound which satisfies at least one of Conditions (A) and (B) are preferably incorporated into the image-forming layer containing the organic silver salt. However, one of them may be incorporated into the image-forming layer and the other may be incorporated into a nonimage-forming layer adjacent to the image-forming layer. Also, both of them may be incorporated into the nonimage-forming layer. Further, when the image-forming layer is composed of plural layers, each of them may be incorporated into different layers.

The phenol compound (compound represented by formula (I)) and the compound which satisfies at least one of Conditions (A) and (B) may be included in a coating solution in any form, for example, a solution, an emulsified dispersion and a solid fine particle dispersion, thereby being incorporated into the image recording material.

As a well-known method of emulsified dispersion, there is a method wherein the compound is dissolved using oil, e.g., dibutyl phthalate, tricresyl phosphate, glycerol triacetate or diethyl phthalate, and an auxiliary solvent, e.g., ethyl acetate or cyclohexanone, and using the resulting solution, an emulsified dispersion is mechanically prepared.

As a method of solid fine particle dispersion, there is a method wherein powder of the phenol compound (compound represented by formula (I)) and the compound which satisfies at least one of Conditions (A) and (B) is dispersed in an appropriate solvent, e.g., water using a ball mill, a colloid mill, a vibrating ball mill, a sand mill, a jet mill, a roller mill or ultrasonic wave to prepare a solid dispersion. In such a case, a protective colloid, e.g., polyvinyl alcohol, or a surface active agent, for example, an anionic surface active agent, e.g., sodium triisopropylnaphthalenesulfonate (a mixture of those wherein the substitution positions of three isopropyl groups are different) may be used. Into an aqueous dispersion, an antiseptic, e.g., benzisothiazolinone sodium salt may be incorporated.

<Light-Insensitive Organic Silver Salt>

Now, the light-insensitive organic silver salt is described in detail below.

The light-insensitive organic silver salt for use in the present invention is preferably a silver salt that is relatively stable to light but capable of forming a silver image when heated at 80° C. or higher in the presence of an exposed photo-catalyst (e.g., a latent image of light-sensitive silver halide) and a heat developing agent (a reducing agent). The organic silver salt may be an appropriate organic substance containing a source capable of reducing a silver ion. Such a light-insensitive organic silver salt is described in JP-A-10-62899, Paragraph Nos. 0048 to 0049, EP-A-803,763, from page 18, line 24 to page 19, line 37, and EP-A-962,812. Among others, a silver salt of organic acid, particularly a silver salt of long-chain aliphatic carboxylic acid having from 10 to 30 carbon atoms, preferably from 15 to 28 carbon atoms is preferably used. Preferred examples of the silver salt of organic acid include silver behenate, silver arachidate, silver stearate, silver oleate, silver laurate, silver caprate, silver myristate, silver palmitate and a mixture thereof.

While a shape of the organic silver salt for use in the present invention is not particularly restricted, the organic silver salt having a scaly shape is preferred. The scaly organic silver salt is defined in the following manner. An organic silver salt particle is observed by means of an electron microscope, and a shape of the organic silver salt particle is approximated to a rectangular parallelepiped. When the sides of the rectangular parallelepiped are taken as a, b and c in the order from the shortest (c may be equal to b), x is calculated from the shorter numerical values, a and b, as follows:

x=b/a

With about 200 particles, x's are obtained by the above equation, and when an average value is taken as x (average), those particles satisfying the relationship of x (average)≧1.5 are regarded as scaly particles. Those particles satisfying the relationship of 30≧x (average)≧1.5 are preferred and those satisfying the relationship of 20≧x (average)≧2.0 are more preferred. By the way, particles satisfying the relationship of 1.5>x (average)≧1 are regarded as acicular particles.

In the scaly particle, a can be regarded as a thickness of a tabular particle of the organic silver salt having a plane with the sides of b and c as the main plane. An average of a is preferably from 0.01 to 0.23 μm, and more preferably from 0.1 to 0.20 μm. An average of c/b is preferably from 1 to 6, more preferably from 1.05 to 4, still more preferably from 1.1 to 3, and particularly preferably from 1.1 to 2.

It is preferred that the particle size distribution of organic silver salt for use in the present invention is mono-dispersed. The term “mono-dispersed” used herein means that a percentage of values obtained by dividing the standard deviation of short axis length and the standard deviation of long axis length by the average short axis length and the average long axis length respectively is preferably not more than 100%, more preferably not more than 80%, and still more preferably not more than 50%. The shape of organic silver salt can be determined from transmission electron microscope images of a dispersion of the organic silver salt. Another method for measuring the monodispersity is a method of determining a standard deviation of volume weighted average diameter of the organic silver salt. A percentage of value (variation coefficient) obtained by dividing the standard deviation by the volume weighted average diameter is preferably not more than 100%, more preferably not more than 80%, and still more preferably not more than 50%. The particle size (volume weighted average diameter) is obtained, for example, by irradiating the organic silver salt dispersed in liquid with a laser beam and determining an autocorrelation function of fluctuation of the scattered light to the time variation.

For the preparation and dispersion of organic silver salt for use in the present invention, known methods can be employed. For example, methods described in JP-A-10-62899, EP-A-803,763 and EP-A-962,812 are used.

In the present invention, an aqueous dispersion of the organic silver salt can be mixed with an aqueous dispersion of the light-sensitive silver salt to prepare an image recording material. While a mixing ratio of the light-sensitive silver salt to the organic silver salt is appropriately determined depending on the purpose, a ratio of the light-sensitive silver salt to the organic silver salt is preferably in a range of from 1 to 30 mol %, more preferably from 3 to 20 mol %, and particularly preferably from 5 to 15 mol %. A method of mixing two or more of the aqueous dispersions of organic silver salts with two or more of the aqueous dispersions of light-sensitive silver salts is preferably used in order to control the photographic characteristics.

While the organic silver salt is used in an appropriate amount, the amount thereof is preferably from 0.1 to 5 g/m², more preferably from 1 to 3 g/m² in terms of silver.

<Light-Sensitive Silver Halide>

Now, the light-sensitive silver halide is described in detail below.

The light-sensitive silver halide for use in the present invention is not particularly limited with respect to its halogen composition, and for example, silver chloride, silver chlorobromide, silver bromide, silver iodobromide and silver iodochlorobromide are used. In the silver halide grain, distribution of halide composition may be uniform, vary stepwise or vary continuously. Also, a silver halide grain having a core/shell structure is preferably used. The core/shell grain having from 2 to 5 layers, more preferably from 2 to 4 layers, is employed. Further, a silver chloride or silver chlorobromide grain having a localized silver bromide phase on the surface thereof is preferably used.

Methods for the production of light-sensitive silver halide for use in the present invention are well known in the field of art, and for example, those described in Research Disclosure, June 1978, Item 17029 and U.S. Pat. No. 3,700,458 can be used. Specifically, a silver-supplying compound and a halogen-supplying compound are added to a gelatin or other polymer solution to prepare a light-sensitive silver halide emulsion, and then the silver halide emulsion is mixed with the organic silver salt.

A grain size of the light-sensitive silver halide for use in the present invention is preferably small for the purpose of restraining white turbidity after the image formation. Specifically, the grain size is preferably not more than 0.20 μm, more preferably from 0.01 to 0.15 μm, and still more preferably from 0.02 to 0.12 μm. The term “grain size” used herein means a diameter of a sphere having a volume equal to the silver halide grain, when the silver halide grain has a regular crystal form, e.g., cubic grain or octahedral grain, or an irregular crystal form, e.g., spherical grain or rod-shaped grain. On the other hand, it means a diameter of a circle having an area equal to a projected area of the main plane of silver halide grain, when the silver halide grain is a tabular grain.

A shape of the silver halide grain for use in the present invention includes cubic grain, octahedral grain, tabular grain, spherical grain, rod-shaped grain and potato-shaped grain. In the present invention, cubic grain is particularly preferred. A silver halide grain corners of which are rounded is also preferably used. While a plane index (Miller index) of the outer surface of light-sensitive silver halide grain is not particularly limited, it is preferred that a proportion of {100} plane is high since the {100} plane exhibits a high spectral sensitization efficiency, when spectral sensitizing dyes are adsorbed thereon. The proportion of {100} plane is preferably not less than 50%, more preferably not less than 65%, and still more preferably not less than 80%. A ratio of the Miller index of {100} plane can be determined according to the method utilizing adsorption dependence of spectral sensitizing dye on {100} plane and {111} plane described in T. Tani, J. Imaging Soc., Vol. 29, page 165 (1985).

The light-sensitive silver halide for use in the present invention contains preferably metal belonging to Groups VIII to X of the Periodic Table (showing Groups I to XVIII) or a complex thereof. Preferred examples of the metal or central metal of the metal complex belonging to Groups VIII to X include rhodium, rhenium, ruthenium, osmium and iridium. The metal complexes may be used alone or in combination of two or more of the complexes containing the same kind of metal or different kinds of metal. A content of the metal complex is preferably in a range of from 1×10⁻⁹ to 1×10⁻³ mol per mol of silver. The metal complexes are described in detail in JP-A-11-65021, Paragraph Nos. 0018 to 0024.

A silver halide containing an iridium compound is preferably used in the present invention. Examples of the iridium compound include hexachloroiridium, hexammineiridium, trioxalatoiridium, hexacyanoiridium and pentachloronitrosyliridium. The iridium compound is employed by dissolving it in water or other appropriate solvent. In order to stabilize the solution of iridium, a conventionally known method can be used. Specifically, a method of adding an aqueous hydrogen halide solution (e.g., hydrochloric acid, hydrobromic acid or hydrofluoric acid) or alkali halide (e.g., potassium chloride, sodium chloride, potassium bromide or sodium bromide) to the iridium solution is used. In place of using the iridium solution, it is possible to add silver halide grains containing iridium previously doped to be dissolved at the preparation of silver halide. An amount of the iridium compound added is preferably in a rang of from 1×10⁻⁸ to 1×10⁻³ mol, more preferably from 1×10⁻⁷ to 5×10⁻⁴ mol, per mol of silver halide.

A metal atom capable of being added to silver halide (e.g., [Fe(CN)₆]⁴⁻), a desalting method and a chemical sensitization method of silver halide emulsion for use in the present invention are described in JP-A-11-84574, Paragraph Nos. 0046 to 0050, and JP-A-11-65021, Paragraph Nos. 0025 to 0031.

In the heat-developable image recording material according to the present invention, a phenol derivative represented by formula (A) described in Japanese Patent Application No. 11-73951 is preferably used as a development accelerator.

A sensitizing dye applied to the silver halide for use in the present invention includes a dye that can spectrally sensitize a silver halide grain in the desired wavelength region, when the dye adsorbs on the silver halide grain, and a sensitizing dye having spectral sensitivity suitable for spectral characteristics of a light source for exposure can be appropriately selected. Examples of the spectral sensitizing dye and method for addition thereof include those described in JP-A-11-65021, Paragraph Nos. 0103 to 0109, compounds represented by formula (II) described in JP-A-10-186572, and those described in EP-A-803,764, from page 19, line 38 to page 20, line 35. The spectral sensitizing dye is preferably added to a silver halide emulsion after desalting and before coating, more preferably after desalting and before the initiation of chemical ripening.

An amount of the spectral sensitizing dye added can be appropriately selected taking characteristics such as sensitivity and fog into consideration, and is preferably in a rang of from 10⁻⁶ to 1 mol, more preferably from 10⁻⁴ to 10⁻¹ mol, per mol of silver halide in the light-sensitive layer.

A supersensitizing agent may also be used in the present invention. Examples of the supersensitizing agent include compounds described, for example, in EP-A-587,338, U.S. Pat. Nos. 3,877,943 and 4,873,184, JP-A-5-341432, JP-A-11-109547 and JP-A-10-111543.

It is preferred that the light-sensitive silver halide for use in the present invention is chemically sensitized with a sulfur sensitizing method, a selenium sensitizing method or a tellurium sensitizing method. Examples of compounds preferably used in the sulfur sensitizing method, selenium sensitizing method and tellurium sensitizing method include known compounds, for example, compounds described in JP-A-7-128,768. In the present invention, the tellurium sensitizing method is particularly preferably used. Examples of the tellurium sensitizer used include a diacyltelluride, a bis(oxycarbonyl)telluride, a bis(carbamoyl)telluride, a diacylditelluride, a bis(oxycarbonyl)ditelluride, a bis(carbamoyl)ditelluride, a compound containing a P=Te bond, a tellurocarboxylate, a tellurosulfonate, a compound containing a P—Te bond and a tellurocarbonyl compound. Specific examples of the tellurium sensitizer include compounds described in the literature cited in JP-A-11-65021, Paragraph No. 0030. Particularly, compounds represented by formulae (II), (III) and (IV) described in JP-A-5-313284 are preferred.

The chemical sensitization of light-sensitive silver halide for use in the present invention can be conducted at any stage after the grain formation and before coating. For example, it is carried out after desalting, (1) before spectral sensitization, (2) simultaneously with spectral sensitization, (3) after spectral sensitization, or (4) just before coating. Particularly, it is preferably conducted after spectral sensitization.

An amount of the sulfur, selenium or tellurium sensitizer used may vary depending on the silver halide grain, conditions of chemical ripening, etc., however, is ordinarily in a rang of from 10⁻⁸ to 10⁻² mol, preferably from 10⁻⁷ to 10⁻³ mol, per mol of silver halide. The conditions of chemical sensitization are not particularly restricted, and the chemical sensitization is conducted at pH of from 5 to 8, pAg of from 6 to 11, preferably from 7 to 10, and temperature of from 40 to 95° C., preferably from 44 to 70° C.

The light-sensitive silver halide (emulsion) for use in the present invention may be one kind, or two or more kinds, for example, those different in average grain size, halide composition, crystal habit or conditions of chemical sensitization. Gradation can be controlled by using two or more kinds of light-sensitive silver halide having different sensitivities, in combination. Such techniques are described, for example, in JP-A-57-119341, JP-A-53-106125, JP-A-47-3929, JP-A-48-55730, JP-A-46-5187, JP-A-50-73627 and JP-A-57-150841. With respect to the difference in sensitivity, it is preferred to use emulsions each having difference of not less than 0.2 in terms of log E.

An amount of the light-sensitive silver halide for use in the present invention is preferably from 0.03 to 0.6 g, more preferably from 0.05 to 0.4 g, and particularly preferably from 0.1 to 0.4 g, per m² of the image recording material in terms of silver. The amount of light-sensitive silver halide is preferably from 0.01 to 0.5 mol, more preferably from 0.02 to 0.3 mol, and particularly preferably from 0.03 to 0.25 mol, per mol of the organic silver salt.

With respect to a mixing method and mixing conditions of the light-sensitive silver halide and organic silver salt each prepared separately, there is a method of mixing the light-sensitive silver halide and organic silver salt separately prepared by means of a high-speed stirrer, a ball mill, a sand mill, a colloid mill, a vibration mill or a homogenizer. Also, a method wherein the light-sensitive silver halide prepared is mixed at an appropriate stage during the preparation of organic silver salt to prepare the organic silver salt is used. However, the mixing method and mixing conditions are not particularly limited as far as the effects of the present invention can be achieved.

A period of the addition of the light-sensitive silver halide for use in the present invention to a coating solution for the image forming layer is preferably from 180 minutes before coating to just before coating, preferably from 60 minutes before coating to 10 seconds before coating. A mixing method and mixing conditions are not particularly limited as far as the effect of the present invention can be achieved. Specifically, there are a method of mixing in a tank in which mean residence time calculated from an addition flow rate and a supply flow rate to a coater is controlled so as to be the desired time, and a method using a static mixer as described in N. Harnby, M. F. Edwards and A. W. Nienow, Ekitai Kongou Gijyutu, Chapter 8, translated by Kouji Takahashi, The Nikkan Kogyo Shimbun, Ltd. (1989).

<Support>

As the support for use in the present invention, a polyester film, particularly a polyethylene terephthalate film, which has been subjected to heat treatment in a temperature range of from 130 to 185° C. in order to relax the residual internal strain formed at the biaxial stretching of the film and to eliminate the strain of heat contraction generating during the heat development processing is preferably used. In case of a heat-developable image recording material for the medical use, a transparent support may be colored with a blue dye (for example, Dye-1 described in Example of JP-A-8-240877), or may not be colored.

To the support, techniques regarding a subbing layer using, for example, a water-soluble polyester described in JP-A-11-84574, a styrene-butadiene copolymer described in JP-A-10-186565 and a vinylidene chloride copolymer described in Japanese Patent Application No. 11-106881, Paragraph Nos. 0063 to 0080 are preferably applied. Also, techniques relating to an anti-static layer or a subbing layer described in JP-A-56-143430, JP-A-56-143431, JP-A-58-62646, JP-A-56-120519, JP-A-11-84573, Paragraph Nos. 0040 toOO51, U.S. Pat. No. 5,575,957, and JP-A-11-223898, Paragraph Nos. 0078 to 0084 may be applied.

The heat-developable image recording material according to the present invention is preferably a mono-sheet type (i.e., an image is formed on the heat-developable image recording material without using another sheet such as an image-receiving material).

<Other Components>

To the organic silver salt-containing layer of heat-developable image recording material according to the present invention, a hydrophilic polymer, for example, gelatin, polyvinyl alcohol, methyl cellulose or hydroxypropyl cellulose may be added, if desired. An amount of the hydrophilic polymer added is not more than 30% by weight, preferably not more than 20% by weight, based on the total amount of binder in the organic silver salt-containing layer.

A solvent (both of a solvent and a dispersion medium are together denoted as a solvent herein for convenience' sake) for a coating solution of the organic silver salt-containing layer in the heat-developable image recording material according to the present invention is an aqueous solvent containing at least 30% by weight of water. A component other than water may be appropriately selected from a water-miscible organic solvent including, for example, methyl alcohol, ethyl alcohol, isopropyl alcohol, methyl cellosolve, ethyl cellosolve, dimethylformamide and ethyl acetate. A content of water in the solvent for the coating solution is preferably not less than 50% by weight, and more preferably not less than 70% by weight. Preferred examples of the solvent composition include water/methyl alcohol (90/10 by weight), water/methyl alcohol (70/30 by weight), water/methyl alcohol/dimethylformamide (80/15/5 by weight), water/methyl alcohol/ethyl cellosolve (85/10/5 by weight) and water/methyl alcohol/isopropyl alcohol (85/10/5 by weight), as well as water.

Into the heat-developable image recording material according to the present invention, an antifoggant, a stabilizer and a stabilizer precursor may be incorporated. Examples of the antifoggant, stabilizer and stabilizer precursor include those described in JP-A-10-62899, Paragraph No. 0070, and the patents cited in EP-A-803,764, from page 20 line 57 to page 21, line 7. As the antifoggant, an organic halogen compound is preferably used. Examples of the organic halogen compound include those described in the patents cited in JP-A-11-65021, Paragraph Nos. 0111 to 0112. Particularly, an organic polyhalogen compound represented by formula (II) described in JP-A-10-33934, specifically, tribromomethylnaphthylsulfone, tribromomethylphenylsulfone or tribromomethyl(4-(2,4,6-trimethylphenylsulfonyl)phenyl)sulfone is preferred.

In order to incorporate the antifoggant into the heat-developable image recording material, the methods described for the incorporation of the heat developing agent can be employed. The polyhalogen compound is preferably added to the heat-developable image recording material in the form of solid fine particle dispersion.

Other examples of the antifoggant include a mercury (II) salt described in JP-A-11-65021, Paragraph No. 0113, a benzoic acid described in JP-A-11-65021, Paragraph No. 0114, a salicylic acid derivative represented by formula (Z) described in Japanese Patent Application No. 11-87297, and a formalin scavenger compound represented by formula (S) described in Japanese Patent Application No. 11-23995.

Into the heat-developable image recording material according to the present invention, an azolium salt may be incorporated for the purpose of inhibiting fog. Examples of the azolium salt include compounds represented by formula (XI) described in JP-A-59-193447, compounds described in JP-B-55-12581, and compounds represented by formula (II) described in JP-A-60-153039. The azolium salt may be added to any part of the heat-developable image recording material. However, it is preferably added to a layer positioned on the side having the light-sensitive layer, and more preferably to the organic silver salt-containing layer. The azolium salt may be added at any stage during the preparation of a coating solution. For example, in case of adding to the organic silver salt-containing layer, the azolium salt may be added at any stage during the preparation of organic silver salt and the preparation of coating solution for the organic silver salt-containing layer. However, it is preferably added at a stage after the preparation of organic silver salt and just before coating. The azolium salt may be added in any form, for example, of powder, a solution or a fine particle dispersion. Also, it may be added as a solution mixed with one or more other additives, for example, a sensitizing dye, a heat developing agent or a toning agent.

An amount of the azolium salt added is not particularly restricted and it is preferably from 1×10⁻⁶ to 2 mol, more preferably from 1×10⁻³ to 0.5 mol, per mol of silver.

Into the heat-developable image recording material according to the present invention, a mercapto compound, a disulfide compound or a thione compound may be incorporated for the purposes of controlling development including inhibiting development and accelerating development, of increasing spectral sensitization efficiency, and of improving preservability before and after development, etc. Examples of the mercapto compound, disulfide compound and thione compound include compounds described in JP-A-10-62899, Paragraph Nos. 0067 to 0069, compounds represented by formula (I) described in JP-A-10-186572 and the specific examples thereof described in Paragraph Nos. 0033 to 0052, compounds described in EP-A-803,764, pages 36 to 56. Among others, mercapto-substituted heteroaromatic compounds are preferred.

It is preferred to incorporate a toning agent into the heat-developable image recording material according to the present invention. Examples of the toning agent include those described in JP-A-10-62899, Paragraph Nos. 0054 to 0055, and EP-A-803,764, page 21, lines 23 to 48. Specifically, a phthalazinone, for example, phthalazinone, a derivative thereof or a salt thereof (e.g., 4-(1-naphthyl)phthalazinone, 6-chlorophthalazinone, 5,7-dimethoxyphthalazinone or 2,3-dihydro-1,4-phthalazinedione); a combination of a phthalazinone with phthalic acid or a derivative thereof (e.g., phthalic acid, 4-methylphthalic acid, 4-nitrophthalic acid or tetrachlorophthalic anhydride); a phthalazine, for example, phthalazine, a derivative thereof or a salt thereof (e.g., 4-(1-naphthyl)phthalazine, 6-isopropylphthalazine, 6-tert-butylphthalazine, 6-chlorophthalazine, 5,7-dimethoxyphthalazine or 2,3-dihydrophthalazine); a combination of a phthalazine with phthalic acid or a derivative thereof (e.g., phthalic acid, 4-methylphthalic acid, 4-nitrophthalic acid or tetrachlorophthalic anhydride) are preferably used. The combination of a phthalazine with phthalic acid or a derivative thereof is particularly preferred.

Into the heat-developable image recording material according to the present invention, a plasticizer or a lubricant may also be incorporated. Examples of the plasticizer and lubricant preferably used include those described in JP-A-11-65021, Paragraph No. 0117.

Into the heat-developable image recording material according to the present invention, a super high contrast imparting agent for the purpose of forming a super high contrast image. Suitable examples of the super high contrast imparting agent include compounds described in JP-A-11-65021, Paragraph No. 0118, and compounds represented by formulae (III) to (V) and specific examples thereof illustrated by Chemical Formulae 21 to 24 described in Japanese Patent Application No. 11-91652. Also, an acrylonitrile and specific examples thereof (CN-1 to CN-13) described in U.S. Pat. No. 5,545,515 may be used.

Compounds selected from substituted alkene derivatives, substituted isoxazole derivatives and acetal compounds represented by formulae (VII), (VIII) and (IX) shown below, respectively, are particularly preferred as the super high contrast imparting agents.

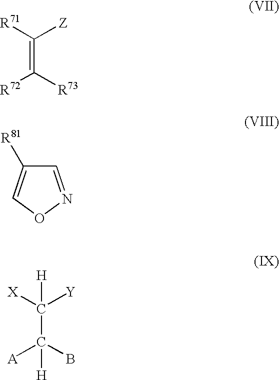

Now, the compound represented by formula (VII) is described in detail below.

In formula (VII), R⁷¹, R⁷² and R⁷³, which may be the same or different, each represents a hydrogen atom or a substituent.

Examples of the substituent represented by R⁷¹, R⁷² or R⁷³ include a halogen atom (e.g., fluorine, chlorine, bromine or iodine), an alkyl group (including a cycloalkyl group and active methine group), an aralkyl group, an alkenyl group, an alkynyl group, an aryl group, a heterocyclic group (including an N-substituted nitrogen-containing heterocyclic group), a heterocyclic group containing a quaternary nitrogen atom (e.g., pyridinio), an acyl group, an alkoxycarbonyl group, an aryloxycarbonyl group, a carbamoyl group, a carboxy group or a salt thereof, an imino group, an N-substituted imino group, a thiocarbonyl group, a sulfonylcarbamoyl group, an acylcarbamoyl group, a sulfamoylcarbamoyl group, a carbazoyl group, an oxalyl group, an oxamoyl group, a cyano group, a thiocarbamoyl group, a hydroxy group or a salt thereof, an alkoxy group (including a group containing an ethyleneoxy repeating unit or a propyleneoxy repeating unit), an aryloxy group, a heterocyclicoxy group, an acyloxy group, an alkoxy- or aryloxy-carbonyloxy group, a carbamoyloxy group, a sulfonyloxy group, an amino group, an alkyl-, aryl- or heterocyclic-amino group, an acylamino group, a sulfonamido group, a ureido group, a thioureido group, an imido group, an alkoxy- or aryloxy-carbonylamino group, a sulfamoylamino group, a semicarbazido group, a thiosemicarbazido group, a hydrazino group, a quaternary ammonio group, an oxamoylamino group, an alkyl- or aryl-sulfonylureido group, an acylureido group, an acylsulfamoylamino group, a nitro group, a mercapto group, an alkyl-, aryl- or heterocyclic-thio group, an acylthio group, an alkyl- or aryl-sulfonyl group, an alkyl- or aryl-sulfinyl group, a sulfo group or a salt thereof, a sulfamoyl group, an acylsulfamoyl group, a sulfonylsulfamoyl group or a salt thereof, a phosphoryl group, a group containing a phosphoric amide or phosphoric eater structure, a silyl group and a stannyl group. Each of these substituents may be further substituted with each of these substituents.

Of the substituents represented by R⁷¹, R⁷² or R⁷³, those each having the total number of carbon atoms of from 0 to 30 are preferred. Specific examples of the preferred substituent include an electron attractive group having the same meaning as one defined for Z in formula (VII) hereinafter, an alkyl group, a hydroxy group or a salt thereof, a mercapto group or a salt thereof, an alkoxy group, an aryloxy group, a heterocyclicoxy group, an alkylthio group, an arylthio group, a heterocyclicthio group, an amino group, an alkylamino group, an arylamino group, a heterocyclic amino group, a ureido group, an acylamino group, a sulfonamido group and a substituted or unsubstituted aryl group.

R⁷¹ preferably represents a hydrogen atom, an electron attractive group, an aryl group, an alkylthio group, an alkoxy group, an acylamino group or a silyl group, and more preferably an electron attractive group or an aryl group.

When R⁷¹ represents an electron attractive group, R⁷¹ preferably represents a group having the total number of carbon atoms of from 0 to 30, specifically, a cyano group, a nitro group, an acyl group, a formyl group, an alkoxycarbonyl group, an aryloxycarbonyl group, a thiocarbonyl group, an imino group, an N-substituted imino group, an alkylsulfonyl group, an arylsulfonyl group, a carbamoyl group, a sulfamoyl group, a trifluoromethyl group, a phosphoryl group, a carboxy group or a salt thereof or a saturated or unsaturated heterocyclic group, more preferably a cyano group, an acyl group, a formyl group, an alkoxycarbonyl group, a carbamoyl group, an imino group, an N-substituted imino group, a sulfamoyl group, a carboxy group or a salt thereof or a saturated or unsaturated heterocyclic group, and particularly preferably a cyano group, a formyl group, an acyl group, an alkoxycarbonyl group, a carbamoyl group or a saturated or unsaturated heterocyclic group.

When R⁷¹ represents an aryl group, R⁷¹ preferably represents a substituted or unsubstituted phenyl group having the total number of carbon atoms of from 6 to 30. Examples of the substituent for the phenyl group include any appropriate substituent, but an electron attractive substituent is preferred.

When R⁷¹ and R⁷³ each represents an electron attractive group in formula (VII), R⁷² and R⁷³ each preferably represents an electron attractive group having the same meaning as one defined for Z in formula (VII) hereinafter, an alkyl group, a hydroxy group or a salt thereof, a mercapto group or a salt thereof, an alkoxy group, an aryloxy group, a heterocyclicoxy group, an alkylthio group, an arylthio group, a heterocyclicthio group, an amino group, an alkylamino group, an anilino group, a heterocyclicamino group, an acylamino group and a substituted or unsubstituted phenyl group.

More preferably, one of R⁷² and R⁷³ represents a hydrogen atom and the other represents a substituent. Examples of the substituent include preferably an alkyl group, a hydroxy group or a salt thereof, a mercapto group or a salt thereof, an alkoxy group, an aryloxy group, a heterocyclicoxy group, an alkylthio group, an arylthio group, a heterocyclicthio group, an amino group, an alkylamino group, an anilino group, a heterocyclicamino group, an acylamino group (particularly a perfluoroalkanamido group), a sulfonamido group, a substituted or unsubstituted phenyl group and a heterocyclic group, more preferably a hydroxy group or a salt thereof, a mercapto group or a salt thereof, an alkoxy group, an aryloxy group, a heterocyclicoxy group, an alkylthio group, an arylthio group and a heterocyclicthio group and a heterocyclic group, and still more preferably a hydroxy group or a salt thereof, an alkoxy group or a heterocyclic group.

In formula (VII), Z represents an electron attractive group or a silyl group, and preferably an electron attractive group.

The electron attractive group represented by Z is a substituent having a Hammett substituent constant up of a positive value. Specific examples of the substituent include a cyano group, an alkoxycarbonyl group, an aryloxycarbonyl group, a carbamoyl group, an imino group, an N-substituted imino group, a thiocarbonyl group, a sulfamoyl group, an alkylsulfonyl group, an arylsulfonyl group, a nitro group, a halogen atom, a perfluoroalkyl group, a perfluoroalkanamido group, a sulfonamido group, an acyl group, a formyl group, a phosphoryl group, a carboxy group or a salt thereof, a sulfo group or a salt thereof, a heterocyclic group, an alkenyl group, an alkynyl group, an acyloxy group, an acylthio group, a sulfonyloxy group and an aryl group substituted with such an electron attractive group. The heterocyclic group is a saturated or unsaturated heterocyclic group and includes, for example, pyridyl, quinolyl, quinoxalinyl, pyrazinyl, benzotriazolyl, imidazolyl, benzimidazolyl, hydantoin-1-yl, succinimido and phthalimido.

The electron attractive group represented by Z may further have a substituent. Examples of the substituent include the substituents represented by R⁷¹, R⁷² or R⁷³ in formula (VII).

When Z represents an electron attractive group, Z preferably represents a group having the total number of carbon atoms of from 0 to 30, specifically, a cyano group, an alkoxycarbonyl group, an aryloxycarbonyl group, a carbamoyl group, a thiocarbonyl group, an imino group, an N-substituted imino group, a sulfamoyl group, an alkylsulfonyl group, an arylsulfonyl group, a nitro group, a perfluoroalkyl group, an acyl group, a formyl group, a phosphoryl group, an acyloxy group, an acylthio group or a phenyl group substituted with an appropriate electron attractive group, more preferably a cyano group, an alkoxycarbonyl group, a carbamoyl group, an imino group, a sulfamoyl group, an alkylsulfonyl group, an arylsulfonyl group, an acyl group, a formyl group, a phosphoryl group, a trifluoromethyl group or a phenyl group substituted with an appropriate electron attractive group, and still more preferably a cyano group, a formyl group, an acyl group, an alkoxycarbonyl group, an imono group or a carbamoyl group.

When Z represents a silyl group, Z preferably represents trimethylsilyl, tert-butyldimethylsilyl, phenyldimethylsilyl, triethylsilyl, triisopropylsilyl or trimethylsilyldimethylsilyl.

In formula (VII), R⁷¹ and Z, R⁷² and R⁷³, R⁷¹ and R⁷², and R⁷³ and Z may be combined with each other to form a ring structure, respectively. It is preferred that R⁷¹ and Z or R⁷² and R⁷³ form a ring structure.

The ring structure formed is a non-aromatic carbon ring or a non-aromatic heterocyclic ring. The ring structure is preferably a 5-membered to 7-membered ring and contains the total number of carbon atoms (including substituent(s)) of from 1 to 40, more preferably from 3 to 30.

Of the compounds represented by formula (VII), those wherein Z represents a cyano group, a formyl group, an acyl group, an alkoxycarbonyl group, an imino group or a carbamoyl group, R⁷¹ represents an electron attractive group or an aryl group, and one of one of R⁷² and R⁷³ represents a hydrogen atom and the other represents a hydroxy group or a salt thereof, a mercapto group or a salt thereof, an alkoxy group, an aryloxy group, a heterocyclicoxy group, an alkylthio group, an arylthio group, a heterocyclicthio group or a heterocyclic group are preferred.

Of the compounds represented by formula (VII), those wherein Z and R⁷¹ form a 5-membered to 7-membered non-aromatic ring structure, and one of one of R⁷² and R⁷³ represents a hydrogen atom and the other represents a hydroxy group or a salt thereof, a mercapto group or a salt thereof, an alkoxy group, an aryloxy group, a heterocyclicoxy group, an alkylthio group, an arylthio group, a heterocyclicthio group or a heterocyclic group are more preferred. In such a case, Z which forms the non-aromatic ring structure together with R⁷¹ is preferably an acyl group, a carbamoyl group, an oxycarbonyl group, a tiocarbonyl group or a sulfonyl group. R⁷¹ which forms the non-aromatic ring structure together with Z is preferably an acyl group, a carbamoyl group, an oxycarbonyl group, a thiocarbonyl group, a sulfonyl group, an imino group, an N-substituted imino group, an acylamino group or a carbonylthio group.

Now, the compound represented by formula (VIII) is described in detail below.

In formula (VIII), R⁸¹ represents the same substituent defined for R⁷¹, R⁷² or R⁷³ in formula (VII). R⁸¹ preferably represents an electron attractive group or an aryl group.

When R⁸¹ represents an electron attractive group, R⁸¹ preferably represents a group having the total number of carbon atoms of from 0 to 30, specifically, a cyano group, a nitro group, an acyl group, a formyl group, an alkoxycarbonyl group, an aryloxycarbonyl group, an alkylsulfonyl group, an arylsulfonyl group, a carbamoyl group, a sulfamoyl group, a trifluoromethyl group, a phosphoryl group, an imino group or a saturated or unsaturated heterocyclic group, more preferably a cyano group, an acyl group, a formyl group, an alkoxycarbonyl group, a carbamoyl group, a sulfamoyl group, an alkylsulfonyl group, an arylsulfonyl group or a saturated or unsaturated heterocyclic group, and still more preferably a cyano group, a formyl group, an acyl group, an alkoxycarbonyl group, a carbamoyl group or a saturated or unsaturated heterocyclic group.

When R⁸¹ represents an aryl group, R⁸¹ preferably represents a substituted or unsubstituted phenyl group having the total number of carbon atoms of from 6 to 30. Examples of the substituent for the phenyl group include the substituent defined for R⁷¹, R⁷² or R⁷³ in formula (VII).

R⁸¹ represents particularly preferably a cyano group, an alkoxycarbonyl group, a carbamoyl group, a saturated or unsaturated heterocyclic group or a substituted or unsubstituted phenyl group, and most preferably a cyano group, a saturated or unsaturated heterocyclic group or an alkoxycarbonyl group.

Now, the compound represented by formula (IX) is described in detail below.

In formula (IX), X and Y, which may be the same or different, each represents a hydrogen atom or a substituent, or X and Y may be combined with each other to form a ring structure.

The substituent represented by X or Y includes the substituent defined for R⁷¹, R⁷² or R⁷³ in formula (VII). Specific examples of the substituent include an alkyl group (including, e.g., perfluoroalkyl or trichloromethyl), an aryl group, a heterocyclic group, a halogen atom, a cyano group, a nitro group, an alkenyl group, an alkynyl group, an acyl group, a formyl group, an alkoxycarbonyl group, an aryloxycarbonyl group, an imino group, an N-substituted imino group, a carbamoyl group, a thiocarbonyl group, an acyloxy group, an acylthio group, an acylamino group, an alkylsulfonyl group, an arylsulfonyl group, a sulfamoyl group, a phosphoryl group, a carboxy group or a salt thereof, a sulfo group or a salt thereof, a hydroxy group or a salt thereof, a mercapto group or a salt thereof, an alkoxy group, an aryloxy group, a heterocyclicoxy group, an alkylthio group, an arylthio group, a heterocyclicthio group, an amino group, an alkylamino group, an anilino group, a heterocyclicamino group and a silyl group. The substituent may further have a substituent. Alternatively, X and Y may be combined with each other to form a ring structure. The ring structure formed is a non-aromatic carbon ring or a non-aromatic heterocyclic ring.

The substituent represented by X or Y has preferably the total number of carbon atoms of from 1 to 40, and more preferably from 1 to 30. Specific preferred examples of the substituent include a cyano group, an alkoxycarbonyl group, an aryloxycarbonyl group, a carbamoyl group, an imino group, an N-substituted imino group, a thiocarbonyl group, a sulfamoyl group, an alkylsulfonyl group, an arylsulfonyl group, a nitro group, a perfluoroalkyl group, an acyl group, a formyl group, a phosphoryl group, an acylamino group, an acyloxy group, an acylthio group, a heterocyclic group, an alkylthio group, an alkoxy group and an aryl group.

X and Y each represents more preferably a cyano group, a nitro group, an alkoxycarbonyl group, a carbamoyl group, an acyl group, a formyl group, an acylthio group, an acylamino group, a thiocarbonyl group, a sulfamoyl group, an alkylsulfonyl group, an arylsulfonyl group, an imino group, an N-substituted imino group, a phosphoryl group, a trifluoromethyl group, a heterocyclic group or a substituted phenyl group, and particularly preferably a cyano group, an alkoxycarbonyl group, a carbamoyl group, an alkylsulfonyl group, an arylsulfonyl group, an acyl group, an acylthio group, an acylamino group, a thiocarbonyl group, a formyl group, an imino group, an N-substituted imino group, a heterocyclic group or a phenyl group substituted with an electron attractive group.

It is also preferred that X and Y are combined with each other to form a non-aromatic carbon ring or a non-aromatic heterocyclic ring. The ring structure formed is preferably a 5-membered to 7-membered ring and contains the total number of carbon atoms (including substituent(s)) of from 1 to 40, and more preferably from 3 to 30. Preferred examples of X and Y which form the ring structure include an acyl group, a carbamoyl group, an oxycarbonyl group, a thiocarbonyl group, a sulfonyl group, an imino group, an N-substituted imino group, an acylamino group and a carbonylthio group.

In formula (IX), A and B, which may be the same or different, each represents an alkoxy group, an alkylthio group, an alkylamino group, an aryloxy group, an arylthio group, an anilino group, a heterocyclicoxy group, a heterocyclicthio group or a heterocyclicamino group, or A and B may be combined with each other to form a ring structure.

The substituent represented by A or B has preferably the total number of carbon atoms of from 1 to 40, and more preferably from 1 to 30. The substituent may further have a substituent.

More preferably, A and B are combined with each other to form a ring structure. The ring structure formed is preferably a 5-membered to 7-membered non-aromatic heterocyclic ring and contains the total number of carbon atoms of from 1 to 40, and more preferably from 3 to 30. Examples of the combination of A and B (—A—B—) include —O—(CH₂)₂—O—, —O— (CH₂)₃—O—, —S— (CH₂)₂—S—, —S— (CH₂)₃—S—, —S—Ph—S—, —N(CH₃)—(CH₂)₂—O—, —N(CH₃)—(CH₂)₂—S—, —O— (CH₂)₂—S—, —O—(CH₂)₃—S—, —N(CH₃)—Ph—O—, —N(CH₃)—Ph—S— and —N(Ph)—(CH₂)₂—S—.

The compound represented by formula (VII), (VIII) or (IX) may contain an adsorptive group that adsorbs to light-sensitive silver halide. Examples of the adsorptive group include an alkylthio group, an arylthio group, a thiourea group, a thioamido group, a mercapto heterocyclic group and a triazole group as described in U.S. Pat. Nos. 4,385,108 and 4,459,347, JP-A-59-195233, JP-A-59-200231, JP-A-59-201045, JP-A-59-201046, JP-A-59-201047, JP-A-59-201048, JP-A-59-201049, JP-A-61-170733, JP-A-61-270744, JP-A-62-948, JP-A-63-234244, JP-A-63-234245 and JP-A-63-234246. The absorptive group to light-sensitive silver halide may be a form of precursor. Examples of the precursor include groups described in JP-A-2-285344.

The compound represented by formula (VII), (VIII) or (IX) may contain a ballast group that is conventionally used in an immobile photographic additive such as a coupler, or a polymer chain. Particularly, the compound containing the ballast group is preferred in the present invention. The ballast group is a group that is relatively inert to photographic characteristics and has at least 8 carbon atoms. The ballast group is selected, for example, from an alkyl group, an aralkyl group, an alkoxy group, a phenyl group, an alkylphenyl group, a phenoxy group and an alkylphenoxy group. Examples of the polymer chain include those described in JP-A-1-100530.

The compound represented by formula (VII), (VIII) or (IX) may contain a cationic group (for example, a group containing a quaternary ammonio group or a nitrogen-containing heterocyclic group having a quaternary nitrogen atom), a group having an ethyleneoxy or propyleneoxy repeating unit, an alkyl-, aryl- or heterocyclic-thio group, or a dissociation group capable of being dissociated with a base (for example, carboxy, sulfo, acylsulfamoyl or carbamoylsulfamoyl) Particularly, the compound containing a group having an ethyleneoxy or propyleneoxy repeating unit or an alkyl-, aryl- or heterocyclic-thio group is preferred in the present invention. Specific examples of these groups include those described in JP-A-7-234471, JP-A-5-333466, JP-A-6-19032, JP-A-6-19031, JP-A-5-45761, U.S. Pat. Nos. 4,994,365 and 4,988,604, JP-A-3-259240, JP-A-7-5610, JP-A-7-244348 and U.S. Pat. No. 4,006,032.

The compounds represented by formulae (VII), (VIII) and (IX) can be easily prepared according to known methods. For example, they are prepared with reference to methods described in U.S. Pat. Nos. 5,545,515, 5,635,339 and 5,654,130, WO 97/34196 and Japanese Patent Application Nos. 9-354107, 9-309813 and 9-272002.

Specific examples of the compound represented by formula (VII), (VIII) or (IX) (Compounds 1 to 72) for use as the super high contrast imparting agent are set forth below, but the present invention should not be construed as being limited thereto.

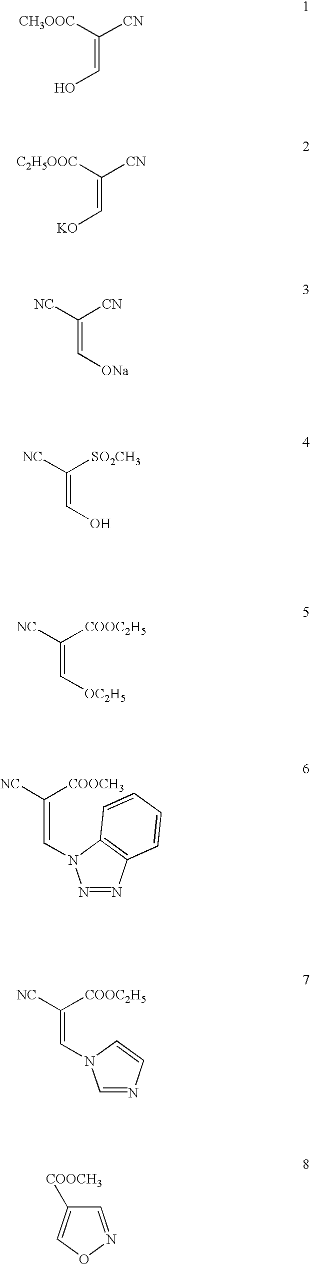

An amount of the compound represented by formula (VII), (VIII) or (IX) used is preferably from 1×10⁻⁶ to 1 mol, more preferably from 1×10⁻⁵ to 5×10⁻¹ mol, and still more preferably from 2×10⁻⁵ to 2×10⁻¹ mol, per mol of silver.

In order to incorporate the compound represented by formula (VII), (VIII) or (IX) into the heat-developable image recording material, it is dissolved in water or an appropriate organic solvent, for example, an alcohol (e.g., methanol, ethanol, propanol or a fluorinated alcohol), a ketone (e.g., acetone or methyl ethyl ketone), dimethylformamide, dimethylsulfoxide or methyl cellosolve to prepare a solution. Also, a well-known emulsified dispersion method can be employed. Specifically, the compound represented by formula (VII), (VIII) or (IX) is dissolved using oil, e.g., dibutyl phthalate, tricresyl phosphate, glycerol triacetate or diethyl phthalate, and an auxiliary solvent, e.g., ethyl acetate or cyclohexanone, and the resulting solution is mechanically stirred to prepare an emulsified dispersion. Further, according to a solid dispersion method, powder of the compound represented by formula (VII), (VIII) or (IX) is dispersed in an appropriate solvent, e.g., water using a ball mill, a colloid mill or ultrasonic wave to prepare a solid dispersion.

The compound represented by formula (VII), (VIII) or (IX) may be incorporated into any layer positioned on the side having the image forming layer of the support, specifically, the image forming layer or any other layer positioned on this side. However, it is preferably incorporated into the image forming layer or a layer adjacent thereto.

The compound represented by formula (VII), (VIII) or (IX) may be used individually or in combination of two or more thereof. The compound may be used together with one or more compounds described in U.S. Pat. Nos. 5,545,515, 5,635,339 and 5,654,130, WO 97/34196, U.S. Pat. No. 5,686,228, JP-A-11-119372, Japanese Patent Application Nos. 9-228881, 9-273935, 9-354107, 9-309813, 9-296174 and 9-282564, JP-A-11-95365, JP-A-11-95366 and Japanese Patent Application No. 9-332388.

The compound represented by formula (VII), (VIII) or (IX) can be used together with a hydrazine derivative described, for example, in JP-A-10-339932 and JP-A-10-161270. Also, the following hydrazine derivatives can be used together therewith. Specifically, they include compounds represented by Chemical Formula 1 described in JP-B-6-77138 (the term “JP-B” as used herein means an “examined Japanese patent publication”) and specifically compounds described on pages 3 to 4; compounds represented by formula (I) described in JP-B-6-93082 and specifically Compounds 1 to 38 described on pages 8 to 18; compounds represented by formulae (4) to (6) described in JP-A-6-230497 and specifically Compounds 4-1 to 4-10 described on pages 25 to 26, Compounds 5-1 to 5-42 described on pages 28 to 36, and Compounds 6-1 to 6-7 described on pages 39 to 40; compounds represented by formulae (1) to (2) described in JP-A-6-289520 and specifically Compounds 1-1) to 1-17) and Compound 2-1) described on pages 5 to 7; compounds represented by Chemical Formulae 2 and 3 described in JP-A-6-313936 and specifically compounds described on pages 6 to 19; compounds represented by Chemical Formula 1 described in JP-A-6-313951 and specifically compounds described on pages 3 to 5; compounds represented by formula (I) described in JP-A-7-6510 and specifically Compounds I-1 to I-38 described on pages 5 to 10; compounds represented by formula (II) described in JP-A-7-77783 and specifically Compounds II-1 to II-102 described on pages 10 to 27; compounds represented by formulae (H) and (Ha) described in JP-A-7-104426 and specifically Compounds H-1 to H-44 described on pages 8 to 15; compounds having an anionic group nearby a hydrazine group or a nonionic group capable of forming an intramolecular hydrogen bond with a hydrogen atom of hydrazine group nearby the hydrazine group described in EP-A-713,131, particularly those represented by formulae (A) to (F) and specifically Compounds N-1 to N-30; compounds represented by formula (1) described in EP-A-713,131 and specifically Compounds D-1 to D-55; various hydrazine derivatives described in Kochi Gijutsu (Pages 1 to 207), pages 25 to 34, Aztech Corp. (Mar. 22, 1991); and Compounds D-2 and D-39 described in JP-A-62-86354, on pages 6 to 7.

An amount of the hydrazine derivative used is preferably from 1×10⁻⁶ to 1 mol, more preferably from 1×10⁻⁵ to 5×10⁻¹ mol, and still more preferably from 2×10⁻⁵ to 2×10⁻¹ mol, per mol of silver.

The hydrazine derivative can be used by dispersing in the same manner as described for the compound represented by formula (VII), (VIII) or (IX).

The hydrazine derivative may be incorporated into any layer positioned on the side having the image forming layer of the support, specifically, the image forming layer or any other layer positioned on this side. However, it is preferably incorporated into the image forming layer or a layer adjacent thereto.

In the heat-developable image recording material according to the present invention, the super high contrast imparting agent described above can be used together with a high contrast accelerating agent in order to form a super high contrast image. Examples of the high contrast accelerating agent used include compounds described in JP-A-11-65021, Paragraph No. 0102, amine compounds described in U.S. Pat. No. 5,545,505 and specifically AM-1 to AM-5, hydroxamic acids described in U.S. Pat. No. 5,545,507 and specifically KA-1 to HA-11, hydrazine compounds described in U.S. Pat. No. 5,558,983 and specifically CA-1 to CA-6, and onium salts described in JP-A-9-297368 and specifically A-1 to A-42, B-1 to B-27 and C-1 to C-14.

With respect to preparation methods, addition methods and addition amounts of the super high contrast imparting agent and high contrast accelerating agent, those described in the patents cited above can be utilized.

In case of using formic acid or a salt thereof as a strong fogging substance in the heat-developable image recording material according to the present invention, the strong fogging substance is preferably incorporated into a layer positioned on the side having the image forming layer containing light-sensitive silver halide in an amount of not more than 5 mmol, and more preferably not more than 1 mmol.

When a nucleating agent is used in the heat-developable image recording material according to the present invention, it is preferred to use an acid formed by hydration of phosphorus pentoxide or its salt in combination. Examples of the acid formed by hydration of phosphorus pentoxide or the salt thereof include metaphosphoric acid (salt), pyrophosphoric acid (salt), orthophosphoric acid (salt), triphosphoric acid (salt), tetraphosphoric acid (salt) and hexamethaphosphoric acid (salt). The acid formed by hydration of phosphorus pentoxide or the salt thereof particularly preferably used includes orthophosphoric acid (salt) and hexamethaphosphoric acid (salt). Specific examples of the salt include sodium orthophosphate, sodium dihydrogen orthophosphate, sodium hexamethaphosphate and ammonium hexamethaphosphate.

An amount of the acid formed by hydration of phosphorous pentaoxide or the salt thereof used may be appropriately determined taking photographic characteristics, for example, sensitivity or fog into consideration, and is preferably from 0.1 to 500 mg, more preferably from 0.5 to 100 mg, per m² of the image recording material.

The heat-developable image recording material according to the present invention may have a surface protective layer for the purpose of preventing adhesion of the image forming layer. With respect to the surface protective layer, descriptions in JP-A-11-65021, Paragraph Nos. 0119 to 0120 are referred to.

Although gelatin is preferred as a binder for the surface protective layer, polyvinyl alcohol (PVA) is also preferably used. Specific example of PVA include PVA-105 (polyvinyl alcohol (PVA) content: 94.0% by weight or more, saponification degree: 98.5±0.5% by mole, sodium acetate content: 1.5% by weight or less, volatile content: 5.0% by weight or less, viscosity (4% by weight, 20° C.): 5.6+0.4 CPS) as a completely saponified product, PVA-205 (polyvinyl alcohol (PVA) content: 94.0% by weight, saponification degree: 88.0±1.5% by mole, sodium acetate content: 1.0% by weight, volatile content: 5.0% by weight, viscosity (4% by weight, 20° C.): 5.0±0.4CPS) as a partially saponified product, and MP-102, MP-202, MP-203, R-1130 and R-2105 as a modified polyvinyl alcohol (all of these products are manufactured by Kuraray Co., Ltd.). A coating amount of polyvinyl alcohol for the surface protective layer (per one layer) is preferably from 0.3 to 4.0 g, more preferably from 0.3 to 2.0 g, per m² of the support.

In case of using the heat-developable image recording material according to the present invention in the field of printing where a dimensional change particularly causes trouble, it is preferred to incorporate a polymer latex into the surface protective layer and a back layer. Examples of the polymer latex include the specific polymer latexes described above, and those described in Taira Okuda and Hiroshi Inagaki ed., Gosei Jushi Emulsion, Kobunshi-kankokai (1978), Takaaki Sugimura, Yasuo Kataoka, Souichi Suzuki and Keiji Kasahara ed., Gosei Latex no Oyo, Kobunshi-kankokai (1993), and Soichi Muroi, Gosei Latex no Kagaku, Kobunshi-kankokai (1979). Specific examples of the polymer latex include a latex of methyl methacrylate/ethyl acrylate/methacrylic acid (33.5/50/16.5 by weight ratio) copolymer, a latex of methyl methacrylate/butadiene/itaconic acid (47.5/47.5/5 by weight ratio) copolymer, a latex of ethyl acrylate/methacrylic acid copolymer, and a latex of methyl methacrylate/2-ethylhexyl acrylate/ethylene/2-hydroxyethyl methacrylate/acrylic acid (58.9/25.4/8.6/5.1/2.0) copolymer. Further, to the binder for surface protective layer, combination of polymer latexes described in Japanese Patent Application No. 11-6872, techniques described in Japanese Patent Application No. 11-143058, Paragraph Nos. 0021 to 0025, techniques described in Japanese Patent Application No. 11-6872, Paragraph Nos. 0027 to 0028, and techniques described in Japanese Patent Application No. 10-199626, Paragraph Nos. 0023 to 0041 may be applied.

A temperature for the preparation of a coating solution for the image forming layer in the heat-developable image recording material according to the present invention is preferably in a range of from 30 to 65° C., more preferably from 35 to 60° C., and still more preferably from 35 to 55° C. It is also preferred that the temperature of coating solution for the image forming layer just after the addition of polymer latex is maintained in a range of from 30 to 65° C. Before the addition of polymer latex, the heat developing agent and the organic silver salt have been preferably mixed.

It is preferred that a liquid containing the organic silver salt or a coating solution for the image forming layer in the heat-developable image recording material according to the present invention is a so-called thixotropic fluid. The thixotropic property means a property in which viscosity decreases as an increase of shearing velocity. For the measurement of viscosity, although any device may be employed, it is preferred to conduct the measurement using FRS Fluid Spectrometer manufactured by Rheometrix Far East Ltd. at temperature of 25° C. The viscosity at the shearing velocity of 0.1 S⁻¹ in the liquid containing the organic silver salt or coating solution for the image forming layer is preferably in a range of from 400 to 100,000 mPa·s, and more preferably from 500 to 20,000 mPa·s. Also, the viscosity at the shearing velocity of 1,000 S⁻¹ is preferably in a range of from 1 to 200 mPa·s, and more preferably from 5 to 80 mPa·s.

Various systems exhibiting the thixotropic property are known, and described, for example, in Koza Rheology, Kobunshi-kankokai and Soichi Muroi and Ikuo Morino, Kobunshi Latex, Kobunshi-kankokai. In order to exhibit the thixotropic property, the fluid must contain a large number of fine solid particles. For the purpose of strengthening the thixotropic property, it is effective, for example, to incorporate a viscosity-increasing linear polymer, to use fine solid particles of anisotropy having a high aspect ratio or to employ an alkali thickener or a surface active agent.

In the heat-developable image recording material according to the present invention, the image forming layer (light-sensitive layer) comprises one or more layers on the support. In case of one image forming layer, the layer contains the organic silver salt, the silver halide, the developing agent and the binder, and if desired, an additional material, for example, a toning agent, a coating aid or other auxiliary agents. In case of two image forming layers, the first image forming layer (ordinarily a layer adjacent to the support) contains the organic silver salt and the silver halide, and the second image forming layer or both layers contain other components. Two layer-construction composed of a single image forming layer containing all the components and a protective top layer may be used. In a multi-color light-sensitive heat-developable photographic material, the combination of two layers described above may be used for each color. Also, all the components may be contained in a single layer as described in U.S. Pat. No. 4,708,928. In case of a multi-dye multi-color light-sensitive heat-developable photographic material, each image forming layer is separated from another by providing a functional or non-functional barrier layer between one image forming layer and another image forming layer as described in U.S. Pat. No. 4,460,681.

The specific polymer latex described above may be used in any layer described above and is preferably added to a layer containing the organic silver salt and the silver halide (image forming layer).

Into the heat-developable image recording material according to the present invention, various kinds of dyes and pigments may be incorporated for the purpose of improving tone of the light-sensitive layer, of preventing the occurrence of interference fringe at exposure with a laser beam and of preventing irradiation. Such techniques are described in detail in WO 98/36322. Preferred examples of the dye and pigment for use in the light-sensitive layer include an anthraquinone dye, an azomethine dye, an indoaniline dye, an azo dye, an indanthrone pigment of anthraquinone series (e.g., C. I. Pigment Blue 60), a phthalocyanine pigment (for example, copper phthalocyanine, e.g., C. I. Pigment Blue 15, or non-metal phthalocyanine, e.g., C. I. Pigment Blue 16), a triarylcarbonyl pigment of lake pigment series, indigo, and an inorganic pigment (e.g., ultramarine or cobalt blue). The dye and pigment may be incorporated into the heat-developable image recording material in any manner, for example, as a solution, an emulsion, a solid fine particle dispersion or a state mordanted to a polymer mordant. An amount of the dye and pigment used may be determined depending on the desired absorption, and in general, the dye and pigment is preferably used in a range of from 1 μg to 1 g per m² of the image recording material.

In the heat-developable image recording material according to the present invention, an anti-halation layer may be provided on the farther side from a light source in relation to the light-sensitive layer. With respect to the anti-halation layer, descriptions in JP-A-ll-65021, Paragraph Nos. 0123 to 0124 and JP-A-11-223898 are referred to.

The heat-developable image recording material according to the present invention ordinarily comprises a light-insensitive layer in addition to the light-sensitive layer. The light-insensitive layer can be classified according to the position thereof as follows: (1) a protective layer provided on the light-sensitive layer (on the farther side from the support); (2) an intermediate layer provided between plural light-sensitive layers or between the light-sensitive layer and the protective layer; (3) an undercoat layer provided between the light-sensitive layer and the support; and (4) a back layer provided on the opposite side of the light-sensitive layer. A filter layer is provided in the heat-developable image recording material as a layer classified in (1) or (2). The anti-halation layer is provided in the heat-developable image recording material as a layer classified in (3) or (4).

It is preferred that a light-insensitive layer to which a decolorizable dye and a base precursor are added is used as the filter layer or the anti-halation layer. The decolorizable dye and base precursor are preferably added to the same light-insensitive layer. However, they may be individually added to two adjacent light-insensitive layers. Also, a barrier layer may be provided between two adjacent light-insensitive layers.

In order to add the decolorizable dye to the light-insensitive layer, a method of adding a solution, emulsion or solid fine particle dispersion of the decolorizable dye, or a polymer impregnated with the decolorizable dye to a coating solution for the light-insensitive layer can be adopted. Also, the decolorizable dye may be added to the light-insensitive layer using a polymer mordant. These methods of addition are same as those of adding a dye to a ordinary heat-developable image recording material. A latex used for the polymer impregnated with the decolorizable dye is described in U.S. Pat. No. 4,199,363, West German Patents (OLS) 2,514,274 and 2, 541,230, EP-A-029,104 and JP-B-53-41091. An emulsifying method in which a dye is added to a solution containing a polymer dissolved is described in WO 88/00723.

An amount of the decolorizable dye added is determined according to the use of dye. Ordinarily, the decolorizable dye is used in such an amount that an optical density (absorbance) measured at the desired wavelength exceeds 0.1. The optical density is preferably in a range of from 0.2 to 2. An amount of the decolorizable dye sufficient for obtaining such a level of the optical density is ordinarily in a range of approximately from 0.001 to 1 g/m², and preferably from 0.01 to 0.2 g/m².

When the decolorizable dye is decolorized, the optical density can be reduced to 0.1 or less. Two or more of the decolorizable dyes may be used in combination in a heat-decolorizable type recording material or in the heat-developable image recording material. Similarly, two or more of the base precursors may be used in combination.

The heat-developable image recording material according to the present invention is preferably a so-called one-sided image recording material having at least one light-sensitive layer containing the light-sensitive silver halide emulsion and other components described above on one side of the support and a back layer on the other side of the support.

It is preferred to add a matting agent to the heat-developable image recording material according to the present invention for the purpose of improving transportability. The matting agents are described in JP-A-11-65021, Paragraph Nos. 0126 to 0127. A coating amount of the matting agent is preferably from 1 to 400 mg, and more preferably from 5 to 300 mg, per m² of the heat-developable image recording material.

A matting degree of the light-sensitive layer side may be any degree as far as no star dust-like defect occurs. A Bekk smoothness of the light-sensitive layer side is preferably in a range of from 30 to 2,000 seconds, and more preferably from 40 to 1,500 seconds.

On the other hand, regarding a matting degree of the back layer side, the Bekk smoothness is preferably in a range of from 10 to 1,200 seconds, more preferably from 20 to 800 seconds, and still more preferably from 40 to 500 seconds.

The matting agent is preferably added to the outermost surface layer, a layer that functions as the outermost surface layer or a layer close to the outer surface, or also preferably added to a layer that functions as a so-called protective layer.

With respect to the back layer, descriptions in JP-A-11-65021, Paragraph Nos. 0128 to 0130 are referred to.

A hardening agent may be used in each layer, for example, a light-sensitive layer, a protective layer or a back layer in the heat-developable image recording material according to the present invention. Examples of the hardening agent are described in T. H. James, The Theory of the Photographic Process, Fourth Edition, pages 77 to 87, Macmillan Publishing Co., Inc. (1977). Multi-valent metal ions described in ibid., page 78, polyisocyanates described in U.S. Pat. No. 4,281,060 and JP-A-6-208193, epoxy compounds described in U.S. Pat. No. 4,791,042 and vinyl sulfone compounds described in JP-A-62-89048 are preferably used.

The hardening agent is added in the form of a solution. A period of the addition of the solution of hardening agent to a coating solution for the protective layer is ordinarily from 180 minutes before coating to just before coating, and preferably from 60 minutes before coating to 10 seconds before coating. A mixing method and mixing conditions are not particularly limited as far as the effect of the present invention can be achieved. Specifically, there are a method of mixing in a tank in which mean residence time calculated from an addition flow rate and a supply flow rate to a coater is controlled so as to be the desired time, and a method using a static mixer as described in N. Harnby, M. F. Edwards and A. W. Nienow, Ekitai Kongou Gijyutu, Chapter 8, translated by Kouji Takahashi, The Nikkan Kogyo Shimbun, Ltd. (1989).

A surface active agent for use in the heat-developable image recording material is described in JP-A-11-65021, Paragraph No. 0132, a solvent is described in ibid., Paragraph No. 0133, a support is described in ibid., Paragraph No. 0134, an anti-static or conductive layer is described in ibid., Paragraph No. 0135, and a method for forming a color image is described in ibid., Paragraph No. 0136.

In the heat-developable image recording material according to the present invention, a pH of film surface before heat development processing is not more than 6.0, and more preferably not more than 5.5. The lower limit is not particularly restricted but approximately 3. For adjusting the pH of film surface, it is preferred to use an organic acid, e.g., a phthalic acid derivative, a non-volatile acid, e.g., sulfuric acid, or a volatile base, e.g., ammonia in view of decreasing the pH of film surface. Particularly, ammonia is preferred for achieving a low pH of film surface since it is apt to volatilize and can be removed during a coating process or before the heat development. Measurement of the pH of film surface is described in Japanese Patent Application No. 11-87297, Paragraph No. 0123.

To the heat-developable image recording material according to the present invention, an antioxidant, a stabilizing agent, a plasticizer, an ultraviolet absorbing agent or a coating aid may further be added. Each of such additives is added to the light-sensitive layer or the light-insensitive layer. With respect to such additives, descriptions in Wo 98/36322, EP-A-803,764, JP-A-10-186567 and JP-A-10-186568 are referred to.

Each layer of the heat-developable image recording material according to the present invention may be coated by any method. Specifically, various coating methods including extrusion coating, slid coating, curtain coating, dip coating, knife coating, flow coating and extrusion coating using a hopper described in U.S. Pat. No. 2,681,294 can be used. Extrusion coating or slide coating described in Stephan F. Kistler and Peter M. Schweizer, Liquid Film Coating, pages 399 to 536, Chapman & Hall (1997) is preferably employed. Particularly, the slide coating is preferably used. Examples of the form of a slide coater used in the slid coating are described in ibid., page 427, FIG. 11b.1. According to methods described in ibid., pages 399 to 536, U.S. Pat. No. 2,761,791 and British Patent 837,095, two or more layers can be simultaneously coated, if desired.

Techniques described in EP-A-803,764, EP-A-883,022, WO 98/36322, JP-A-56-62648, JP-A-58-62644, JP-A-9-281637, JP-A-9-297367, JP-A-9-304869, JP-A-9-311405, JP-A-9-329865, JP-A-10-10669, JP-A-10-62899, JP-A-10-69023, JP-A-10-186568, JP-A-10-90823, JP-A-10-171063, JP-A-10-186565, JP-A-10-186567, JP-A-10-186569, JP-A-10-186570, JP-A-10-186571, JP-A-10-186572, JP-A-10-197974, JP-A-10-197982, JP-A-10-197983, JP-A-10-197985, JP-A-10-197986, JP-A-10-197987, JP-A-10-207001, JP-A-10-207004, JP-A-10-221807, JP-A-10-282601, JP-A-10-288823, JP-A-10-288824, JP-A-10-307365, JP-A-10-312038, JP-A-10-339934, JP-A-11-7100, JP-A-11-15105, JP-A-11-24200, JP-A-11-24201, JP-A-11-30832, JP-A-11-84574, JP-A-11-65021, JP-A-11-125880, JP-A-11-129629, JP-A-11-133536, JP-A-11-133537, JP-A-11-133538, JP-A-11-133539, JP-A-11-133542 and JP-A-11-133543 are also used in the heat-developable image recording material according to the present invention.

The heat-developable image recording material according to the present invention may be developed by any method. The heat-developable image recording material exposed imagewise is usually developed by heating. A developing temperature is preferably in a range of from 80 to 250° C., and more preferably from 100 to 140° C. A developing time is preferably from 1 to 180 seconds, more preferably from 10 to 90 seconds, and particularly preferably from 10 to 40 seconds.

A plate heater system is preferably used for the heat development. Of the plate heater systems for heat development, a method described in JP-A-11-133572 is preferably used. In the method, a heat development apparatus for obtaining a visible image by bringing a heat-developable image recording material having a latent image formed into contact with a heating means in a heat development part, wherein the heating means comprises a plate heater and plural press rollers are arranged along one side of the plate heater, is used, and the heat-developable image recording material having a latent image is passed between the press rollers and the plate heater to perform heat development. It is preferred that the plate heater is divided into 2 to 6 stages, and that the top stage has a temperature decreased by approximately from 1 to 10° C. Such a method is also described in JP-A-54-30032. According to the method, moisture and organic solvents contained in the heat-developable image recording material can be removed out of the system, and deformation of support of the heat-developable image recording material due to rapid heating can be restrained.

The heat-developable image recording material according to the present invention may be exposed to light by any method. A laser beam is preferably used as a light source for the exposure. Of the laser beams, a gas laser (e.g., Ar⁺ or He—Ne), a YAG laser, a dye laser and a semiconductor laser are preferred in the present invention. A semiconductor laser and a second harmonic generating element can also be used. A gas laser or semiconductor laser radiating red to infrared light is preferred.

A single-mode laser is utilized, and techniques described in JP-A-11-65021, Paragraph No. 0140 are used.

An output of the laser is preferably not less than 1 mW, more preferably not less than 10 mW, and still more preferably not less than 40 mW. A plurality of laser beams may be put together. A diameter of the laser beam is approximately from 30 to 200 μm in terms of 1/e² spot size of Gaussian beam.

As a laser imager having an exposure part and a heat development part, Fuji Medical Dry Laser Imager FM-DP L is exemplified. Descriptions on the Fuji Medical Dry Laser Imager FM-DP L are found in Fuji Medical Review, No. 8, pages 39 to 55. Of course, the techniques described therein are applied to the laser imager used for the heat-developable image recording material according to the present invention.

The heat-developable image recording material according to the present invention forms a black and white image based on a silver image. It is, therefore, preferably employed as a heat-developable image recording material for medical diagnosis, a heat-developable image recording material for industrial photography, a heat-developable image recording material for printing and a heat-developable image recording material for COM. Based on the back and white image formed, a duplicated image is formed on a duplication film (MI-Dup manufactured by Fuji Photo Film Co., Ltd.) in the field of medical diagnosis. Also, in the field of printing, the back and white image formed is used as a mask for forming image on a contact film (DO-175 or PDO-100 manufactured by Fuji Photo Film Co., Ltd.) or an offset printing plate. Further, the heat-developable image recording material according to the present invention is used as a heat-developable image recording material for a laser imager in “AD network” proposed by Fuji Medical System as a network system adapted to the DICOM Standard.

The present invention will be described in greater detail with reference to the following examples. The materials, reagents, ratios, procedures and the like described in the examples can be appropriately changed without departing from the spirit of the present invention. Therefore, the present invention should not be construed as being limited thereto.

### EXAMPLE 1

The structures of compounds used in Example 1 are shown below.

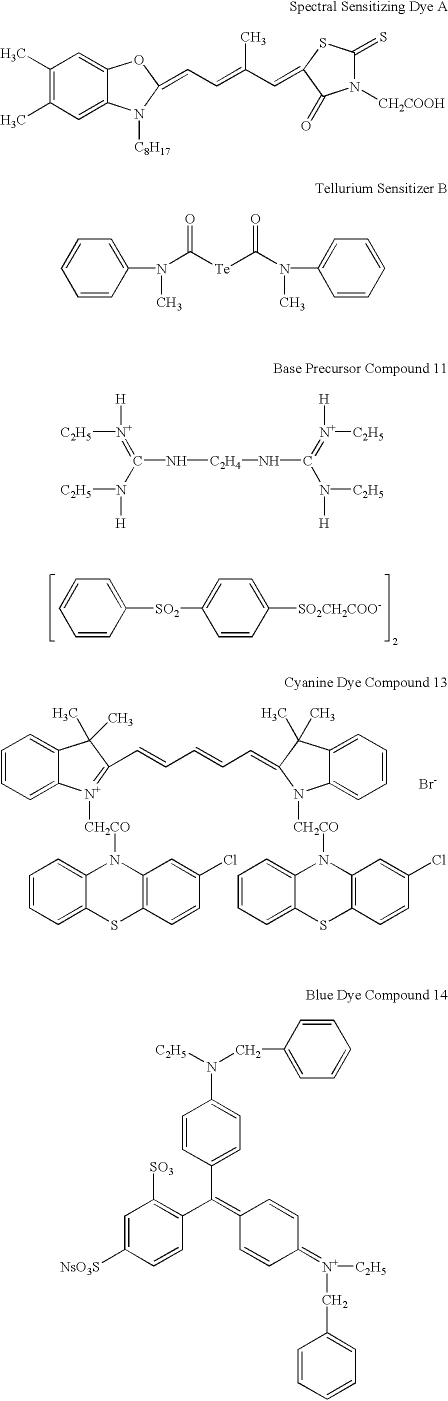

<Preparation of PET Support>

Polyethylene terephthalate (PET) having an intrinsic viscosity IV=0.66 (measured in phenol/tetrachloroethane=6/4 (ratio by weight) at 25° C.) was obtained using terephthalic acid and ethylene glycol in a conventional manner. The PET was palletized, and the pellets were dried at 130° C. for 4 hours. Then, the pellets were melted at 300° C., extruded from a T-die, and rapidly quenched to prepare an unstretched film having a thickness so as to form a film having a thickness of 175 μm after heat setting.

The film was stretched 3.3 times in the longitudinal direction with rollers having different peripheral speeds, and then stretched 4.5 times in the lateral direction by means of a tenter. The temperatures of the operations were 110° C. and 130° C., respectively. Subsequently, the film was subjected to heat setting at 240° C. for 20 seconds, and then relaxation by 4% in the lateral direction at the same temperature. The film was slit to remove its chucked parts by the tenter, and both sides of the film were subjected to knurl processing. The film was rolled up at 4 kg/cm² to obtain a roll of the film having a thickness of 175 μm.

<Surface Treatment with Corona Discharge>

Both surfaces of the film support were treated by a solid-state corona discharge processor (6KVA Model manufactured by Pillar Technologies, Inc.) at 20 m/min at room temperature. From the values of electric current and voltage applied at that time, it was found that the film support was subjected to treatment of 0.375 kVA-min/m². The treatment frequency was 9.6 kHz, and a gap clearance between an electrode and a dielectric roll was 1.6 mm.

<Preparation of Undercoated Support>

1. Preparation of Coating Solution for Undercoat Layer Composition-1 (for Undercoat Layer on the Light-Sensitive Layer Side)

| | | |
|---|---|---|
| Besresin A-515GB (manufactured by | 234 | g |
| Takamatsu Oil and Fat Co., Ltd.) | | |
| (30% by weight solution) | | |
| Polyethylene glycol monononylphenyl ether | 21.5 | g |
| (average number of ethylene oxide: 8.5) | | |
| (10% by weight solution) | | |
| Fine polymer particles (average particle | 0.91 | g |
| size: 0.4 μm, MP-1000 manufactured by | | |
| Soken Chemical and Engineering Co., Ltd.) | | |
| Distilled water | 744 | ml |
| Composition-2 (for first undercoat layer on the back layer | | |
| side) | | |
| Butadiene/styrene copolymer latex | 158 | g |
| (solid content: 40% by weight, | | |
| weight ratio of butadiene/styrene: 32/68) | | |
| Sodium salt of 2,4-dichloro-6-hydroxy- | 20 | g |
| S-triazine (8% by weight aqueous solution) | | |
| Sodium laurylbenzenesulfonate | 10 | ml |
| (1% by weight aqueous solution) | | |
| Distilled water | 854 | ml |
| Composition-3 (for second undercoat layer on the back | | |
| layer side) | | |
| SnO₂/SbO (weight ration: 9/1, average | 84 | g |
| particle size: 0.038 μm, 17% by weight | | |
| dispersion) | | |
| Gelatin (10% by weight aqueous solution) | 89.2 | g |
| Metolose TC-5 (manufactured by Shin-Etsu | 8.6 | g |
| Chemical Co., Ltd.) (2% by weight aqueous | | |
| solution) | | |
| Fine polymer particles (average particle | 0.01 | g |
| size: 0.4 μm MP-1000 manufactured by | | |
| Soken Chemical and Engineering Co., Ltd.) | | |
| Sodium dodecylbenzenesulfonate | 10 | ml |
| (1% by weight aqueous solution) | | |
| NaOH (1% by weight aqueous solution) | 6 | ml |
| Proxel (manufactured by ICI Ltd.) | 1 | ml |
| Distilled water | 805 | ml |

2. Preparation of Undercoated Support

On one surface (light-sensitive layer side) of the biaxially stretched polyethylene terephthalate support having a thickness of 175 μm, both surfaces of which had been subjected to the corona discharge treatment, was coated Composition-1 for undercoat layer by means of wire bar in a wet coating amount of 6.6 ml/m² (per one side) and dried at 180° C. for 5 minutes. Then, Composition-2 for undercoat layer was coated on the opposite side (back layer side) of the support by means of wire bar in a wet coating amount of 5.7 ml/m² and dried at 180° C. for 5 minutes. Further, Composition-3 for undercoat layer was coated on the opposite side (back layer side) of the support by means of wire bar in a wet coating amount of 7.7 ml/m² and dried at 180° C. for 6 minutes to prepare the undercoated support.

<Preparation of Coating Solution for Back Layer>

1. Preparation of Solid Fine Particle Dispersion (a) of Base Precursor

With 220 ml of distilled water were mixed 64 g of Base Precursor Compound 11, 28 g of diphenylsulfone and 10 g of a surface active agent (Demol N manufactured by Kao Corp.), and the mixture was dispersed using beads by a sand mill (¼ Gallon Sand Grinder Mill manufactured by Imex Inc.) to obtain the solid fine particle dispersion (a) of base precursor having an average particle size of 0.2 μm.

2. Preparation of Solid Fine Particle Dispersion of Dye

With 305 ml of distilled water were mixed 9.6 g of Cyanine Dye Compound 13 and 5.8 g of sodium p-dedecybenzenesulfonate, and the mixture was dispersed using beads by a sand mill (¼ Gallon Sand Grinder Mill manufactured by Imex Inc.) to obtain the solid fine particle dispersion of dye having an average particle size of 0.2 μm.

3. Preparation of Coating Solution for Anti-Halation Layer

With 844 ml of water were mixed 17 g of gelatin, 9.6 g of polyacrylamide, 70 g of the solid fine particle dispersion (a) of base precursor described above, 56 g of the solid fine particle dispersion of dye described above, 1.5 g of polymethyl methacrylate fine particles (average particle size: 6.5 μm), 0.03 g of benzisothiazolinone, 2.2 g of sodium polyethylenesulfonate and 0.2 g of Blue Dye Compound 14 to prepare the coating solution for anti-halation layer.

<Preparation of Coating Solution for Surface Protective Layer on Back Layer Side>

In a vessel maintained at 40° C., 50 g of gelatin, 0.2 g of sodium polystyrenesulfonate, 2.4 g of N,N-ethylenebis(vinylsulfonacetamide), 1 g of sodium tert-octylphenoxyethoxyethanesulfonate, 30 mg of benzisothiazolinone, 37 mg of potassium salt of N-perfluorooctylsulfonyl-N-propylalanine, 0.15 g of polyethylene glycol mono(N-perfluorooctylsulfonyl-N-propyl-2-aminoethyl) ether (average polymerization degree of ethylene oxide: 15), 32 mg of C₈F₁₇SO₃K, 64 mg of C₈F₁₇SO₂N(C₃H₇)(CH₂CH₂O)₄(CH₂)₄SO₃Na, 8.8 g of acrylic acid/ethyl acrylate copolymer (weight ratio of copolymerization: 5/95), 0.6 g of Aerosol OT (manufactured by American Cyanamid Co.), 1.8 g of liquid paraffin (as a liquid paraffin emulsion) and 950 ml of water were mixed to prepare the coating solution for surface protective layer on back layer side.

<Preparation of Silver Halide Emulsion 1>

To 1,421 ml of distilled water was added 8.0 ml of a 1% by weight aqueous potassium bromide solution, and then 8.2 ml of 1 N nitric acid and 20 g of phthalated gelatin were added thereto. The solution was maintained with stirring at 37° C. in a stainless steel reaction vessel coated with titanium. Separately, 37.04 g of silver nitrate was diluted with distilled water to 159 ml in volume to prepare Solution A, and 32.6 g of potassium bromide was diluted with distilled water to 200 ml in volume to prepare Solution B. Solution A was entirely added at a constant flow rate over a period of one minute to the above-described solution according to a controlled double jet method, while keeping pAg at 8.1. Solution B was added according to a controlled double jet method. Then, 30 ml of a 3.5% by weight aqueous hydrogen peroxide solution was added, and further 36 ml of a 3% by weight aqueous benzimidazole solution was added. Separately, Solution A was diluted with distilled water to 317.5 ml in volume to prepare Solution A2, and tripotassium hexachloroiridate was dissolved in Solution B in an amount so as to make the content 1×10⁻⁴ mol per mol of silver in the final emulsion and diluted with distilled water to 400 ml in volume to prepare Solution B2. Solution A2 was entirely added at a constant flow rate over a period of 10 minutes according to a controlled double jet method, while keeping pAg at 8.1. Solution B was added according to a controlled double jet method. Then, 50 ml of a 0.5% by weight methanol solution of 5-methyl-2-mercaptobenzimidazole was added, the pAg was controlled to 7.5 with silver nitrate, the pH was adjusted to 3.8 with sulfuric acid having a concentration of 0.5 mol/liter, and stirring was terminated. The mixture was subjected to precipitation, desalting and water washing steps, 3.5 g of deionized gelatin was added, and then an aqueous solution of sodium hydroxide having a concentration of 1 mol/liter was added to adjust the pH to 6.0, thereby preparing a silver halide emulsion having a pAg of 8.2.

The grains in the thus-prepared silver halide emulsion were pure silver bromide grains having an average equivalent spherical diameter of 0.035 μm and a variation coefficient of equivalent spherical diameter of 18%. The value was the average of 1,000 grains observed by an electron microscope. A proportion of {100} plane of the grain was 85% according to the Kubelka-Munk method.

The emulsion described above was maintained at 38° C. with stirring, 0.035 g of benzisothiazolinone (as a 3.5% by weight methanol solution) was added thereto, and 40 minutes after, a solid dispersion of Spectral Sensitizing Dye A (as an aqueous gelatin solution) was added in an amount of 5×10⁻³ mol per mol of silver. The temperature was raised to 47° C. after one minute, and 20 minutes after the temperature elevation, Tellurium Sensitizer B was added in an amount of 5×10⁻⁵ mol per mol of silver, followed by ripening for 90 minutes. Just before the completion of ripening, 5 ml of a 0.5% by weight methanol solution of N,N-dihydroxy-N-diethylmelamine was added, the temperature was decreased to 31° C., and 5 ml of a 3.5% by weight methanol solution of phenoxyethanol, 5-methyl-2-mercaptobenzimidazole in an amount of 7×10⁻³ mol per mol of silver and 1-phenyl-2-heptyl-5-mercapto-1,3,4-triazole in an amount of 6.4×10⁻³ mol per mol of silver were added to prepare Silver Halide Emulsion 1.

<Preparation of Silver Halide Emulsion 2>

In the same manner as in Preparation of Silver Halide Emulsion 1 except for changing the solution temperature from 37° C. to 50° C. to conduct the grain formation, a pure silver bromide cubic grain emulsion having an average equivalent spherical diameter of 0.08 μm and a variation coefficient of equivalent spherical diameter of 15% was prepared. The precipitation, desalting and water washing steps were conducted in the same manner as in Preparation of Silver Halide Emulsion 1. Then, the spectral sensitization, chemical sensitization and addition of 5-methyl-2-mercaptobenzimidazole and 1-phenyl-2-heptyl-5-mercapto-1,3,4-triazole were conducted in the same manner as in Preparation of Silver Halide Emulsion 1 except for changing the amount of Spectral Sensitizing Dye A to 4.5×10⁻³ mol per mol of silver, thereby preparing Silver Halide Emulsion 2.

<Preparation of Silver Halide Emulsion 3>

In the same manner as in Preparation of Silver Halide Emulsion 1 except for changing the solution temperature from 37° C. to 27° C. to conduct the grain formation, a pure silver bromide cubic grain emulsion having an average equivalent spherical diameter of 0.038 μm and a variation coefficient of equivalent spherical diameter of 20% was prepared. The precipitation, desalting and water washing steps were conducted in the same manner as in Preparation of Silver Halide Emulsion 1. Then, the spectral sensitization, chemical sensitization and addition of 5-methyl-2-mercaptobenzimidazole and 1-phenyl-2-heptyl-5-mercapto-1,3,4-triazole were conducted in the same manner as in Preparation of Silver Halide Emulsion 1 except for changing the amount of Spectral Sensitizing Dye A to 6×10⁻³ mol per mol of silver, thereby preparing Silver Halide Emulsion 3.

<Preparation of Mixed Silver Halide Emulsion A>

To a mixture of 70% by weight of Silver Halide Emulsion 1, 15% by weight of Silver Halide Emulsion 2 and 15% by weight of Silver Halide Emulsion 3 was added a 1% aqueous benzothiazolium iodide solution in an amount of 7×10⁻³ mol per mol of silver.

<Preparation of Scaly Fatty Acid Silver Salt>

A mixture of 87.6 g of behenic acid (Edenor C22-85R manufactured by Henkel Corp.), 423 ml of distilled water, 49.2 ml of an aqueous sodium hydroxide solution having a concentration 5 mol/liter and 120 ml of tert-butanol was reacted at 75° C. for one hour with stirring to prepare a solution of sodium behenate. Separately, 206.2 ml of an aqueous solution (pH: 4.0) containing 40.4 g of silver nitrate was prepared and maintained at 10° C. A reaction vessel containing 635 ml of distilled water and 30 ml of tert-butanol was maintained at 30° C., and the entire amount of the sodium behenate solution described above and the entire amount of the aqueous silver nitrate solution described above were added to the solution in the reaction vessel with stirring at a constant flow rate over a period of 62 minutes and 10 seconds and over a period of 60 minutes, respectively, in such a manner that only the aqueous silver nitrate solution was added from the start of the addition, 7 minutes and 20 seconds after the start of the addition of the aqueous silver nitrate solution, the addition of the sodium behenate solution was started, and only the sodium behenate solution was added for 9 minutes and 30 seconds after the completion of the addition of the aqueous silver nitrate solution. The temperature in the reaction vessel was maintained at 30° C. and the outer temperature was controlled so as to be constantly maintained the temperature of the solution. Further, the piping of the addition system of the sodium behenate solution was warmed by a steam trace, and a steam aperture was adjusted so that the solution temperature at the outlet of the addition nozzle tip became 75° C. The piping of the addition system of the aqueous silver nitrate solution was also temperature-controlled by circulating cold water in the outer jacket of a double-walled tube. The positions where the sodium behenate solution and the aqueous silver nitrate solution were added were arranged symmetrically in relation to the stirring axle in the center, and the height of positions was adjusted so as not to touch the reaction solution.

After the completion of the addition of the sodium behenate solution, the reaction solution was stirred at the same temperature for 20 minutes and allowed to stand to decrease the temperature to 25° C. The solid content was colleted by suction filtration and then washed with water until the conductivity of the filtrate reached to 30 μS/cm. Thus, the fatty acid silver salt was obtained. The solid content obtained was stored as a wet cake without drying.

The shape of the silver behenate particles thus-obtained was evaluated using electron microscopic photography. The silver behenate particles were scaly crystals having average values of a=0.14 μm, b=0.4 μm and c=0.6 μm, an average aspect ratio of 5.2, an average equivalent spherical diameter of 0.52 μm, and a variation coefficient of the equivalent spherical diameter of 15% (a, b and c have the meanings as defined hereinbefore respectively).

To the wet cake in an amount corresponding to 100 g of dried solid content were added 7.4 g of polyvinyl alcohol (PVA-217 manufactured by Kuraray Co., Ltd., average polymerization degree: about 1,700) and water to make the entire amount of 385 g, and then the mixture was preliminarily dispersed by a homomixer.

The preliminarily dispersed solution was processed three times using a dispersing machine (Microfluidizer M-110S-EH equipped with a GOLZ interaction chamber, manufactured by Microfluidex International Corp.) under a pressure adjusted to 175.0 Mpa to prepare a silver behenate dispersion. The cooling operation was performed by using coil type heat exchangers installed before and behind the interaction chamber respectively and by adjusting the temperature of coolant, thereby setting the dispersion temperature at 18° C.

<Preparation of 25% by Weight Dispersion of Reducing Agent>

To a mixture of 10 kg of 1,1-bis(2-hydroxy-3,5-dimethylphenyl)-3,5,5-trimethylhexane (Compound (1-1)) and 10 kg of a 20% by weight aqueous solution of modified polyvinyl alcohol (Poval MP 203 manufacture by Kuraray Co., Ltd.) were added 16 kg of water, and the mixture was thoroughly mixed to make a slurry. The slurry was fed by means of a diaphragm pump into a horizontal type sand mill (UVM-2 manufactured by Imex Inc.) filled with zirconia beads having an average diameter of 0.5 mm, and dispersed for 3 hours and 30 minutes. Then, 0.2 g of sodium salt of benzisothiazolinone and water were added to the dispersion so as to make the concentration of the reducing agent 25% by weight, thereby preparing a dispersion of reducing agent. The particles of the reducing agent included in the dispersion of reducing agent thus obtained had a median particle size of 0.40 μm and a maximum particle size of not more than 1.8 μm. The dispersion of reducing agent was filtered with a polypropylene filter having a pore size of 10.0 μm to remove foreign matter such as contaminant, and stored.

<Preparation of 10% by Weight Dispersion of Mercapto Compound>

To a mixture of 5 kg of 1-phenyl-2-heptyl-5-mercapto-1,3,4-triazole and 5 kg of a 20% by weight aqueous solution of modified polyvinyl alcohol (Poval MP 203 manufacture by Kuraray Co., Ltd.) were added 8.3 kg of water, and the mixture was thoroughly mixed to make a slurry. The slurry was fed by means of a diaphragm pump into a horizontal type sand mill (UVM-2 manufactured by Imex Inc.) filled with zirconia beads having an average diameter of 0.5 mm, and dispersed for 6 hours. Then, water was added to the dispersion so as to make the concentration of the mercapto compound 10% by weight, thereby preparing a dispersion of mercapto compound. The particles of the mercapto compound included in the dispersion of mercapto compound thus obtained had a median particle size of 0.40 μm and a maximum particle size of not more than 2.0 μm. The dispersion of mercapto compound was filtered with a polypropylene filter having a pore size of 10.0 μm to remove foreign matter such as contaminant, and stored. The dispersion of mercapto compound was again filtered with a polypropylene filter having a pore size of 10.0 μm just before the use.

<Preparation of 20% by Weight Dispersion of Organic Polyhalogen Compound-1>

To a mixture of 5 kg of tribromomethylnaphthylsulfone, 2.5 kg of a 20% by weight aqueous solution of modified polyvinyl alcohol (Poval MP 203 manufacture by Kuraray Co., Ltd.) and 213 g of a 20% by weight aqueous solution of sodium triisopropylnaphthalenesulfonate were added 10 kg of water, and the mixture was thoroughly mixed to make a slurry. The slurry was fed by means of a diaphragm pump into a horizontal type sand mill (UVM-2 manufactured by Imex Inc.) filled with zirconia beads having an average diameter of 0.5 mm, and dispersed for 5 hours. Then, 0.2 g of sodium salt of benzisothiazolinone and water were added to the dispersion so as to make the concentration of the organic polyhalogen compound 20% by weight, thereby preparing a dispersion of organic polyhalogen compound. The particles of the organic polyhalogen compound included in the dispersion of organic polyhalogen compound thus obtained had a median particle size of 0.36 μm and a maximum particle size of not more than 2.0 μm. The dispersion of organic polyhalogen compound was filtered with a polypropylene filter having a pore size of 3.0 μm to remove foreign matter such as contaminant, and stored.

<Preparation of 25% by Weight Dispersion of Organic Polyhalogen Compound-2>

A dispersion was prepared in the same manner as in Preparation of 20% by weight Dispersion of Organic Polyhalogen Compound-1 except for using 5 kg of N-butyl-3-tribromomethanesulfonylbenzamide in place of 5 kg of tribromomethylnaphthylsulfone, and water was added to the dispersion so as to make the concentration of the organic polyhalogen compound 25% by weight. Thus, the dispersion of organic polyhalogen compound was obtained. The particles of the organic polyhalogen compound included in the dispersion of organic polyhalogen compound thus obtained had a median particle size of 0.39 μm and a maximum particle size of not more than 2.2 μm. The dispersion of organic polyhalogen compound was filtered with a polypropylene filter having a pore size of 3.0 μm to remove foreign matter such as contaminant, and stored.

<Preparation of 30% by Weight Dispersion of Organic Polyhalogen Compound-3>

A dispersion was prepared in the same manner as in Preparation of 20% by weight Dispersion of Organic Polyhalogen Compound-1 except for using 5 kg of tribromomethylphenylsulfone in place of 5 kg of tribromomethylnaphthylsulfone and changing the amount of 20% by weight aqueous solution of modified polyvinyl alcohol to 5 kg, and water was added to the dispersion so as to make the concentration of the organic polyhalogen compound 30% by weight. Thus, the dispersion of organic polyhalogen compound was obtained. The particles of the organic polyhalogen compound included in the dispersion of organic polyhalogen compound thus obtained had a median particle size of 0.41 μm and a maximum particle size of not more than 2.0 μm. The dispersion of organic polyhalogen compound was filtered with a polypropylene filter having a pore size of 3.0 μm to remove foreign matter such as contaminant, and stored at 10° C. or below until the use.

<Preparation of 5% by Weight Solution of Phthalazine Compound>

In 174.57 kg of water was dissolved 8 kg of modified polyvinyl alcohol (Poval MP 203 manufacture by Kuraray Co., Ltd.), and to the solution were added 3.15 kg of a 20% by weight aqueous solution of sodium triisopropylnaphthalenesulfonate and 14.28 kg of a 70% by weight aqueous solution of 6-isopropylphthalazine to prepare a 5% by weight solution of 6-isopropylphthalazine.

<Preparation of 20% by Weight Dispersion of Pigment>

To a mixture of 64 g of C. I. Pigment Blue 60 and 6.4 g of Demol N (manufactured by Kao Corp.) was added 250 ml of water, and the mixture was thoroughly mixed to make a slurry. The slurry was put into a vessel together with 800 g of zirconia beads having an average diameter of 0.5 mm and dispersed by a sand mill (1/4 Gallon Sand Grinder Mill manufactured by Imex Inc.) for 25 hours to prepare a dispersion of pigment. The particles of the pigment included in the dispersion of pigment thus obtained had an average particle size of 0.21 μm.

<Preparation of Binder for Image Forming Layer>

Polymer Latex (RP-1) obtained by Comparative Synthesis Example 1 shown below was treated by adding an aqueous NaOH solution having a concentration of 1 mol/liter and an aqueous NH₄OH solution having a concentration of 1 mol/liter so that a ratio of Na⁺ ion/NH₄⁺ ion was 1/2.3 by mole, and a pH of the latex was adjusted to 8.4. The latex concentration was 40% by weight.

### COMPARATIVE SYNTHESIS EXAMPLE 1

### Synthesis of Polymer Latex (RP-1): Modified Polymer Latex (P-1)

Polymer Latex (RP-1) (solid content: 45%, particle size: 79 nm, gel fraction: 71%) was synthesized in the same manner as in Synthesis Example 1 described above except for changing the surface active agent to Pelex SS-L (manufactured by Kao Corp.). The concentration of chlorine ion was 1,000 ppm.

<Preparation of Coating Solution for Image Forming Layer>

A mixture of 1.1 g of the 20% by weight dispersion of pigment, 103 g of the organic acid silver salt dispersion, 5 g of a 20% by weight aqueous solution of polyvinyl alcohol (PVA-205 manufacture by Kuraray Co., Ltd.), 25 g of the 25% by weight dispersion of reducing agent, 13.2 g of the dispersions of organic polyhalogen compound-1, -2 and -3 (2/5/2 by weight ratio), 6.2 g of the 10% by weight dispersion of mercapto compound, 106 g of the binder for image forming layer (Polymer Latex (RP-1), latex concentration: 40% by weight) and 18 ml of the 5% by weight solution of phthalazine compound was thoroughly mixed with 10 g of the mixed silver halide emulsion A to prepare a coating solution for image forming layer (light-sensitive layer, emulsion layer). The coating solution was fed to a coating die, as it was so as to be a coating amount of 70 ml/m².

The viscosity of the coating solution for image forming layer measured by a Brookfield type viscometer (manufactured by Tokyo Keiki Co., Ltd.) at 40° C. (No. 1 rotor, at 60 rpm) was 85 mPa·s.

The viscosities of the coating solution measured by RFS Fluid Spectrometer (manufactured by Rheometrix Far East Ltd.) at 25° C. were 1,500, 220, 70, 40 and 20 mPa·s at the shearing velocity of 0.1, 1, 10, 100 and 1,000 (1/sec), respectively.

<Preparation of Coating Solution for Intermediate Layer on Emulsion Layer Side>

To a mixture of 772 g of a 10% by weight aqueous solution of polyvinyl alcohol (PVA-205 manufacture by Kuraray Co., Ltd.), 5.3 g of the 20% by weight dispersion of pigment, 226 g of a 27.5% by weight latex solution of methyl methacrylate/styrene/butyl acrylate/hydroxyethyl methacrylate/acrylic acid copolymer (copolymerization ratio: 64/9/20/5/2 by weight) were added 2 ml of a 5% by weight aqueous solution of Aerosol OT (manufactured by American Cyanamid Co.) and 10.5 ml of a 20% by weight aqueous solution of diammonium phthalate, and then added water to make the total weight 880 g, thereby preparing a coating solution for intermediate layer. The coating solution was fed to a coating die so as to be a coating amount of 10 ml/m².

The viscosity of the coating solution for intermediate layer measured by a Brookfield type viscometer at 40° C. (No. 1 rotor, at 60 rpm) was 21 mPa·s.

<Preparation of Coating Solution for First Protective Layer on Emulsion Layer Side>

To a solution prepared by dissolving 64 g of inert gelatin in water were added 80 g of a 27.5% by weight latex solution of methyl methacrylate/styrene/butyl acrylate/hydroxyethyl methacrylate/acrylic acid copolymer (copolymerization ratio: 64/9/20/5/2 by weight), 23 ml of a 10% by weight methanol solution of phthalic acid, 23 ml of a 10% by weight aqueous solution of 4-methylphthalic acid, 28 ml of sulfuric acid having a concentration of 0.5 mol/liter, 5 ml of a 5% by weight aqueous solution of Aerosol OT (manufactured by American Cyanamid Co.), 0.5 g of phenoxyethanol and 0.1 g of benzisothiazolinone, and then added water to make the total weight 750 g, thereby preparing a coating solution for first protective layer. Just before coating, 26 ml of a 4% by weight aqueous solution of chrome alum was added to the coating solution using a static mixer, then the coating solution was fed to a coating die so as to be a coating amount of 18.6 ml/m².

The viscosity of the coating solution for first protective layer measured by a Brookfield type viscometer at 40° C. (No. 1 rotor, at 60 rpm) was 17 mPa·s.

<Preparation of Coating Solution for Second Protective Layer on Emulsion Layer Side>

To a solution prepared by dissolving 80 g of inert gelatin in water were added 102 g of a 27.5% by weight latex solution of methyl methacrylate/styrene/butyl acrylate/hydroxyethyl methacrylate/acrylic acid copolymer (copolymerization ratio: 64/9/20/5/2 by weight), 3.2 ml of a 5% by weight aqueous solution of potassium salt of N-perfluorooctylsulfonyl-N-propylalanine, 32 ml of a 2% by weight aqueous solution of polyethylene glycol mono(N-perfluorooctylsulfonyl-N-propyl-2-aminoethyl) ether (average polymerization degree of ethylene oxide: 15), 23 ml of a 5% by weight aqueous solution of Aerosol OT (manufactured by American Cyanamid co.), 4 g of polymethyl methacrylate fine particles (average particle size: 0.7 m), 21 g of polymethyl methacrylate fine particles (average particle size: 6.4 μm), 1.6 g of 4-methylphthalic acid, 4.8 g of phthalic acid, 44 ml of sulfuric acid having a concentration of 0.5 mol/liter and 10 mg of benzisothiazolinone, and then added water to make the total weight 650 g, thereby preparing a coating solution for second protective layer. Just before coating, 445 ml of an aqueous solution containing 4% by weight of chrome alum and 0.67% by weight of phthalic acid was added to the coating solution using a static mixer, then the coating solution was fed to a coating die so as to be a coating amount of 8.3 ml/m².

The viscosity of the coating solution for second protective layer measured by a Brookfield type viscometer at 40° C. (No. 1 rotor, at 60 rpm) was 9 mPa·s.

<Preparation of Heat-Developable Image Recording Material>

On the back layer side of the undercoated support described above, the coating solution for anti-halation layer and the coating solution for protective layer on back layer side were simultaneously multilayer-coated in such a manner that a coating amount of the solid fine particles of dye in the anti-halation layer became 0.04 g/m² and a coating amount of gelatin in the protective layer on back layer side became 1.7 g/m², and dried to prepare an anti-halation back layer.

On the undercoat layer provided on the opposite side to the back layer, the coating solutions for image forming layer (coating amount of silver halide: 0.14 g/m² in terms of silver), intermediate layer, first protective layer and second protective layer were simultaneously multilayer-coated in this order from the undercoat layer by a slide bead coating method to prepare the heat-developable image recording material, which was designated Sample 101.

Specifically, the coating was performed at a coating speed of 160 m/min. The distance between the tip of the coating die and the support was adjusted in a range of from 0.14 to 0.28 mm. The width of coating was controlled so as to increase 0.5 mm on each side to the discharge slit width for the coating solution. The pressure in a reduced pressure chamber was set lower than the atmospheric pressure by 392 Pa. The support was handled so as to prevent electrification while controlling temperature and humidity and electrically discharged with ionized air just before coating. In a subsequent chilling zone, the coating solution was chilled by blowing air of dry bulb temperature of 18° C. and wet bulb temperature of 12° C. for 30 seconds. The image recording material was transported in a helical floating type drying zone while blowing dry air of dry bulb temperature of 30° C. and wet bulb temperature of 18° C. for 200 seconds. Then, it was passed through a drying zone of 70° C. for 20 seconds and a drying zone of 90° C. for 10 seconds, and thereafter cooled to 25° C., thereby evaporating the solvent in the coating solution. In the chilling zone and drying zones, the average wind speed blown on the surface of coating was 7 m/sec.

With respect to the matting degree of the heat-developable image recording material, the Bekk smoothness of the image forming layer side was 550 seconds, and that of the back layer side was 130 seconds.

Samples 102 to 121 were prepared by appropriately selecting the phenol reducing agent (compound represented by formula (I)) and the compound which satisfies one of the conditions (A) and (B) (compound used in combination with the compound represented by formula (I)), the coating amounts thereof (denoted relatively by mol % taking the coating amount of Compound (1-1) as 100), and the binder for the image forming layer as shown in Table 1 below, so as to each sample provide the development density nearly equal to that of Sample 101. With Samples 101 to 121, the coating property and the image preservability were evaluated. The results obtained are shown in Table 1 below.

In Table 1 below, the phenol reducing agents are selected from Compounds (1-1) to (1-34), which are specific examples of the compound represented by formula (I) described above, the compounds used in combination with the compound represented by formula (I) are selected from Compounds (1) to (32), which are specific examples of the compound represented by formula (II), (III), (IV) or (V) described above and Compounds (II-1) to (II-90), which are specific examples of the compound having a phosphoryl group described above, and the binders for image forming layer are selected from Polymer Latexes (P-1) to (P-24), which are specific examples of the polymer latex described above and Polymer Latexes (RP-1) to (RP-2), respectively.

In the preparation of Samples 102 to 121, when the phenol reducing agent (compound represented by formula (I)) different from the compound used in Sample 101 was employed, a 25% by weight dispersion of the phenol reducing agent was prepared in the same manner as in Preparation of 25% by weight Dispersion of Reducing Agent described above except for using the phenol reducing agent in place of 1,1-bis(2-hydroxy-3,5-dimethylphenyl)-3,5,5-trimethylhexane (Compound (1-1)).

In the preparation of Samples 102 to 121, when the compound used in combination with the compound represented by formula (I) was employed, it was incorporated into the coating solution for image forming layer as the dispersion thereof. The amount thereof used was controlled to be equivalent to the amount of phenol reducing agent by mol. Preparation of dispersion of Compound (II-2) is illustrated below. Dispersions of other compounds were also prepared in the same manner.

<Preparation of Dispersion of Compound (II-2)>

To a mixture of 1 kg of Compound (II-2) and 1 kg of a 20% by weight aqueous solution of modified polyvinyl alcohol (Poval MP 203 manufacture by Kuraray Co., Ltd.) were added 1.6 kg of water, and the mixture was thoroughly mixed to make a slurry. The slurry was fed by means of a diaphragm pump into a horizontal type sand mill (UVM-2 manufactured by Imex Inc.) filled with zirconia beads having an average diameter of 0.5 mm, and dispersed for 3 hours and 30 minutes. Then, 0.2 g of sodium salt of benzisothiazolinone and water were added to the dispersion so as to make the concentration of the phosphoryl compound 25% by weight, thereby preparing a solid fine particle dispersion of phosphoryl compound. The particles of the phosphoryl compound included in the dispersion thus obtained had a median particle size of 0.45 μm and a maximum particle size of not more than 2.0 μm. The dispersion of phosphoryl compound was filtered with a polypropylene filter having a pore size of 10.0 μm to remove foreign matter such as contaminant, and stored.

In the preparation of Samples 102 to 121, when the binder for image forming layer different from that used in Sample 101 was employed, the binder was prepared in the same manner as in Preparation of Binder for Image Forming Layer described above. In Table 1, the binder for image forming layer used and the halogen ion content thereof are set forth. Polymer Latex (RP-2) used in Sample 103 was prepared according to Comparative Synthesis Example 2 described below.

### COMPARATIVE SYNTHESIS EXAMPLE 2

### Synthesis of Polymer Latex (RP-2): Purified and Concentrated Polymer Latex (RP-1)

Polymer Latex (RP-1) obtained in Comparative Synthesis Example 1 was subjected to dialysis with distilled water using a cellulose tube for dialysis (C-65 manufactured by Viskase Corp.) for 6 hours. The resulting dialysis product was mixed with Polymer Latex (RP-1) in an amount corresponding to the solid content of polymer in the dialysis product, and the mixed latex was concentrated to 45% with a evaporator to obtain Polymer Latex (RP-2) (solid content: 45%, particle size: 110 nm, gel fraction: 72%). The concentration of chlorine ion was 550 ppm.

<Evaluation of Coating Property>

The evaluation of coating property was conducted by visually observing the surface of each sample after coating and determining numbers of streaks and repelling marks per 5 m². The criteria of evaluation according to the numbers of streaks and repelling marks are as follows:

A: 0

B: 1

C: 2 to 4

D: 5 or more

In the above criteria, only A and B are practically acceptable.

<Evaluation of Image Preservability>

The evaluation of image preservability was conducted by preserving each image recording material after heat development under conditions of 60° C. and 55% RH for one day and determining difference in density (ADmin) in a white background portion before and after the preservation.

TABLE 1

| | | | Phenol Reducing | | Compound | | | | |
|---|---|---|---|---|---|---|---|---|---|
| | | | Agent | | combined | | | | |
| | Binder for Image | | Compound of | | with Phenol | | | | |
| | Forming Layer | | Formula (I) | | Reducing Agent | | | | |
| | | Halogen | | Coating | | Coating | | | |
| | | Ion | | Amount | | Amount | | | |
| Sample | | Content | | (relative | | (relative | Coating | Image | |
| No | Species | (ppm) | Species | mol %) | Species | mol %) | Property | Preservability | Remarks |
| 101 | RP-1 | 1,000 | (I-1) | 100 | — | — | A | 0.252 | Comparison |
| 102 | RP-1 | 1,000 | (I-1) | 100 | (II-2) | 100 | B | 0.144 | Comparison |
| 103 | RP-2 | 550 | (I-1) | 100 | (II-2) | 100 | C | 0.033 | Comparison |
| 104 | P-1 | 9 | (I-1) | 100 | (II-2) | 100 | A | 0.036 | Invention |
| 105 | P-1 | 9 | (I-1) | 100 | — | — | A | 0.102 | Invention |
| 106 | P-1 | 9 | (I-2) | 80 | (II-2) | 80 | A | 0.044 | Invention |
| 107 | P-1 | 9 | (I-3) | 50 | (II-2) | 50 | A | 0.039 | Invention |
| 108 | P-1 | 9 | (I-4) | 65 | (II-2) | 65 | A | 0.047 | Invention |
| 109 | P-1 | 9 | (I-7) | 90 | (II-2) | 90 | B | 0.061 | Invention |
| 110 | P-2 | 8 | (I-1) | 100 | (2) | 100 | A | 0.055 | Invention |
| 111 | P-3 | 25 | (I-1) | 100 | (6) | 100 | A | 0.047 | Invention |
| 112 | P-4 | 15 | (I-1) | 100 | (8) | 100 | A | 0.039 | Invention |
| 113 | P-5 | 200 | (I-1) | 100 | (11) | 100 | A | 0.042 | Invention |
| 114 | P-7 | 380 | (I-1) | 100 | (13) | 100 | B | 0.062 | Invention |
| 115 | P-8 | 48 | (I-1) | 100 | (15) | 100 | A | 0.077 | Invention |
| 116 | P-10 | 150 | (I-1) | 100 | (16) | 100 | A | 0.081 | Invention |
| 117 | P-12 | 350 | (I-1) | 100 | (17) | 100 | A | 0.076 | Invention |
| 118 | P-15 | 430 | (I-1) | 100 | (II-51) | 100 | A | 0.098 | Invention |
| 119 | P-18 | 87 | (I-1) | 100 | (II-26) | 100 | A | 0.052 | Invention |
| 120 | P-20 | 8 | (I-1) | 100 | (23) | 100 | A | 0.058 | Invention |
| 121 | P-21 | 29 | (I-1) | 100 | (24) | 100 | B | 0.048 | Invention |

As is parent from the results shown in Table 1, the image preservability and coating property were extremely improved by using the specific polymer latex as the binder for image forming layer.

### EXAMPLE 2

Heat-developable image recording materials were prepared according to the same procedures in Example 1 except that Silver Halide Emulsions 1 to 3, Mixed Silver Halide Emulsion A, 25% by weight Dispersion of Reducing Agent, 25% by weight Dispersion of Organic Polyhalogen Compound-2, 30% by weight Dispersion of Organic Polyhalogen Compound-3 and Coating Solution for Image Forming Layer were changed to those prepared described below, and a dispersion of phosphoryl compound was used.

<Preparation of Silver Halide Emulsion 1>

To 1,421 ml of distilled water was added 3.1 ml of a 1% by weight aqueous potassium bromide solution, and then 3.5 ml of sulfuric acid having a concentration of 0.5 mol/liter and 31.7 g of phthalated gelatin were added thereto. The solution was maintained with stirring at 34° C. in a stainless steel reaction vessel coated with titanium. Separately, 22.22 g of silver nitrate was diluted with distilled water to 95.4 ml in volume to prepare Solution A, and 15.9 g of potassium bromide was diluted with distilled water to 97.4 ml in volume to prepare Solution B. Solution A and Solution B were entirely added at a constant flow rate over a period of 45 seconds to the above-described solution. Then, 10 ml of a 3.5% by weight aqueous hydrogen peroxide solution was added, and further 10.8 ml of a 10% by weight aqueous benzimidazole solution was added. Separately, 51.86 g of silver nitrate was diluted with distilled water to 317.5 ml in volume to prepare Solution C, and 45.8 g of potassium bromide was diluted with distilled water to 400 ml in volume to prepare Solution D. Solution C was entirely added at a constant flow rate over a period of 20 minutes, and Solution D was added while keeping a pAg at 8.1 according to a controlled double jet method. After 10 minutes since the start of addition of Solution C and Solution D, potassium hexachloroiridate (III) was added in an amount so as to make the content 1×10⁻⁴ mol per mol of silver in the final emulsion. Further, 5 seconds after the completion of addition of Solution C, an aqueous solution of potassium hexacyanoferrate (II) was added in an amount so as to make the content 3×10⁻⁴ mol per mol of silver in the final emulsion. The pH was adjusted to 3.8 with sulfuric acid having a concentration of 0.5 mol/liter, and stirring was terminated. The mixture was subjected to precipitation, desalting and water washing steps, and then an aqueous solution of sodium hydroxide having a concentration of 1 mol/liter was added to adjust the pH to 5.9, thereby preparing a silver halide dispersion having a pAg to 8.0.

To the silver halide dispersion maintaining at 38° C. with stirring, 5 ml of a 0.34% by weight methanol solution of 1,2-benzisothiazolin-3-one was added thereto, and 40 minutes after, a methanol solution of Spectral Sensitizing Dye A was added in an amount of 1×10⁻³ mol per mol of silver. The temperature was raised to 47° C. after one minute, and 20 minutes after the temperature elevation, a methanol solution of sodium benzenethiosulfonate was added in an amount of 7.6×10⁻⁵ mol per mol of silver, and after 5 minutes, a methanol solution of Tellurium Sensitizer B was added in an amount of 1.9×10⁻⁴ mol per mol of silver, followed by ripening for 91 minutes. Then, 1.3 ml of a 0.8% by weight methanol solution of N,N′-dihydroxy-N″-diethylmelamine was added, after 4 minutes, a methanol solution of 5-methyl-2-mercaptobenzimidazole and a methanol solution of 1-phenyl-2-heptyl-5-mercapto-1,3,4-triazole were added in an amount of 3.7×10⁻³ mol per mol of silver and in an amount of 4.9×10⁻³ mol per mol of silver, respectively, to prepare Silver Halide Emulsion 1.

The grains in the thus-prepared silver halide emulsion were pure silver bromide grains having an average equivalent spherical diameter of 0.046 μm and a variation coefficient of equivalent spherical diameter of 20%. The value was the average of 1,000 grains observed by an electron microscope. A proportion of {100} plane of the grain was 80% according to the Kubelka-Munk method.

<Preparation of Silver Halide Emulsion 2>

Silver Halide Emulsion 2 was prepared in the same manner as in Preparation of Silver Halide Emulsion 1 except for changing the solution temperature from 34° C. to 49° C. to conduct the grain formation, changing the addition period of Solution C from 20 minutes to 30 minutes and eliminating the addition of potassium hexacyanoferrate (II). The precipitation, desalting and water washing steps were conducted in the same manner as in Preparation of Silver Halide Emulsion 1. Then, the spectral sensitization, chemical sensitization and addition of 5-methyl-2-mercaptobenzimidazole and 1-phenyl-2-heptyl-5-mercapto-1,3,4-triazole were conducted in the same manner as in Preparation of Silver Halide Emulsion 1 except for changing the amount of Spectral Sensitizing Dye A to 7.5×10⁻⁴ mol per mol of silver, the amount of Tellurium Sensitizer B to 1.1×10⁻⁴ mol per mol of silver, and the amount of 1-phenyl-2-heptyl-5-mercapto-1,3,4-triazole to 3.3×10⁻³ mol per mol of silver, respectively, thereby preparing Silver Halide Emulsion 2. The grains in Silver Halide Emulsion 2 were pure silver bromide cubic grains having an average equivalent spherical diameter of 0.080 m and a variation coefficient of equivalent spherical diameter of 20%.

<Preparation of Silver Halide Emulsion 3>

Silver Halide Emulsion 3 was prepared in the same manner as in Preparation of Silver Halide Emulsion 1 except for changing the solution temperature from 34° C. to 27° C. to conduct the grain formation. The precipitation, desalting and water washing steps were conducted in the same manner as in Preparation of Silver Halide Emulsion 1. Then, in the same manner as in Preparation of Silver Halide Emulsion 1 except for changing the amount of Spectral Sensitizing Dye A to 6×10⁻³ mol per mol of silver and changing the amount of Tellurium Sensitizer B to 5.2×10⁻⁴ mol per mol of silver, Silver Halide Emulsion 3 was prepared. The grains in Silver Halide Emulsion 3 were pure silver bromide cubic grains having an average equivalent spherical diameter of 0.038 μm and a variation coefficient of equivalent spherical diameter of 20%.

<Preparation of Mixed Silver Halide Emulsion A>

To a mixture of 70% by weight of Silver Halide Emulsion 1, 15% by weight of Silver Halide Emulsion 2 and 15% by weight of Silver Halide Emulsion 3 was added a 1% by weight aqueous benzothiazolium iodide solution in an amount of 7×10⁻³ mol per mol of silver.

<Preparation of 25% by Weight Dispersion of Reducing Agent>

To a mixture of 10 kg of 1,1-bis(2-hydroxy-3,5-dimethylphenyl)-3,5,5-trimethylhexane (Compound (1-1)) and 10 kg of a 20% by weight aqueous solution of modified polyvinyl alcohol (Poval MP 203 manufacture by Kuraray Co., Ltd.) were added 16 kg of water, and the mixture was thoroughly mixed to make a slurry. The slurry was fed by means of a diaphragm pump into a horizontal type sand mill (UVM-2 manufactured by Imex Inc.) filled with zirconia beads having an average diameter of 0.5 mm, and dispersed for 3 hours and 30 minutes. Then, 0.2 g of sodium salt of benzisothiazolinone and water were added to the dispersion so as to make the concentration of the reducing agent 25% by weight, thereby preparing a solid fine particle dispersion of reducing agent. The particles of the reducing agent included in the dispersion thus obtained had a median particle size of 0.42 μm and a maximum particle size of not more than 2.0 μm. The dispersion of reducing agent was filtered with a polypropylene filter having a pore size of 10.0 μm to remove foreign matter such as contaminant, and stored.

<Preparation of 25% by Weight Dispersion of Phosphoryl Compound>

To a mixture of 1 kg of triphenylphosphine oxide as the phosphoryl compound and 1 kg of a 20% by weight aqueous solution of modified polyvinyl alcohol (Poval MP 203 manufacture by Kuraray Co., Ltd.) were added 1.6 kg of water, and the mixture was thoroughly mixed to make a slurry. The slurry was fed by means of a diaphragm pump into a horizontal type sand mill (UVM-2 manufactured by Imex Inc.) filled with zirconia beads having an average diameter of 0.5 mm, and dispersed for 3 hours and 30 minutes. Then, 0.2 g of sodium salt of benzisothiazolinone and water were added to the dispersion so as to make the concentration of the phosphoryl compound 25% by weight, thereby preparing a solid fine particle dispersion of phosphoryl compound. The particles of the phosphoryl compound included in the dispersion thus obtained had a median particle size of 0.45 μm and a maximum particle size of not more than 2.0 μm. The dispersion of phosphoryl compound was filtered with a polypropylene filter having a pore size of 10.0 μm to remove foreign matter such as contaminant, and stored.

<Preparation of 25% by Weight Dispersion of Organic Polyhalogen Compound-2>

A dispersion was prepared in the same manner as Preparation of 20% by weight Dispersion of organic Polyhalogen Compound-1 except for using 5 kg of tribromomethyl(4-(2,4,6-trimethylphenylsulfonyl)phenyl)-sulfone in place of 5 kg of tribromomethylnaphthylsulfone, and water was added to the dispersion so as to make the concentration of the organic polyhalogen compound 25% by weight, thereby preparing a dispersion of organic polyhalogen compound. The particles of the organic polyhalogen compound included in the dispersion of organic polyhalogen compound thus obtained had a median particle size of 0.38 μm and a maximum particle size of not more than 2.0 μm. The dispersion of organic polyhalogen compound was filtered with a polypropylene filter having a pore size of 3.0 μm to remove foreign matter such as contaminant, and stored.

<Preparation of 30% by Weight Dispersion of Organic Polyhalogen Compound-3>

A dispersion was prepared in the same manner as Preparation of 20% by weight Dispersion of Organic Polyhalogen Compound-1 except for using 5 kg of tribromomethylphenylsulfone in place of 5 kg of tribromomethylnaphthylsulfone and changing the amount of 20% by weight aqueous solution of modified polyvinyl alcohol to 5 kg, and water was added to the dispersion so as to make the concentration of the organic polyhalogen compound 30% by weight, thereby preparing the dispersion of organic polyhalogen compound. The particles of the organic polyhalogen compound included in the dispersion of organic polyhalogen compound thus obtained had a median particle size of 0.41 μm and a maximum particle size of not more than 2.0 μm. The dispersion of organic polyhalogen compound was filtered with a polypropylene filter having a pore size of 3.0 μm to remove foreign matter such as contaminant, and stored at 10° C. or below until the use.

<Preparation of Coating Solution for Image Forming Layer (Light-Sensitive Layer)>

A mixture of 1.1 g of the 20% by weight dispersion of pigment, 103 g of the organic acid silver salt dispersion, 5 g of a 20% by weight aqueous solution of polyvinyl alcohol (PVA-205 manufacture by Kuraray Co., Ltd.), 25 g of the 25% by weight dispersion of reducing agent, 9.4 g of the 25% by weight dispersion of phosphoryl compound, 16.3 g of the dispersions of organic polyhalogen compound-1, -2 and -3 (5/1/3 by weight ratio), 6.2 g of the 10% by weight dispersion of mercapto compound, 106 g of the binder for image forming layer (Polymer Latex (RP-1), latex concentration: 40% by weight) and 18 ml of the 5% by weight solution of phthalazine compound is mixed thoroughly with 10 g of the mixed silver halide emulsion A to prepare a coating solution for image forming layer. The coating solution was fed to a coating die, as it was so as to be a coating amount of 70 ml/m².

<Preparation of Heat-Developable Image Recording Material>

A heat-developable image recording material, Sample 201, was prepared in the same manner as in Sample 101 in Example 1, except for using the components described above.

In a manner similar to Example 1, Samples 202 to 217 and Samples 301 to 314 were prepared by appropriately selecting the phenol reducing agent (compound represented by formula (I)) and the compound which satisfies one of the conditions (A) and (B) (compound used in combination with the compound represented by formula (I)), the coating amounts thereof, and the binder for the image forming layer as shown in Tables 2 and 3 below, so as to each sample provide the development density nearly equal to that of Sample 201. With Samples 201 to 217 and Samples 301 to 314, the coating property and the image preservability were evaluated. The results obtained are shown in Tables 2 and 3 below.

TABLE 2

| | | | Phenol Reducing | | Compound | | | | |
|---|---|---|---|---|---|---|---|---|---|
| | | | Agent | | combined | | | | |
| | Binder for Image | | Compound of | | with Phenol | | | | |
| | Forming Layer | | Formula (I) | | Reducing Agent | | | | |
| | | Halogen | | Coating | | Coating | | | |
| | | Ion | | Amount | | Amount | | | |
| Sample | | Content | | (relative | | (relative | Coating | Image | |
| No | Species | (ppm) | Species | mol %) | Species | mol %) | Property | Preservability | Remarks |
| 201 | RP-1 | 1,000 | (I-1) | 100 | — | — | A | 0.276 | Comparison |
| 202 | RP-1 | 1,000 | (I-1) | 100 | (II-2) | 100 | B | 0.132 | Comparison |
| 203 | RP-2 | 550 | (I-1) | 100 | (II-2) | 100 | C | 0.056 | Comparison |
| 204 | P-1 | 9 | (I-1) | 100 | (II-2) | 100 | A | 0.066 | Invention |
| 205 | P-1 | 9 | (I-1) | 100 | — | — | A | 0.103 | Invention |
| 206 | P-2 | 8 | (I-2) | 100 | (II-2) | 100 | A | 0.071 | Invention |
| 207 | P-3 | 25 | (I-3) | 100 | (II-2) | 50 | A | 0.088 | Invention |
| 208 | P-4 | 15 | (I-4) | 100 | (II-2) | 100 | A | 0.061 | Invention |
| 209 | P-5 | 200 | (I-7) | 100 | (II-2) | 100 | B | 0.051 | Invention |
| 210 | P-7 | 380 | (I-1) | 100 | (II-2) | 150 | A | 0.041 | Invention |
| 211 | P-8 | 48 | (I-1) | 100 | (II-2) | 100 | A | 0.037 | Invention |
| 212 | P-10 | 150 | (I-1) | 100 | (II-2) | 100 | A | 0.047 | Invention |
| 213 | P-12 | 350 | (I-1) | 100 | (II-2) | 100 | A | 0.058 | Invention |
| 214 | P-15 | 430 | (I-1) | 100 | (II-2) | 100 | B | 0.089 | Invention |
| 215 | P-18 | 87 | (I-1) | 100 | (II-2) | 100 | A | 0.081 | Invention |
| 216 | P-20 | 8 | (I-2) | 80 | (II-2) | 80 | A | 0.091 | Invention |
| 217 | P-21 | 29 | (I-3) | 50 | (II-2) | 75 | A | 0.077 | Invention |

TABLE 3

| | | | Phenol Reducing | | Compound | | | | |
|---|---|---|---|---|---|---|---|---|---|
| | | | Agent | | combined | | | | |
| | Binder for Image | | Compound of | | with Phenol | | | | |
| | Forming Layer | | Formula (I) | | Reducing Agent | | | | |
| | | Halogen | | Coating | | Coating | | | |
| | | Ion | | Amount | | Amount | | | |
| Sample | | Content | | (relative | | (relative | Coating | Image | |
| No | Species | (ppm) | Species | mol %) | Species | mol %) | Property | Preservability | Remarks |
| 301 | RP-1 | 1,000 | (I-7) | 90 | — | — | A | 0.288 | Comparison |
| 302 | RP-1 | 1,000 | (I-7) | 90 | (II-1) | 100 | B | 0.152 | Comparison |
| 303 | RP-2 | 550 | (I-7) | 90 | (II-1) | 100 | C | 0.066 | Comparison |
| 304 | P-1 | 9 | (I-7) | 90 | (II-1) | 100 | A | 0.072 | Invention |
| 305 | P-1 | 9 | (I-7) | 90 | — | — | A | 0.111 | Invention |
| 306 | P-3 | 25 | (I-7) | 90 | (II-8) | 50 | A | 0.099 | Invention |
| 307 | P-4 | 15 | (I-7) | 90 | (II-22) | 100 | A | 0.069 | Invention |
| 308 | RP-1 | 1,000 | (I-9) | 60 | — | 100 | A | 0.291 | Comparison |
| 309 | RP-1 | 1,000 | (I-9) | 60 | (II-1) | 150 | B | 0.159 | Comparison |
| 310 | RP-2 | 550 | (I-9) | 60 | (II-1) | 100 | D | 0.047 | Comparison |
| 311 | P-1 | 9 | (I-9) | 60 | (II-1) | 100 | A | 0.062 | Invention |
| 312 | P-2 | 8 | (I-9) | 60 | (II-6) | 100 | A | 0.059 | Invention |
| 313 | P-3 | 8 | (I-9) | 60 | — | — | B | 0.123 | Invention |
| 314 | P-4 | 15 | (I-9) | 60 | (II-22) | 100 | A | 0.069 | Invention |

As is parent from the results shown in Tables 2 and 3, the specific polymer latex as the binder for image forming layer is effective for improving the image preservability and coating property.

### EXAMPLE 3

The structures of compounds used in Examples 3 are shown below.

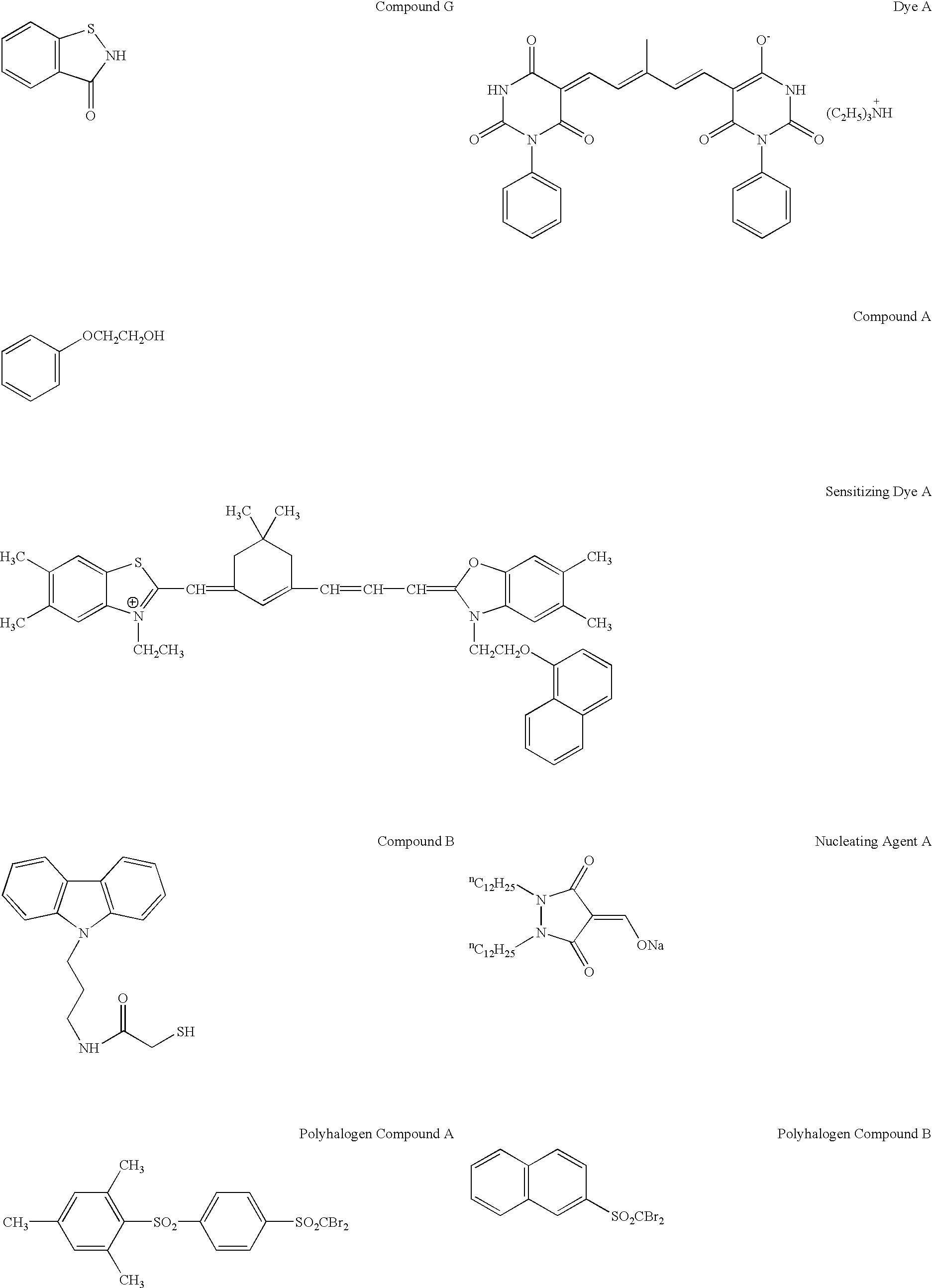

<Preparation of PET Support>

Polyethylene terephthalate (PET) having an intrinsic viscosity IV=0.66 (measured in phenol/tetrachloroethane=6/4 (ratio by weight) at 25° C.) was obtained using terephthalic acid and ethylene glycol in a conventional manner. The PET was palletized, and the pellets were dried at 130° C. for 4 hours. Then, the pellets were melted at 300° C., extruded from a T-die, and rapidly quenched to prepare an unstretched film having a thickness so as to form a film having a thickness of 120 μm after heat setting.

The film was stretched 3.3 times in the longitudinal direction with rollers having different peripheral speeds, and then stretched 4.5 times in the lateral direction by means of a tenter. The temperatures of the operations were 110° C. and 130° C., respectively. Subsequently, the film was subjected to heat setting at 240° C. for 20 seconds, and then relaxation by 4% in the lateral direction at the same temperature. The film was slit to remove its chucked parts by the tenter, and both sides of the film were subjected to knurl processing. The film was rolled up at 4.8 kg/cm² to obtain a roll of the film having a width of 2.4 m, a length of 3,500 m and a thickness of 120 μm.

<Coating of Undercoat Layer>

On both surface of the polyethylene terephthalate support were coated the composition for undercoat layer (a) and the composition for undercoat layer (b) shown below in this order and dried at 180° C. for 4 minutes, respectively. The thickness of the undercoat layer (a) after drying was 2.0 μm.

| (1) Composition for undercoat layer (a) | | |
|---|---|---|
| Polymer latex (a)* | 3.0 | g/m² |
| | (solid content) | |
| 2,4-Dichloro-6-hydroxy-S-triazine | 23 | mg/m² |
| Matting agent (polystyrene; average | 1.5 | mg/m² |
| particle size: 2.4 μm) | | |
| (2) Composition for undercoat layer (b) | | |
| Deionized gelatin (Ca²⁺content: 0.6 ppm; | 50 | mg/m² |
| gelly strength: 230 g) | | |

*core/shell type polymer latex composed of 90% by weight of core portion and 10% by weight of shell portion; core portion: vinylidene chloride/methyl acrylate/methyl methacrylate/acrylonitrile/acrylic acid = 93/3/3/0.9/0.1% by weight; shell portion: vinylidene chloride/methyl acrylate/methyl methacrylate/acrylonitrile/acrylic acid = 8 8/3/3/3/3% by weight; weight average molecular weight: 38,000

<Preparation of Back Layer>

On one surface of the polyethylene terephthalate support, both surface of which had been subjected to the subbing with two layers, were coated the composition for conductive layer and the composition for protective layer shown below in this order and dried at 180° C. for 4 minutes, respectively to prepare the back layer.

| (1) Composition for conductive layer | | |
|---|---|---|
| Jurimer ET-410 (manufactured by Nippon | 96 | mg/m² |
| Pure Chemicals Co., Ltd.) | | |
| Alkali-treated gelatin (molecular weight: | 42 | mg/m² |
| about 10,000; Ca²⁺ content: 30 ppm) | | |
| Deionized gelatin (Ca⁺² content: 0.6 ppm; | 8 | mg/m² |
| Compound G | 0.2 | mg/m² |
| Polyoxyethylene phenyl ether | 10 | mg/m² |
| Sumitex resin M-3 (water-soluble melamine | 18 | mg/m² |
| resin manufactured by Sumitomo Chemical | | |
| Co., Ltd.) | | |
| Dye A (coating amount for obtaining optical density | | |
| of 1.2 at 783 nm) | | |
| SnO₂/Sb (9/1 ratio by weight; fine acicular | 160 | mg/m² |
| particle; long axis/short axis = 20 to 30; | | |
| manufactured by Ishihara Sangyo Kaisha, Ltd.) | | |
| Matting agent (polymethyl methacrylate; | 7 | mg/m² |
| average particle size: 5 μm) | | |
| (2) Composition for protective layer | | |
| Polymer latex (b)** | 1,000 | mg/m² |
| | (solid content) | |
| Polystyrenesulfonate | 2.6 | mg/m² |
| (molecular weight: 1,000 to 5,000) | | |
| Celosol 524 (manufactured by Chukyo Yushi | 25 | mg/m² |
| Co., Ltd.) | | |
| Sumitex resin M-3 (water-soluble melamine | 218 | mg/m² |
| resin manufactured by Sumitomo Chemical | | |
| Co., Ltd.) | | |

<Transportation Heat Treatment>

(1) Heat Treatment

The polyethylene terephthalate support having the undercoat layer and the back layer was transported in a heat treatment zone having the total length of 200 m adjusted at 160° C. under conditions of tension of 3 kg/cm² and transportation speed of 20 m/min to perform the heat treatment.

(2) Post-Heat Treatment

The polyethylene terephthalate support was successively transported in a zone of 40° C. for 15 seconds to conduct the post-heat treatment and rolled up at tension of 10 kg/cm².

<Preparation of Coating Solution for Image Forming Layer>

(1) Preparation of Dispersion of Organic Acid Silver Salt

A mixture of 87.6 g of behenic acid (Edenor C22-85R manufactured by Henkel Corp.), 423 ml of distilled water, 49.2 ml of an aqueous sodium hydroxide solution having a concentration 5 mol/liter and 120 ml of tert-butyl alcohol was reacted at 75° C. for one hour with stirring to prepare a solution of sodium behenate. Separately, 206.2 ml of an aqueous solution containing 40.4 g of silver nitrate was prepared and maintained at 10° C. A reaction vessel containing 635 ml of distilled water and 30 ml of tert-butyl alcohol was maintained at 30° C., and the entire amount of the sodium behenate solution described above and the entire amount of the aqueous silver nitrate solution described above were added to the solution in the reaction vessel with stirring at a constant flow rate over a period of 62 minutes and 10 seconds and over a period of 60 minutes, respectively, in such a manner that only the aqueous silver nitrate solution was added from the start of the addition, 7 minutes and 20 seconds after the start of the addition of the aqueous silver nitrate solution, the addition of the sodium behenate solution was started, and only the sodium behenate solution was added for 9 minutes and 30 seconds after the completion of the addition of the aqueous silver nitrate solution. The temperature in the reaction vessel was maintained at 30° C. and controlled to prevent rising the solution temperature. Further, the piping of the addition system of the sodium behenate solution was warmed by a steam trace, and a steam amount was adjusted so that the solution temperature at the outlet of the addition nozzle tip became 75° C. The piping of the addition system of the aqueous silver nitrate solution was also temperature-controlled by circulating cold water in the outer jacket of a double-walled tube. The positions where the sodium behenate solution and the aqueous silver nitrate solution were added were arranged symmetrically in relation to the stirring axle in the center, and the height of positions was adjusted so as not to touch the reaction solution.

After the completion of the addition of the sodium behenate solution, the reaction solution was stirred at the same temperature for 20 minutes and allowed to stand to decrease the temperature to 25° C. The solid content was colleted by suction filtration and then washed with water until the conductivity of the filtrate reached to 30 μS/cm. The solid content obtained was stored as a wet cake without drying.

The shape of the silver behenate particles thus-obtained was evaluated using electron microscopic photography. The silver behenate particles were scaly crystals having an average projected area diameter of 0.52 μm, an average particle thickness of 0.14 μm, and a variation coefficient of an equivalent spherical diameter of 15%.

To the wet cake in an amount corresponding to 100 g of dried solid content were added 7.4 g of polyvinyl alcohol (PVA-217 manufactured by Kuraray Co., Ltd., average polymerization degree: about 1,700) and water to make the entire amount 385 g, and then the mixture was preliminarily dispersed by a homomixer.

The preliminarily dispersed solution was processed three times using a dispersing machine (Microfluidizer M-110S-EH equipped with a G01Z interaction chamber, manufactured by Microfluidex International Corp.) under a pressure adjusted to 1,750 Kg/cm² to prepare a silver behenate dispersion as the dispersion of organic acid silver salt. The cooling operation was performed by using coil type heat exchangers installed before and behind the interaction chamber respectively and by adjusting the temperature of coolant, thereby setting the desired dispersion temperature.

The particles of silver behenate included in the dispersion of silver behenate thus obtained had a volume weighted average diameter of 0.52 μm and a variation coefficient of 15%. The measurement of particle size was conducted by means of Master Sizer X (manufactured by Malvern Instruments Ltd.). As a result of electron microscopic evaluation, it was found that a ratio of long side to short side was 1.5, a particle thickness was 0.14 μm, and an average aspect ratio (a ratio of equivalent circular diameter of projected area to particle thickness) was 5.1.

(2) Preparation of Light-Sensitive Silver Halide Emulsion

To 700 ml of water were dissolved 11 g of alkali-treated gelatin (calcium content: 2,700 ppm or below), 30 mg of potassium bromide and 10 mg of sodium benzenethiosulfonate, and a temperature of the solution was adjusted to 40° C. and a pH thereof was adjusted to 5.0. To the solution were added 159 ml of an aqueous solution containing 18.6 g of silver nitrate and an aqueous solution containing 1 mol/liter of potassium bromide, 5×10⁻⁶ mol/liter of (NH₄)₂RhCl₅(H2O) and 2×10⁻⁵ mol/liter of K₃IrCl₆ according to a controlled double jet method over a period of 6 minutes and 30 seconds while keeping a pAg at 7.7. Subsequently, 476 ml of an aqueous solution containing 55.5 g of silver nitrate and an aqueous solution containing 1 mol/liter of potassium bromide and 2×10⁻⁵ mol/liter of K₃IrCl₆ were added according to a controlled double jet method over a period of 28 minutes and 30 seconds while keeping a pAg at 7.7.

The mixture was subjected to desalt treatment with flocculation precipitation by decreasing the pH thereof, and 0.17 g of Compound A and 51.1 g of low molecular weight gelatin (average molecular weight: 15,000, calcium content: 20 ppm or below) were added thereto, followed by adjusting 197 the pH and pAg to 5.9 and 8.0, respectively. The resulting particles were cubic grains having an average particle size of 0.08 μm, a variation coefficient of projected area of 9%, and a proportion of {100} plane of 90%.

The temperature of the light-sensitive silver halide emulsion was raised to 60° C., sodium benzenethiosulfonate was added thereto in an amount of 76 μmol per mol of silver, and 3 minutes after, triethylthiourea was added thereto in an amount of 71 μmol per mol of silver, followed by ripening for 100 minutes. Then, 4-hydroxy-6-methyl-1,3,3a,7-tetrazaindene was added in an amount of 5×10⁻⁴ mol and the temperature was lowered to 40° C. While maintaining the temperature at 40° C., Sensitizing Dye A and Compound B were added in an amount of 12.8×10⁻⁴ mol per mol of light-sensitive silver halide and in an amount of 6.4×10⁻³ mol per mol of light-sensitive silver halide, respectively with stirring and 20 minutes after, the temperature was rapidly lowered to 30° C., thereby preparing a light-sensitive silver halide emulsion.

(3) Preparation of Solid Fine Particle Dispersion of Super High Contrast Imparting Agent

To 10 g of a super high contrast imparting agent (Nucleating Agent A) were added 2.5 g of polyvinyl alcohol (PVA-217 manufactured by Kuraray Co., Ltd.) and 87.5 g of water, and the mixture was thoroughly stirred to make a slurry, followed by allowing to stand for 3 hours. The slurry was put into a vessel together with 240 g of zirconia beads having an average diameter of 0.5 mm and dispersed by a dispersing machine (1/4 Gallon Sand Grinder Mill manufactured by Imex Inc.) for 10 hours to prepare a solid fine particle dispersion of super high contrast imparting agent. With respect to the particle size of the dispersion, 80% by weight of the particles had a particle size of from 0.1 to 1.0 μm, and an average particle size was 0.5 μm.

(4) Preparation of Solid Fine Particle Dispersion of Reducing Agent

To 25 g of 1,1-bis(2-hydroxy-3,5-dimethylphenyl)-3,5,5-trimethylhexane were added 25 g of a 20% by weight aqueous solution of modified polyvinyl alcohol (Poval MP 203 manufactured by Kuraray Co., Ltd.), 0.1 g of Safinol 104E (manufactured by Nisshin Chemical Industry Co., Ltd.), 2 g of methanol and 48 ml of water, and the mixture was thoroughly stirred to make a slurry, followed by allowing to stand for 3 hours. The slurry was put into a vessel together with 360 g of zirconia beads having an average diameter of 1 mm and dispersed by a dispersing machine (¼ Gallon Sand Grinder Mill manufactured by Imex Inc.) for 3 hours to prepare a solid fine particle dispersion of reducing agent. With respect to the particle size of the dispersion, 80% by weight of the particles had a particle size of from 0.3 to 1.0 μm.

(5) Preparation of Solid Fine Particle Dispersion of Polyhalogen Compound

To 30 g of Polyhalogen Compound A were added 4 g of modified polyvinyl alcohol (Poval MP 203 manufactured by Kuraray Co., Ltd.), 0.25 g of Compound C and 66 g of water, and the mixture was thoroughly stirred to make a slurry. The slurry was put into a vessel together with 200 g of zirconia silicate beads having an average diameter of 0.5 mm and dispersed by a dispersing machine (1/16 Gallon Sand Grinder Mill manufactured by Imex Inc.) for 5 hours to prepare a solid fine particle dispersion of Polyhalogen Compound A. With respect to the particle size of the dispersion, 80% by weight of the particles had a particle size of from 0.3 to 1.0 μm.

A solid fine particle dispersion of Polyhalogen Compound B was also prepared in the same manner as in Preparation of Solid Fine Particle Dispersion of Polyhalogen Compound A except for using Polyhalogen Compound B in place of Polyhalogen Compound A. The particle size of the dispersion was same as that of the dispersion of Polyhalogen Compound A.

(6) Preparation of Solid Fine Particle Dispersion of Zinc Compound

To 30 g of Compound Z were added 3 g of modified polyvinyl alcohol (Poval MP 203 manufactured by Kuraray Co., Ltd.) and 87 ml of water, and the mixture was thoroughly stirred to make a slurry, followed by allowing to stand for 3 hours. Then, according to the same procedure as in (4) Preparation of Solid Fine Particle Dispersion of Reducing Agent, a solid fine particle dispersion of zinc compound (Compound Z) was prepared. With respect to the particle size of the dispersion, 80% by weight of the particles had a particle size of from 0.3 to 1.0 μm.

(7) Preparation of Coating Solution for Image Forming Layer

To the dispersion of organic acid silver salt (silver behenate) prepared in (1) above were added the components shown below in the amounts shown below per mol of silver in the dispersion of organic acid silver salt, and water, respectively to prepare a coating solution for image forming layer.

Light-sensitive silver halide emulsion prepared in (2) above: 0.05 mol in terms of silver

Solid fine particle dispersion of nucleating agent prepared in (3) above: 17.1 g as solid content

Solid fine particle dispersion of reducing agent prepared in (4) above: 166 g as solid content

Solid fine particle dispersion of polyhalogen compound A prepared in (5) above: 0.06 mol as solid content

Solid fine particle dispersion of polyhalogen compound B prepared in (5) above: 0.02 mol as solid content

Solid fine particle dispersion of zinc compound prepared in (6) above: 10.5 g as solid content

Binder for image forming layer (Polymer Latex (RP-1)) 470 g as solid content

Sodium ethanethiosulfonate: 2.2 mmol

5-Methylbenzotriazole: 1.36 g

Polyvinyl alcohol (PVA-235 manufactured by Kuraray Co., Ltd.): 12.1 g

6-Isopropylphthalazine: 16.5 g

Sodium dihydrogen orthophosphate dihydrate: 0.37 g

Dye A: coating amount for obtaining optical density of 0.3 at 783 nm (0.50 g as an aim)

<Preparation of Coating Solution for Protective Layer on Image Forming Layer Side>

(1) Preparation of Coating Solution for Protective Layer

(a) On Image Forming Layer Side

To 956 g of a polymer latex solution of methyl methacrylate/styrene/2-ethylhexyl acrylate/2-hydroxyethyl methacrylate/acrylic acid copolymer (copolymerization ratio: 58.9/8.6/25.4/5.1/2% by weight) (particle size: 120 nm, glass transition temperature: 57° C., solid content concentration: 21.5% by weight) containing Compound D as a film forming aid in an amount of 15% by weight based on the solid content of polymer latex was added water, then 1.62 g of Compound E, 3.15 g of Compound S, 1.98 g of a matting agent (polystyrene particles, average particle size: 7 μm, variation coefficient of average particle size: 8%) and 23.6 g of polyvinyl alcohol (PVA-235 manufactured by Kuraray Co., Ltd.) were added thereto, and again water was added thereto, thereby preparing a coating solution for protective layer (a) on image forming layer side.

(2) Preparation of Coating Solution for Protective Layer

(b) On Image Forming Layer Side

To 630 g of a polymer latex solution of methyl methacrylate/styrene/2-ethylhexyl acrylate/2-hydroxyethyl methacrylate/acrylic acid copolymer (copolymerization ratio: 58.9/8.6/25.4/5.1/2% by weight)(particle size: 70 nm, glass transition temperature: 54° C., solid content concentration: 21.5% by weight) containing Compound D as a film forming aid in an amount of 15% by weight based on the solid content of polymer latex was added water, then 6.30 g of a 30% by weight solution of carnauba wax (Celosol 524 manufactured by Chukyo Yushi Co., Ltd.) was added thereto. Further, 0.72 g of Compound E, 7.95 g of Compound F, 0.90 g of Compound S, 1.18 g of a matting agent (polystyrene particles, average particle size: 7 μm, variation coefficient of average particle size: 8%) and 8.30 g of polyvinyl alcohol (PVA-235 manufactured by Kuraray Co., Ltd.) were added thereto, and again water was added thereto, thereby preparing a coating solution for protective layer

(b) On Image Forming Layer Side.

<Preparation of Heat-Developable Image Recording Material>

On the surface of the polyethylene terephthalate support opposite to the back layer, which had been coated with the undercoat layer (a) and the undercoat layer (b), and then subjected to the transportation heat treatment, the coating solution for image forming layer and the coating solution for protective layer (a) on image forming layer side were simultaneously multilayer-coated in this order from the undercoat layer in such a manner that a coating amount of silver became 1.6 g/m² and a coating amount of solid content of the polymer latex became 1.31 g/m², respectively. Then, the coating solution for protective layer (b) on image forming layer side was coated thereon in such a manner that a coating amount of the polymer latex became 3.02 g/m², thereby preparing a heat-developable image recording material, which was designated Sample 401. On the image forming layer side of Sample 401, the pH of film surface was 4.9 and the Bekk smoothness was 660 seconds, and on the back layer side of Sample 401, the pH of film surface was 5.9 and the Bekk smoothness was 560 seconds.

In a similar manner to Example 1, Samples 402 to 408 were prepared except for changing the binder for image forming layer to those shown in Table 4 below, respectively. With Samples 401 to 408, the coating property and the image preservability were evaluated. The results obtained are shown in Table 4 below.

The image preservability was evaluated with the heat-developable image recording materials subjected to exposure and development according to (1) Exposure treatment and (2) Heat development treatment described below.

(1) Exposure Treatment

The heat-developable image recording material was exposed using a laser exposing device of single channel cylindrical inner type equipped with a semiconductor laser (beam diameter (FWHM of ½ beam intensity): 12.56 μm, laser output: 50 mW, output wavelength: 783 nm) for 2×10⁻⁸ seconds, with controlling the exposure time and exposure amount by changing a mirror revolution speed and an output value, respectively. The overlap coefficient was 0.449.

(2) Heat Development Treatment

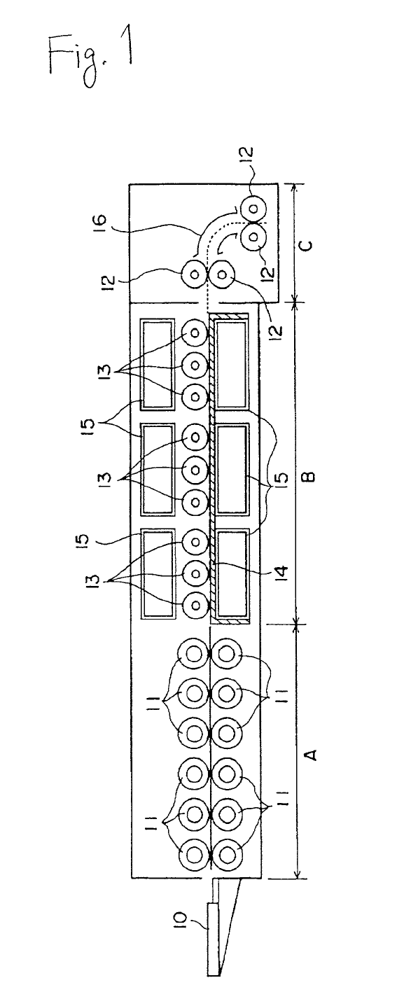

The heat-developable image recording material exposed according to the exposure treatment (1) was subjected to heat development treatment using a heat developing machine shown in FIG. 1. The heat developing machine shown in FIG. 1 comprises a pre-heating part A, a heat development processing part B and a slow cooling part C. The pre-heating part A is equipped with a pre-heating means (not shown) and plural pairs of carrying in rollers 11 for holding a heat-developable image recording material 10 therebetween to carry in the heat development processing part B. The heat development processing part B is equipped with a smooth surface 14 and rollers 13 for holding the heat-developable image recording material 10 therebetween to transport, and heaters 15 for heating the heat-developable image recording material 10. The slow cooling part C is equipped with two pairs of carrying out rollers 12 for holding the heat-developable image recording material 10 therebetween to carry out from the heat development processing part B, and a guide plate 16 for changing the carrying out direction of the heat-developable image recording material 10 between the carrying out rollers 12. In the heat developing machine shown in FIG. 1, the heat-developable image recording material 10 was passed through the pre-heating part A, the heat development processing part B and the slow cooling part C in order and subjected to pre-heating, heat development processing and slow cooling (air cooling) successively, thereby performing the heat development treatment. The rollers 13 in the heat development processing part B had silicone rubber as the surface material. Teflon nonwoven fabric was used for the smooth surface 14. The transportation, i.e., carrying in and carrying out, was conducted at a line speed of 20 mm/sec. The driving systems of the pre-heating part and the heat development processing part were independently operated and a difference of the speed in the pre-heating part from that in the heat development processing part was controlled in a range of from −0.5% to −1%. The heat development was carried out at from 90 to 110° C. for 15 seconds in the pre-heating part A, 120° C. for 20 seconds in the heat development processing part B, and 15 seconds by air cooling in the slow cooling part C. The temperature accuracy on the transverse direction was ±1° C.

TABLE 4

| | Binder for Image | | | | |
|---|---|---|---|---|---|
| | Forming Layer | | | | |
| | | Halogen | | | |
| | | Ion | | | |
| Sample | | Content | Coating | Image | |
| No | Species | (ppm) | Property | Preservability | Remarks |
| 401 | RP-1 | 1,000 | A | 0.121 | Comparison |
| 402 | RP-2 | 550 | C | 0.051 | Comparison |
| 403 | P-1 | 9 | A | 0.049 | Invention |
| 404 | P-2 | 8 | A | 0.067 | Invention |
| 405 | P-3 | 25 | B | 0.052 | Invention |
| 406 | P-4 | 15 | A | 0.078 | Invention |
| 407 | P-8 | 48 | A | 0.091 | Invention |
| 408 | P-10 | 150 | A | 0.074 | Invention |

As is apparent from the results shown in Table 4, similar to Example 1, the excellent coating property and image preservability can be achieved in the super high contrast heat-developable image recording materials by using the specific polymer latex as the binder for image forming layer according to the present invention as compared with the comparisons.

From the results in the examples above it can be seen that the occurrence of streaks and repelling marks is prevented in the coating procedure, and the occurrence of stain in the white background portion during the preservation in a dark place after the heat development processing is also prevented.

The heat-developable image recording material excellent in both image preservability and coating property can be provided according to the present invention.

While the invention has been described in detail and with reference to specific examples thereof, it will be apparent to one skilled in the art that various changes and modifications can be made therein without departing from the spirit and scope thereof.

The entire disclosure of each and every foreign patent application from which the benefit of foreign priority has been claimed in the present application is incorporated herein by reference, as if fully set forth.

What is claimed is:

1. A heat-developable image recording material comprising:
a support;
a photosensitive silver halide;
a non-photosensitive organic silver salt;
a reducing agent for a silver ion; and
a binder including a polymer latex,
wherein the polymer latex has a halogen ion content of not more than 500 ppm.

2. The heat-developable image recording material as claimed in claim 1, wherein the polymer latex has a halogen ion content of not more than 200 ppm.

3. The heat-developable image recording material as claimed in claim 1, wherein the halogen ion is a chlorine ion.

4. The heat-developable image recording material as claimed in claim 1, wherein the polymer latex is not subjected to purification by a desalting process.

5. The heat-developable image recording material as claimed in claim 1, wherein the binder has a glass transition temperature of from −20° C. to 80° C.

6. The heat-developable image recording material as claimed in claim 1, wherein the polymer latex contains a conjugated diene copolymer.

7. The heat-developable image recording material as claimed in claim 1, wherein the reducing agent contains:
a phenol compound; and
a compound that satisfies at least one of the conditions (A) and (B):
(C): the compound having a hydrogen bond-forming rate constant (Kf) of from 20 to 4,000,
(D): the compound having one of a phosphoryl group in its molecule, and a structure represented by formula (II), (III), (IV) or (V): 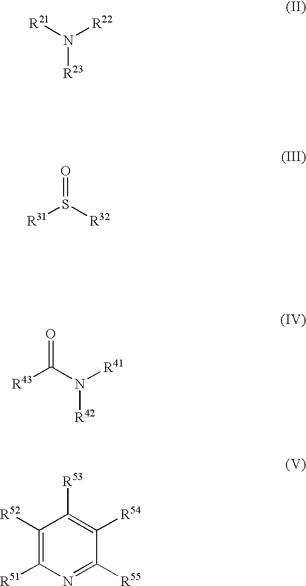
wherein R²¹ and R²², which are the same or different, each represents an alkyl group; R²³ represents an alkyl group, an aryl group or a heterocyclic group; at least two of R²¹, R²² and R²³ may be combined with each other to form a ring, R³¹ and R³², which are the same or different, each represents an alkyl group, an aryl group or a heterocyclic group; R³¹ and R³² may be combined with each other to form a ring,
R⁴¹ and R⁴², which are the same or different, each represents an alkyl group, an aryl group or a heterocyclic group; R represents an alkyl group, an aryl group, a heterocyclic group or —N(R⁴⁴) (R⁴⁵); R⁴⁴ and R⁴⁵, which are the same or different, each represents an alkyl group, an aryl group or a heterocyclic group; at least two of R⁴¹, R⁴², R⁴³, R⁴⁴ and R⁴⁵ may be combined with each other to form a ring, and
R⁵¹, R⁵², R⁵³, R⁵⁴ and R⁵⁵, which are the same or different, each represents a hydrogen atom or a substituent; at least two of R⁵¹, R⁵², R⁵³, R⁵⁴ and R⁵⁵ may be combined with each other to form a ring.

8. The heat-developable image recording material as claimed in claim 7, wherein the phenol compound is an o-polyphenol compound.

9. The heat-developable image recording material as claimed in claim 8, wherein the o-polyphenol compound is a compound represented by formula (I): 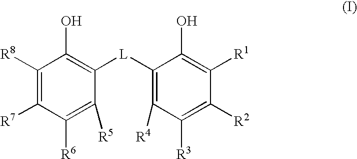
wherein R¹, R², R³, R₄, R⁵, R⁶, R⁷ and R⁸, which are the same or different, each represents a hydrogen atom or a substituent capable of being substituted on the benzene ring; L represents —S— or —CHR⁹—; and R⁹ represents a hydrogen atom or an alkyl group.

10. The heat-developable image recording material as claimed in claim 9, wherein the compound represented by formula (I) is a compound in which R², R⁴, R⁵ and R⁷ each represents a hydrogen atom; R¹ and R⁸ each independently represents an alkyl group; R³ and R⁶ each independently represents an alkyl group; and L represents —CHR⁹—.

11. The heat-developable image recording material as claimed in claim 10, wherein R¹ and R⁸ each independently represents a secondary alkyl group or a tertiary alkyl group.

12. The heat-developable image recording material as claimed in claim 7, wherein the hydrogen bond-forming rate constant (Kf) is from 70 to 4,000.

13. The heat-developable image recording material as claimed in claim 7, wherein the phenol compound is an o-polyphenol compound, and the compound which satisfies at least one of the conditions (A) and (B) is the compound having a phosphoryl group in its molecule.

14. The heat-developable image recording material as claimed in claim 7, wherein the compound having a phosphoryl group in its molecule is a compound represented by formula (VI): 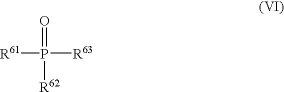
wherein R⁶¹, R⁶² and R⁶³, which are the same or different, each represents an alkyl group, an aryl group, an aralkyl group, an alkoxy group, an aryloxy group, an amino group or a heterocyclic group.

15. The heat-developable image recording material as claimed in claim 1, which further comprises an image-forming layer containing the photosensitive silver halide, the non-photosensitive organic silver salt and the binder.

16. The heat-developable photosensitive material as claimed in claim 15, wherein the image-forming layer further contains the reducing agent for a silver ion.

17. The heat-developable photosensitive material as claimed in claim 15, which further comprises a second image-forming layer containing the reducing agent for a silver ion.
